(19) United States
(12) Patent Application Publication
(10) Pub. No.: US 2018/0144729 A1
(43) Pub. Date: May 24, 2018

(54) SYSTEMS AND METHODS FOR SIMPLIFYING MUSIC RHYTHMS

(71) Applicant: NiceChart, Inc., San Diego, CA (US)

(72) Inventors: Steve Morell, San Diego, CA (US); Tammy Morell, San Diego, CA (US)

(73) Assignee: NiceChart, Inc., San Diego, CA (US)

(21) Appl. No.: 15/809,926

(22) Filed: Nov. 10, 2017

Related U.S. Application Data
(60) Provisional application No. 62/426,054, filed on Nov. 23, 2016.

(51) Int. Cl. G10H 1/00; G10G 1/00

(52) U.S. Cl. CPC G10H 1/0008; G10G 1/00; G10H 2210/105; G10H 2210/061; G10H 2210/071

(57) ABSTRACT

Systems and methods for simplifying music rhythms based on multiple criteria are provided herein. A user inputs a musical selection, or chooses one from an existing library of musical selections, and inputs a player proficiency level. The user then receives a music notation selection that has been adjusted to display rhythms that are appropriate for that player's proficiency level. The system is capable of receiving information and adjusting music notation arrangements in real time.

### CROSS-REFERENCE TO RELATED APPLICATION

This application claims the benefit of and priority to U.S. Provisional Application Ser. No. 62/426,054 entitled “SYSTEMS AND METHODS FOR SIMPLIFYING MUSIC RHYTHMS” and filed Nov. 23, 2016, the entirety of which is hereby incorporated by reference herein for all purposes.

### BACKGROUND

### 1. Field of the Invention

The present disclosure relates to simplifying rhythms in a musical composition to be more appropriately suited for a player's proficiency level, and in particular, to systems and methods for changing rhythmic complexity in simple and compound meters to accommodate a player's proficiency.

### 2. Background of Related Art

Two elements that make up how a player interprets the difficulty of any given selection of music are rhythmic complexity and note range. In practice, sheet music is written with the proficiency level of the player in mind. When creating an alternate version of a naturally difficult arrangement, choices are carefully made by an arranger to simplify the rhythm of a piece in order to best capture its original characteristics. For instance, a melody made up primarily of sixteenth notes can be simplified to eighth notes by skipping every other note. Simplification is common practice to allow a player who is not capable of performing the original version to be able to play a version that sounds similar to the original melody but written in a level-appropriate manner.

As a result, musical arrangement users, such as band directors, plano students, and private lesson teachers, and even creators of sheet music, are forced to manually adjust the music in order to simplify it. This process is time-consuming and often requires manually entering in every single note as a starting point. In some cases, ensemble users may not have the ability or training to rewrite the fixed musical arrangement, therefore, they are limited in their selection and likely to end up with sub-optimal results. If a title is not already available for purchase at the correct proficiency level, it may either be passed over as an option to perform, or the player will be forced to struggle through playing an arrangement that is too difficult for their playing level.

### SUMMARY

Systems and methods are provided for simplifying any combination of note and rest values in a wide variety of commonly used simple and compound meters. This is achieved by receiving note and rest information, assessing the information based on one or more factors, and making adjustments according to the proficiency level, rhythmic value of notes or rests needing to be updated, the placement of the notes within the measure, the location of the notes according to the beat structure of the meter, and the types of notes and rests surrounding the notes and rests being updated.

The disclosed system and method evaluates rhythms one measure at a time and uses the note lengths, the order of those notes or rests, how they are positioned in the measure based on which beat the note is found in a measure, and position in relation to the closest beat as defined by the time signature.

In one aspect, the disclosed system and method utilizes one or more simplification processes, each of which is designed to accept as input a musical arrangement having a higher (more difficult to play) proficiency to the generate as output a musical arrangement having a lower (simpler) proficiency. The simplification processes are referred to herein by the input and output proficiency levels, e.g., the 4-3 process takes a selection of music having a “4” proficiency level and outputs a simplified version having a “3” proficiency level.

Users may select either a defined simplification process (such as proficiency level 3 to level 2) or may simply select a destination proficiency which triggers the required sequence of simplification processes to achieve the final result. For example, a user wishing to simplify an arrangement to proficiency 1 can simply select a target proficiency of 1. This would trigger a 4-3 process, a 3-2 process, and finally a 2-1 process.

In some embodiments, for example, embodiments configured to execute within a desktop notation software application, the invention may take the form of a plugin that could be labeled “3 to 2.” The process for 4 to 3 and then 3 to 2 would be performed in this scenario to achieve the desired rhythmic simplification, as will be described in detail with reference to the flowcharts presented herein.

In another aspect, an objective of the disclosed system and method is to adjust the rhythmic elements of the notation, and to make choices for which pitches will be kept or deleted in those cases when notes and rests are removed as part of the simplification process. These choices are carefully defined and efforts are made to best preserve the rhythmic integrity of the song, and retain as many unique pitches as possible.

Any further note range modifications or transposition at this point may be performed by a complementary melodic simplification process. In practice, for example, the disclosed rhythmic simplification system may be employed in conjunction with other simplification processes to adjust for example, note ranges, to produce arrangements that are completely adjusted to a player's proficiency level. Examples of other simplification processes which may be employed in conjunction with the present invention are disclosed in U.S. Pat. No. 9,202,448 entitled “SYSTEMS AND METHODS FOR CREATING CUSTOMIZED MUSIC ARRANGEMENTS” and U.S. Pat. No. 9,489,932 entitled “SYSTEMS AND METHODS FOR CREATING CUSTOMIZED MUSIC ARRANGEMENTS,” each of which is owned by the assignee of the present application and incorporated by reference herein for all purposes.

The system and method supports simplifying meters where a quarter note is considered the beat (4/4, ¾, 7/4, etc.), meters where dotted quarter notes are considered the main beat ( 6/8, 9/8, 12/8, etc), meters where half notes are considered the main beat (2/2, 3/2, 5/2, etc.) as well as symbols such as cut and common time (or imperfect time).

The beat evaluation location is an element used throughout the process to reference which location within the measure is being evaluated. For example: beat 4 of 5 or beat 3.25 of 4. It should be understood that, while there can be 4 beats a measure, the disclosed system can have a beat evaluation location of, for example, 4.5. In this example, beat 4.5 of a 4 beat measure in simple meter would represent the midpoint of the fourth beat, e.g., the “and” of the fourth beat (e.g., the second eighth note of the fourth beat). There are no zero values, so all measures are regarded as starting with beat evaluation location 1.

A minimum note duration refers to the smallest type of note allowed in given particular proficiency level. All other notes must be larger. For example, if the minimum note duration is an eighth note, a quarter note is permitted, while a sixteenth note is not.

Because of the variety and inconsistency in notation software commonly used to create the output files generated by the system, particularly with respect to the way some tuplets are created, in the example embodiment a messaging facility is utilized to notify users/arrangers of measures that should be examined manually. This will help ensure these rare notations are handled properly. The process generates a log of measures that should be examined after simplification. The field “Display Non-Standard Rhythmic Phrase Message” is a catchall error message that either indicates the presence of incorrectly formatted notation, or a rhythmic phrase that falls outside the parameters of this process (e.g., tuplets smaller than triplets).

The goal of the 4 to 3 process is to prevent no more than 2 consecutive sixteenth notes which will yield a rhythmic interpretation level commensurate with a low-intermediate player. The 3 to 2 process eliminates sixteenth notes and does not allow notes larger than eighth notes, which is consistent with a beginner's rhythmic interpretation ability. Finally the 2 to 1 process eliminates all eighth notes forcing the music to fit within quarter note or larger notes and rests, which is consistent with an early beginner's rhythmic interpretation ability.

An example of output when running the 4 to 3 process is shown in FIGS. 109A-B. The before 4-3 simplification process 7000 is shown in FIG. 109A. The after 4-3 simplification process 7010 is shown in FIG. 109B. Note the elimination of any note that is faster than a sixteenth note and the lack of more than two consecutive sixteenth notes.

An example of output when running the Proficiency 3 to 2 Process is shown in FIGS. 110A-B. The before 3-2 simplification process 7020 is shown in FIG. 110A. The after 3-2 simplification process 7030 is shown in FIG. 110B. This is a continuation of the simplification from the 4 to 3 process when the 3 to 2 or 2 to 1 process is run. Note the elimination of any note that is faster than a sixteenth note and the lack of more than two consecutive sixteenth notes.

An example of output when running the Proficiency 2 to 1 Process is shown in FIGS. 111A-B. The before 2-1 simplification process 7040 is shown in FIG. 111A. The after 2-1 simplification process 7050 is shown in FIG. 111B. This is a continuation of the simplification from the 4 to 3 and 3 to 2 processes. Note the elimination of any note that is faster than an eighth note. The fastest note presented here is a quarter note and is something an early beginner would feel comfortable reading.

In some embodiments, the results of a simplification process may be cached, which would enable future simplification processes for the same piece of music to be generated more quickly by using the cached version rather than having to re-process any intermediate or final simplifications.

According to embodiments of the present disclosure, a system and method is provided that enables a user to simplify rhythms and, additionally or alternatively, adjust the positioning of notes found in written music notation as needed and in real time, to match the proficiency level of a specific player.

The disclosed processes account for changes in time signature across the notation being evaluated and handles both simple and compound meters. In the event an odd time signature (such as ⅞ or 9/8) is presented, no action may be taken to simplify the notation.

In circumstances where the notation provided to the simplification processes is not written in a standard form, simplification of the incorrectly formatted music may not be achievable. Any measures containing a non-standard rhythmic phrase is noted by the simplification process for further review and, if necessary, a simplification may be accomplished manually.

In embodiments, the present invention may be embodied as a software plug-in suitable for use with notation software, such as Sibelius® or Finale®. In these embodiments, the user may be presented with a list of measures having non-standard rhythmic phrasing for further review after the necessary simplification processes have concluded. In some embodiments, the presence of a non-standard rhythmic phrase will simply not be changed for any effected measures.

Accordingly, several advantages are provided, including the ability, preferably when used in conjunction with a note range correction system, for users to receive immediate customized updates to arrangements based on the proficiency level of the player that will be assigned this part. This process can be applied to any form of musical data which tracks note duration including MIDI, MusicXML and any other open source music format or proprietary software format.

Other features and advantages should become apparent from the following description of the preferred embodiments, taken in conjunction with the accompanying drawings.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding and shall not be considered limiting of the breadth, scope, or applicability of the embodiments.

FIGS. 1-62 depict a detailed flowchart of a method for simplifying rhythms that a late intermediate player (level 4) would find appropriate to rhythms an early intermediate player (level 3) would find appropriate. This process is known as the “4 to 3” simplification process according to an embodiment of the present disclosure;

FIGS. 63-94 depict a detailed flowchart of a method for simplifying rhythms that an early intermediate player (level 3) would find appropriate to rhythms a beginner level player (level 2) would find appropriate. This process is known as the “3 to 2” simplification process according to an embodiment of the present disclosure;

FIGS. 95-106 depict a detailed flowchart of a method for simplifying rhythms that a beginner level player (level 2) would find appropriate to rhythms an early beginner level player (level 1) would find appropriate. This process is known as the “2 to 1” simplification process according to an embodiment of the present disclosure;

FIG. 107 is a block diagram illustrating aspects of a musical rhythm simplification system according to an embodiment of the present disclosure;

FIG. 108 is a block diagram that illustrates other aspects of a musical rhythm simplification system according to an embodiment of the present disclosure;

FIGS. 109A and 109B illustrate an example input and output, respectively, of a proficiency level 4 to proficiency level 3 rhythmic simplification process in accordance with an embodiment of the present disclosure;

FIGS. 110A and 110B illustrate an example input and output, respectively, of a proficiency level 3 to proficiency level 2 rhythmic simplification process in accordance with an embodiment of the present disclosure; and

FIGS. 111A and 111B illustrate an example input and output, respectively, of a proficiency level 2 to proficiency level 1 rhythmic simplification process in accordance with an embodiment of the present disclosure.

### DETAILED DESCRIPTION

Particular illustrative embodiments of the present disclosure are described hereinbelow with reference to the accompanying drawings; however, the disclosed embodiments are merely examples of the disclosure, which may be embodied in various forms. The rhythmic simplification processes described herein may be fully understood with reference to the drawings, and to the description which, for brevity, avoids superfluous, repetitive or redundant detail. Similarly, well-known functions or constructions are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure may be described herein in terms of functional block components, code listings, optional selections, page displays, and various processing steps. It should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed by any device having a data connection capable of connecting to the Internet, on a variety of operating systems including without limitation Apple OSX®, Apple MacOS®, Apple iOS®, Google Android®, HP WebOS®, any of the many UNIX variants including Linux, Microsoft Windows®, and/or Microsoft Windows Mobile®.

It should be appreciated that the particular implementations described herein are illustrative of the disclosure and its best mode and are not intended to otherwise limit the scope of the present disclosure in any way. Examples are presented herein which may include sample data items which are intended as examples and are not to be construed as limiting. Indeed, for the sake of brevity, conventional data networking, music file formats, data file input, output and storage, application development and other functional aspects of the systems (and components of the individual operating components of the systems) may not be described in detail herein. It should be noted that many alternative or additional functional relationships or physical or virtual connections may be present in a practical electronic system or apparatus. In the discussion contained herein, the terms user interface element and/or button are understood to be non-limiting, and include other user interface elements such as, without limitation, a hyperlink, clickable image, and the like.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., flash memory, USB thumb drives) and/or the like.

Computer program instructions embodying the present disclosure may also be stored in a computer-readable memory that can direct a computer or other programmable data processing apparatus to function in a particular manner, such that the instructions stored in the computer-readable memory produce an article of manufacture, including instruction means, that implement the function specified in the description or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like The steps recited herein may be executed in any order and are not limited to the order presented. Moreover, two or more steps or actions recited herein may be conducted concurrently.

The disclosed systems and/or methods may be embodied, at least in part, in application software that may be downloaded, in whole or in part, from either a website or an application store (“app store”) to the mobile device. In another embodiment, the disclosed system and method may be included in the mobile device firmware, hardware, and/or software. In another embodiment, the disclosed systems and/or methods may be embodied, at least in part, in application software executing within a webserver to provide a web-based interface to the described functionality.

In yet other embodiments, all or part of the disclosed systems and/or methods may be provided as one or more callable modules, an application programming interface (e.g., an API), a source library, an object library, a plug-in or snap-in, a dynamic link library (e.g., DLL), or any software architecture capable of providing the functionality disclosed herein.

Systems and methods for simplifying music rhythms based on multiple criteria are provided herein. In an embodiment, a user chooses a musical selection from a database of musical selections. The musical selection may be encoded in any suitable notation format, including without limitation MIDI file format, MusicXML, and/or any other suitable open source music format or proprietary software format. The user inputs, into the system, information about a player's proficiency level rated on a scale of, for example, 1 to 4 or, alternatively, 1 to 5, where a lower number indicates a lower proficiency and a higher number indicates a higher proficiency. In the exemplary embodiments presented herein, level 1 represents an early beginner, level 2 represents a beginner, level 3 represents an intermediate player, and 4 represents an advanced player.

Note that, if using a 1 to 5 scale, where 5 represents an expert professional player, level 5 will be treated the same as level 4 in terms of rhythmic difficulty. However, in some embodiments, the proficiency difference from level 5 to level 4 may be relevant for other non-rhythmic based criteria that utilized by a complementary simplification process, such as an instrument range simplification process, for example. That is, changing from proficiency 5 to proficiency 4 would not cause any change to the rhythmic simplification, but could result in other changes such as melodic simplification or instrument range, for example.

In one aspect, each rhythmic simplification process is characterized by its input level and output level. For example, the 4 to 3 process is designed to accept an arrangement requiring a proficiency level of 4, and to output a simplified arrangement suitable for a player of proficiency 3. Each level change is therefore carried out by a rhythmic simplification process designed to accomplish one specific level change: the 4 to 3 process, the 3 to 2 process, and the 2 to 1 process. When the user chooses a desired final proficiency level, all higher-level simplification processes are first performed in descending order. For example, if a user chooses to run a level 2 simplification, the 4 to 3 process is performed first, followed by the 3 to 2 process, at which point the simplification process is completed (e.g, concludes without running the 2 to 1 process). This ensures that any complex rhythms that may exist in the original arrangement are appropriately simplified prior reaching the next simplification level. In another aspect, each simplification process may be characterized by set of simplification rules, such as a minimum note duration rule, a combination rule, and/or a beat-shifting rule.

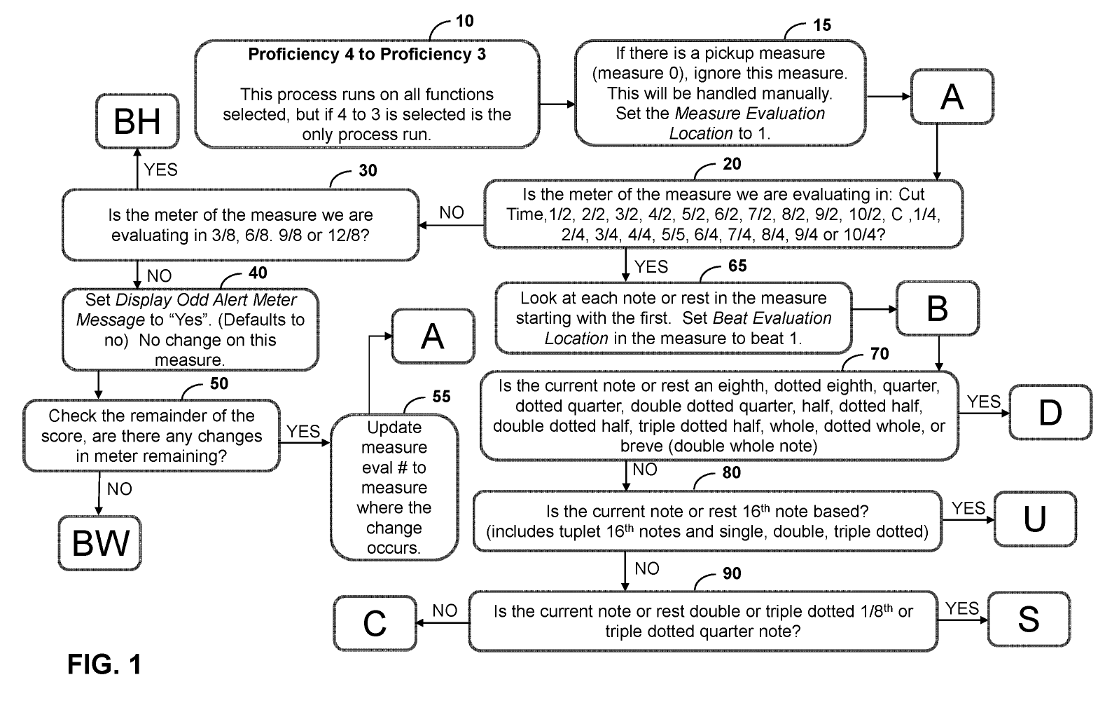

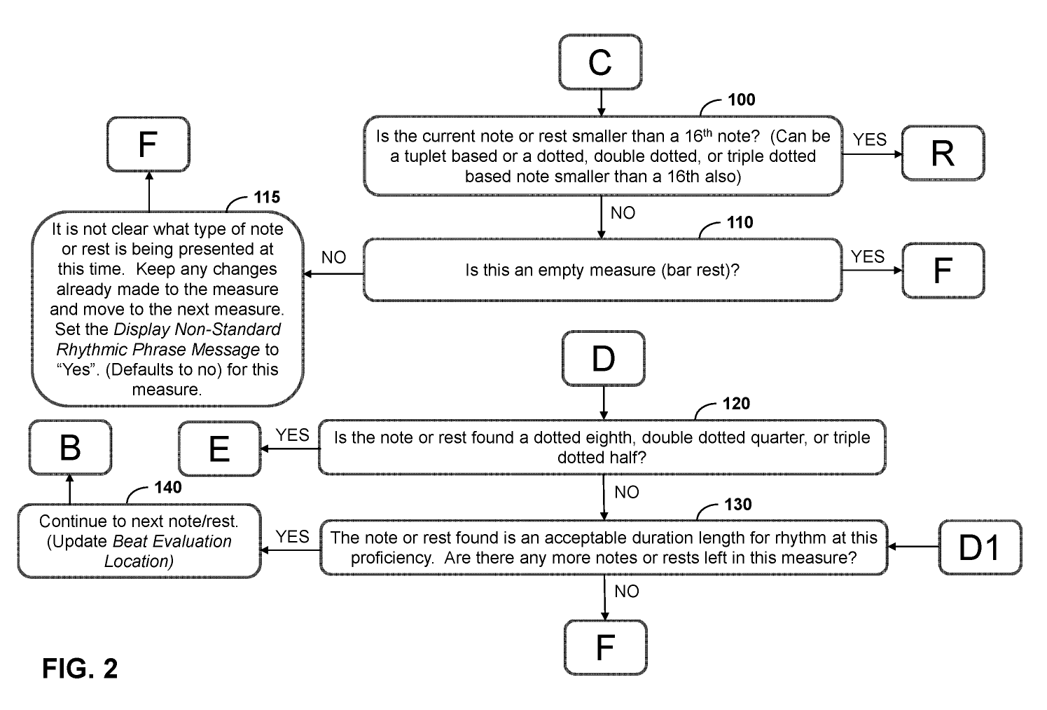

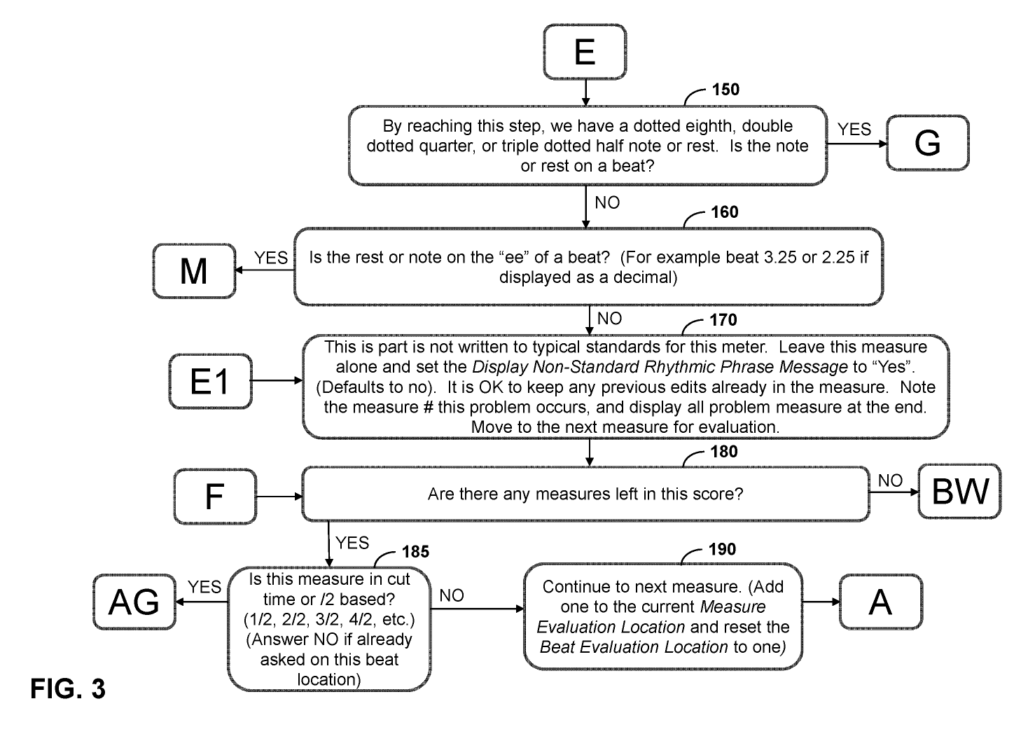

As seen in FIG. 1, the 4-3 process begins by determining the time signature of the measure under evaluation. Pickup measures are ignored and may be handled manually by the user (15). The time signature is examined at steps 20-50 to determine if the measure is in simple or compound meter. If compound meter (e.g., ⅜, 6/8. 9/8 or 12/8), processing continues at step 2530 (FIG. 47, discussed below). If in common time, cut time, and all time signatures over 4 and 2 which represent quarter notes or half notes representing the beat, respectively (e.g., cut time, ½, 2/2, 3/2, 4/2, 5/2, 6/2, 7/2, 8/2, 9/2, 10/2, C, ¼, 2/4, ¾, 4/4, 5/5, 6/4, 7/4, 8/4, 9/4 or 10/4), each note in the measure is identified at steps 65-90 for further processing.

FIGS. 2-46 illustrate the 4-3 process for simplifying rhythms to a level suitable for a level 3 (early intermediate) player. The 4-3 process includes the elimination of any notes faster than 1/16^{th} notes, and any types of dotted rhythms typically completed with notes faster than 1/16^{th} notes. The 4-3 process also prevents more than 2 consecutive 1/16^{th} notes in an effort to generate notation that is more appropriate for an early intermediate player at a moderate tempo. Cut time and time signatures where the half note is considered the beat (e.g., n/2 meters) have a slightly different process that takes the simplification further.

Each measure is evaluated by initially setting the beat evaluation location in the measure to 1, and examining each note and rest in the measure starting with the first note or rest. Each note or rest in the measure is distinguished by duration, position within the measure, and position relative to the beat to determine which simplification process applies to the note or rest's musical context.

If the current note or rest is an eighth, dotted eighth, quarter, dotted quarter, double dotted quarter, half, dotted half, double dotted half, triple dotted half, whole, dotted whole, or breve (double whole note), the 4-3 process continues at step 120 (FIG. 2) to determine if the note or rest is acceptable for level 3 proficiency (step 130), requires simplification (FIG. 3, step 150), or if no further notes are present in the measure to be examined (FIG. 3, step 180).

If the current note or rest is a dotted eighth, double dotted quarter, or triple dotted half, dotted-note simplification is potentially required (FIG. 3, step 150). Processing diverges here depending upon whether the note or rest lands on the beat or the “ee” of a beat (e.g., beat 3.25 or 2.25 as expressed as a decimal). If on the beat, simplification proceeds at FIG. 4 step 200. If on the “ee” then simplification proceeds at FIG. 9 step 450 (connector M). If neither are true, the note or rest is part of a measure not written to typical standards for the indicated meter (step 170). In this event, the measure is flagged for manual simplification, any existing simplifications are retained, and processing continues at the start of the next measure.

If the current note or rest is 1/16th note based (e.g., includes tuplet 16th notes and single, double, triple dotted notes), 1/16th note simplification processing is potentially required as shown in FIG. 17, step 890 (connector U) as discussed in detail below.

If the current note or rest is a double or triple dotted ⅛th, or triple dotted quarter note, simplification proceeds at FIG. 15, block 700 (connector S) as discussed below. Otherwise, simplification proceeds to FIG. 2, step 100 (connector C) where it is determined whether current note or rest smaller than a 1/16th note, or, if the note or rest is a tuplet based or a dotted, double dotted, or triple dotted based note smaller than a 16th note or rest as well. If so the simplification proceeds as shown in FIG. 14, step 650 (connector R), discussed below.

FIG. 15 illustrates 4-3 simplification of a double or triple dotted ⅛th note. If the note or rest falls on a beat, the note or rest is converted to a ¼ note or rest (steps 710-730 and 750) and the current beat evaluation location is positioned after the quarter note or rest that was just created. If, starting from the beginning of the measure, there now exists only rests, all rests are replaced with a bar rest (steps 760-770).

If the measure is empty, any changes already made (e.g., combining rests) are retained and the next measure is processed. If additional elements (notes or rests) remain in the measure, the current beat evaluation location is positioned at the note (or rest) after the quarter note or rest just created.

FIG. 16 illustrates processing for a triple dotted quarter note or rest that is on the beat. The triple dotted quarter note or rest is converted to a ¼ note or rest (steps 810-820 and 840) and the current beat evaluation location is advanced to after the quarter note or rest that was just created. If, starting from the beginning of the measure, there now exists only rests, all rests are replaced with a bar rest (steps 850-860). The current beat evaluation location is advanced to the note (or rest) after the half note or rest that was just created.

FIG. 17 depicts processing for a 1/16th note or rest where the type of 1/16th note is identified and the appropriate simplification are applied (e.g., 1/16th note tuplet simplification rules (FIG. 25, steps 1310-1400), dotted, double dotted, or triple dotted 1/16th note simplification rules (FIG. 26, steps 1410-440), 1/16th note or rest on the beat rules (FIG. 24, steps 1230-1280), 1/16th note or rest on the “ee” of the beat rules (FIG. 23, steps 1170-1220), and 1/16^{th} note or rest on the “and” of a beat rules (FIG. 18, steps 890-930)).

For example, an “on the beat” simplification in the 4-3 process examines whether element is a note or a rest (FIG. 4 at 210), and whether the element is followed by a 1/16^{th} note or rest. If a rest, processing continues at FIG. 5 step 260 (connector H). If a note, and if not followed by a 1/16^{th} note or rest, the measure is not written to typical standards for the indicated meter therefore processing continues at connector E1, step 170. If the element is followed by a 1/16^{th} rest, processing proceeds at FIG. 8 step 430 (connector L) where it is determined any more notes/rests remain in this measure to evaluate after the 16th note rest. If there are, the note that is on the beat and the following 1/16th note rest are retained, and the current beat evaluation location is changed to the note (or rest) after the 16th note rest

Otherwise, the element is followed by a 1/16^{th} note. If no further notes exist in the measure, the current element and following 16^{th} notes remain as original and processing continues with the next measure. If additional notes exist in the measure, the current element and following 1/16^{th} notes are kept and evaluation of this measure skips ahead to the next element (note or rest) following the 1/16^{th} note.

FIG. 5 steps 260-290 illustrates the simplification of adjacent rests in to a single rest. If the current rest not followed by a 1/16^{th} note or rest, the measure is non-standard for the indicated meter (connector E1, step 170). If the element is followed by a 1/16th note, processing continues at FIG. 6, step 330 (connector I). The rest and following 1/16th then retained, and if additional notes exist in the measure, the current element and following 1/16^{th} notes are kept and evaluation of this measure skips ahead to the next element (note or rest) following the 1/16^{th} note. If the element at the beat evaluation location a dotted ⅛th rest, the dotted ⅛th rest and 1/16th note rest are combined into a ¼ note rest. If additional elements exists in the measure, is advanced to the note or rest following the newly-created ¼ rest. Otherwise, if the element at the beat evaluation location is not a dotted ⅛th rest, processing continues at FIG. 7, step 360 (connector J). If the rest located at the current beat evaluation location is a double dotted ¼ note rest, the double dotted ¼ rest and 1/16th note rest are combined into a ½ note rest. Note that, if no further notes exist in the measure and the current time signature is 2/4, the contents of the entire measure are deleted.

If the rest located at the current beat evaluation location is not a double dotted ¼ note rest, processing proceeds at FIG. 8 step 400 (connector K). By reaching this step, we have a triple dotted half note rest that is on a beat followed by a 1/16th note rest (in a n/4 based meter). The triple dotted ½ rest and 1/16th note rest are combined into a whole note rest. If any more notes or rests remain to evaluate in this measure, and current time signature is 4/4 or C, the contents of the measure are deleted. Otherwise, the current beat evaluation location is advanced to the note (or rest) after the whole note rest just created.

In FIG. 9, step 450, a dotted eighth, double dotted quarter, or triple dotted half note or rest on the “ee” of a beat has been identified (for example, at beat evaluation location 2.25 or 3.25 etc.). If the dotted eighth, double dotted quarter, or triple dotted half note or rest, is not preceded by a 1/16th note or rest on a beat, the measure is non-standard for the indicated meter (proceed to connector E1, step 170). Otherwise, a determination is made as to whether the dotted eighth, double dotted quarter, or triple dotted half note is a note or a rest. If a note, no further changes are made, and if additional elements exist in the measure, the current beat evaluation location is advanced to the note (or rest) after the dotted eighth, double dotted quarter, or triple dotted half note. If a rest, processing continues at FIG. 10 steps 500-530 (connector N) where, if the 1/16th note preceding the dotted eighth, double dotted quarter, or triple dotted half note rest is a note (not a rest), no further updates are requires and the current beat evaluation location is advanced to the note (or rest) after the dotted eighth, double dotted quarter, or triple dotted half note rest.

Otherwise, processing advances to FIG. 11 steps 540-570 (connector O) where, if the rest located at the current beat evaluation location is a dotted ⅛th rest, the 16th note that is on the beat and the dotted ⅛th rest are simplified into ¼ note rest on the beat. If additional elements exist in the measure, current beat evaluation location is advanced to the element following the ¼ note rest just created. If the rest is not a dotted ⅛th rest, processing continues at FIG. 12 step 580 (connector P) to determine at step 590 if the rest located at the current beat evaluation location is a double dotted ¼ note rest. If it is, the double dotted ¼ rest and 1/16th note rest before it on the beat evaluation location are combined into a ½ note rest on the beat. If no further elements exists in the measure, and the current is 2/4, the contents of the measure are deleted (step 605). If further elements exist, the current beat evaluation location is advanced to the note (or rest) after the ½ note rest which was just created.

If the rest located at the current beat evaluation location is something other than a double dotted ¼ note rest, processing continues at FIG. 13 steps 620-640 (connector Q) where the 1/16th note rest and the triple dotted ½ rest are combined into a whole note rest on the beat. If there are no further elements in the measure and the current time signature is 4/4 or C, the contents of the measure are deleted. Otherwise, the current beat evaluation location is advanced to the element after the newly-created whole note rest.

Additional 4-to-3 note processing occurs at FIGS. 18-46 to accommodate note combination scenarios including, for example and without limitation, 1/16ths on the “and” and “ah” of the best (steps 940-1030), combinations with prior notes (steps 1040-1400), dotted, double dotted, or triple dotted 1/16th notes or rests (steps 1410-1440), 1/16th, 1/16th triplet, dotted ⅛th, double dotted quarter note, or triple dotted half note combinations (steps 1450-1530), double and triple dotted ⅛th, 14, and ½ notes or rests (steps 1540-1600), simplification to ¼ notes and rests (steps 1610-1710), and cut time and staccato passages (steps 1720-2520).

FIGS. 47-61 illustrate the process for simplifying rhythms in ⅜, 6/8, 9/8 and 12/8 which represent time signatures where dotted quarter notes represent the beat, e.g., compound meters. This process introduces the concept of an A, B, and C ⅛^{th} note that when added together represent the same value as a dotted quarter note, which represents the beat (steps 2530-2560). The A ⅛^{th} note is the ⅛^{th} note located on the beat. In this process, the objective is to remove any notes or rests that are 1/16^{th} note value, such that no notes faster than ⅛^{th} notes remain for the user to play (steps 2570-3090). This is consistent with what an early intermediate player would be comfortable with at a moderate tempo.

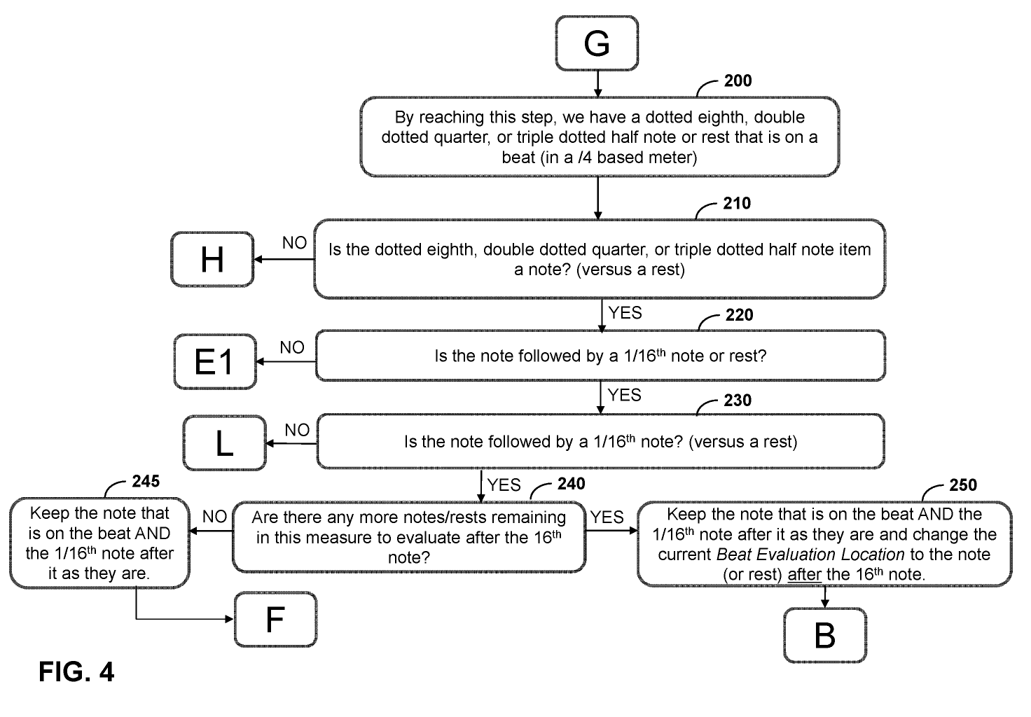

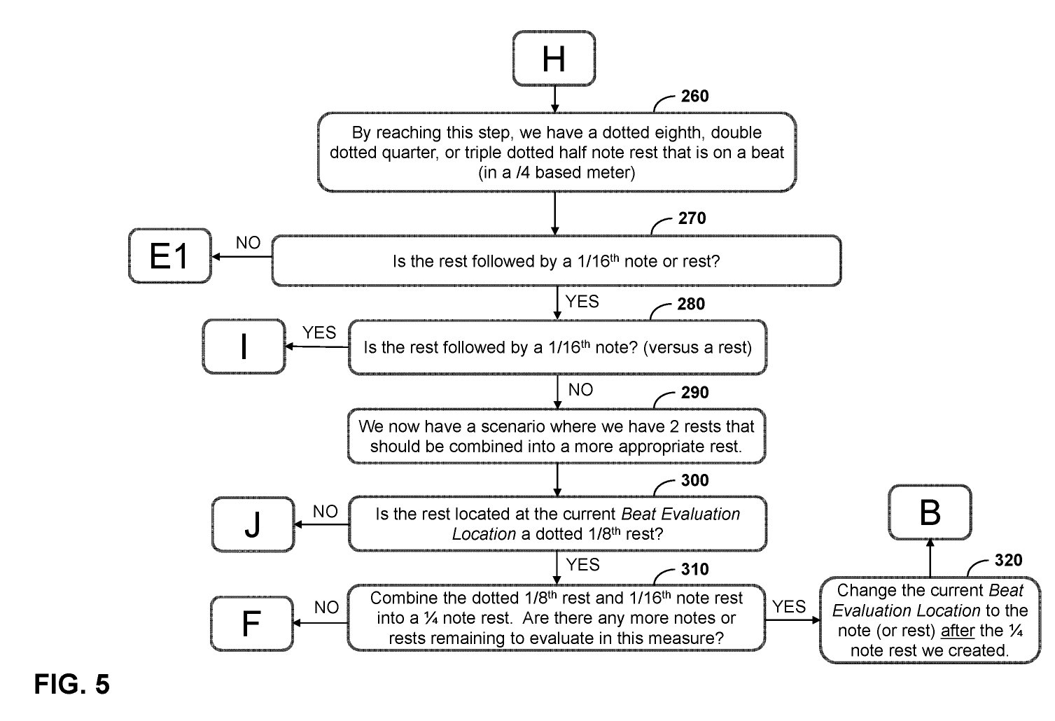

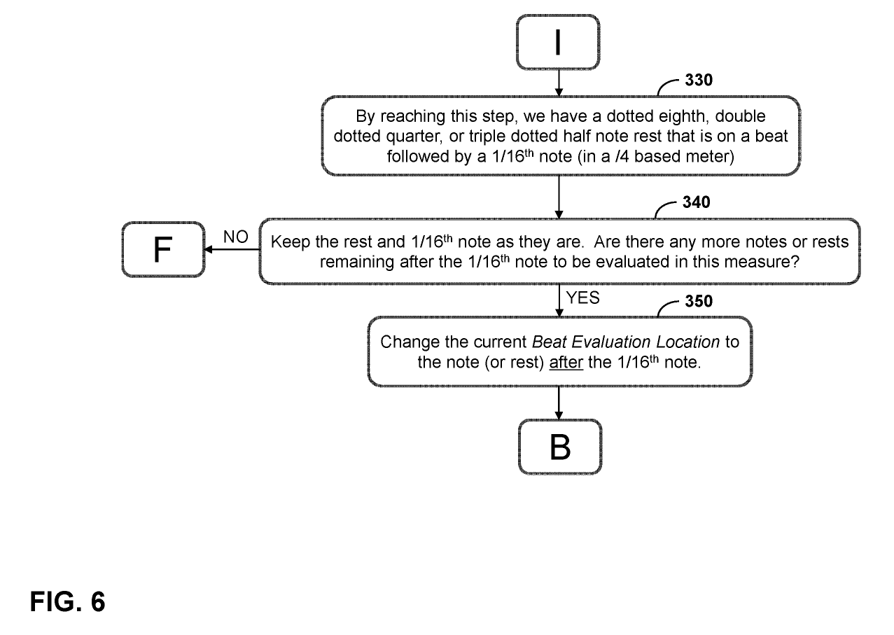

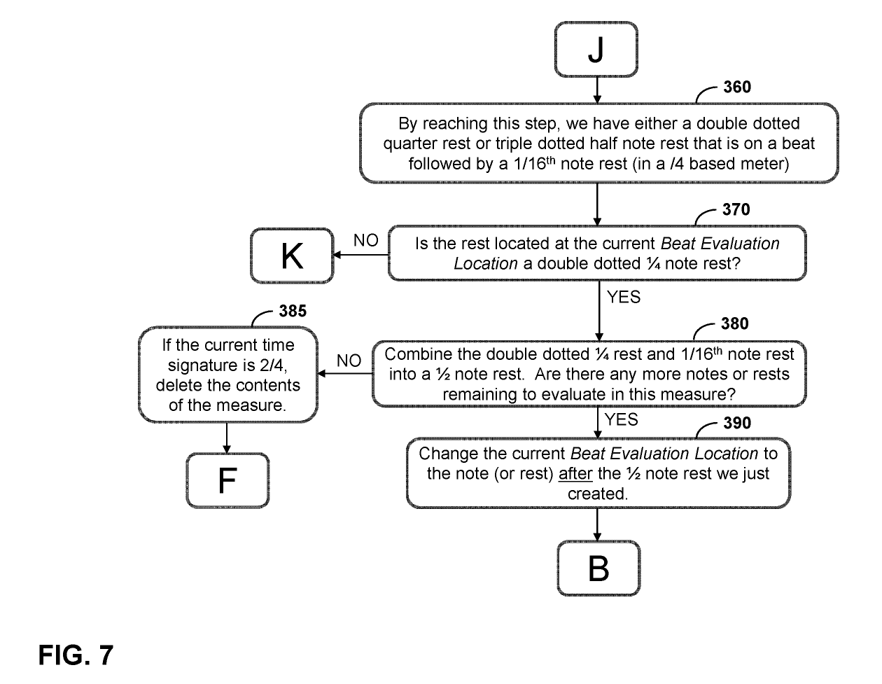

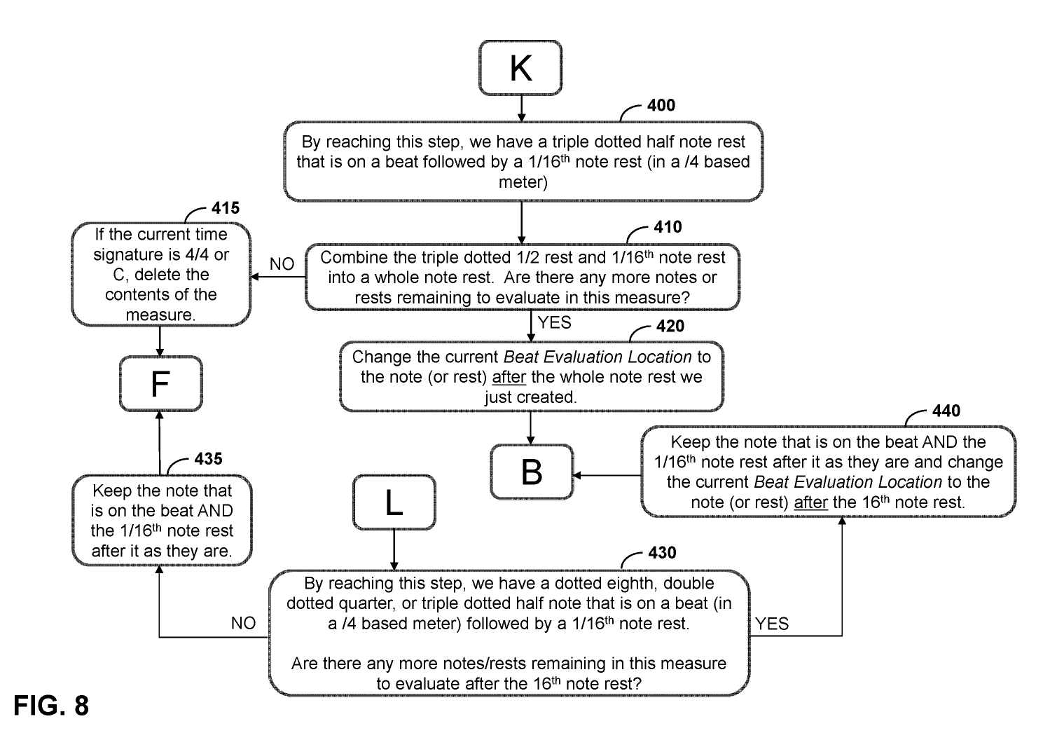

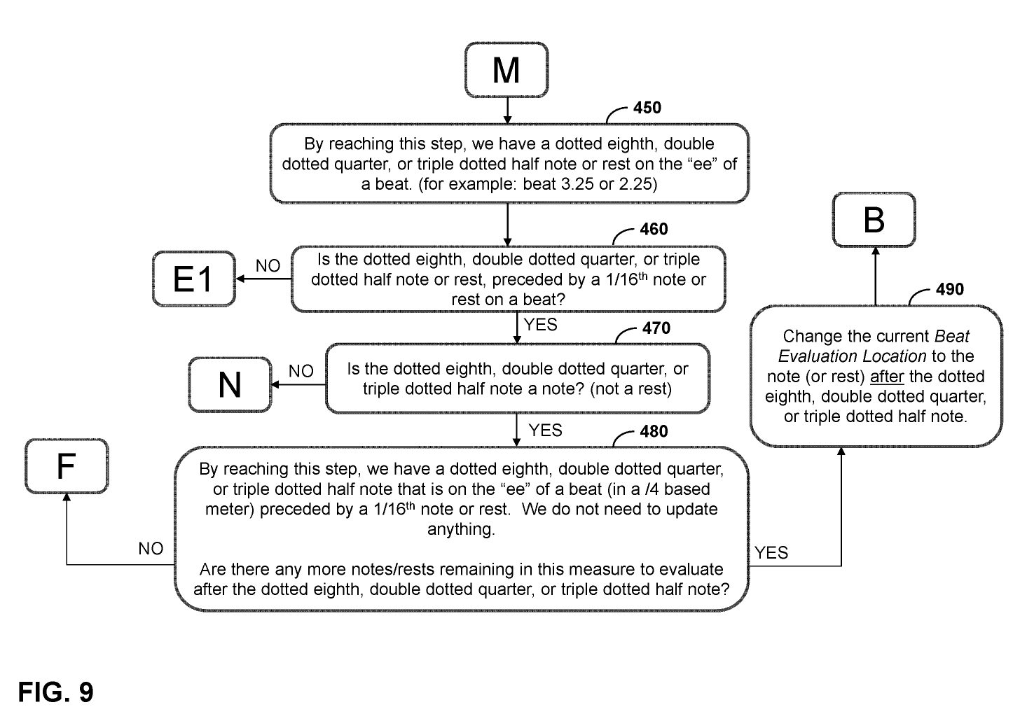

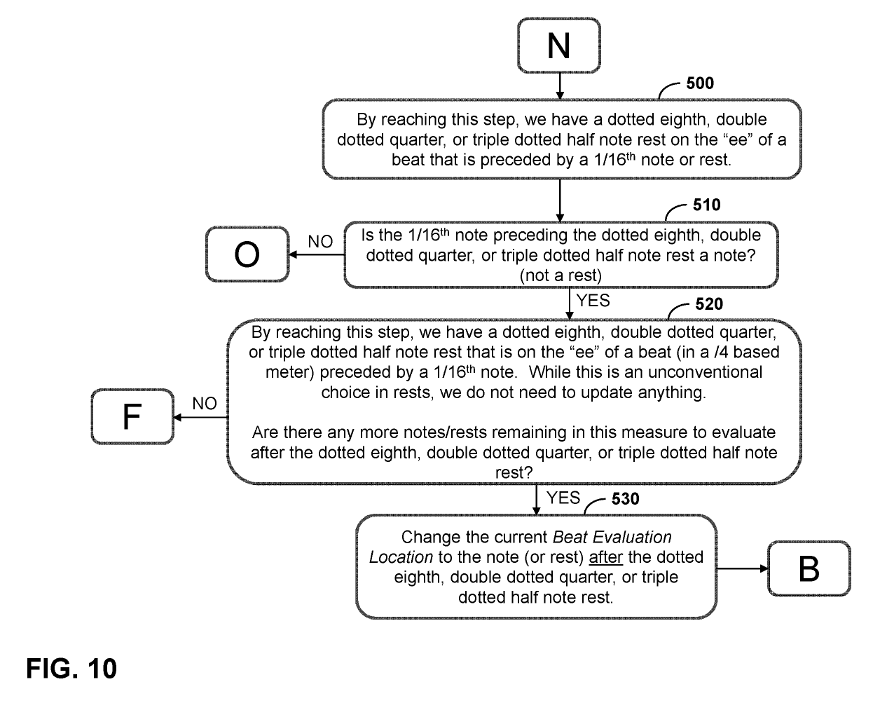

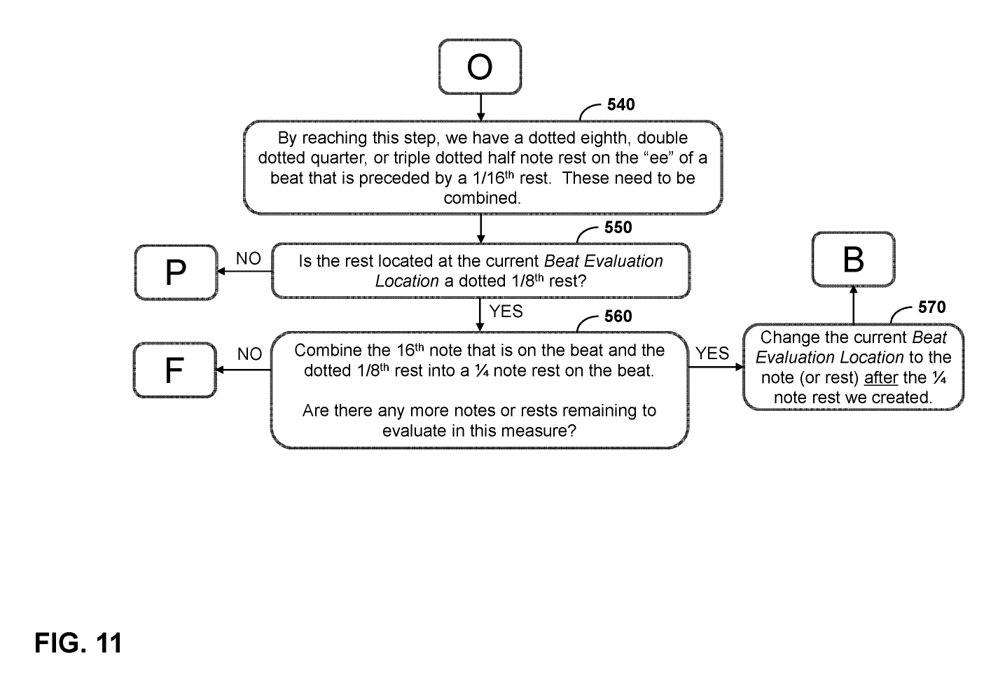

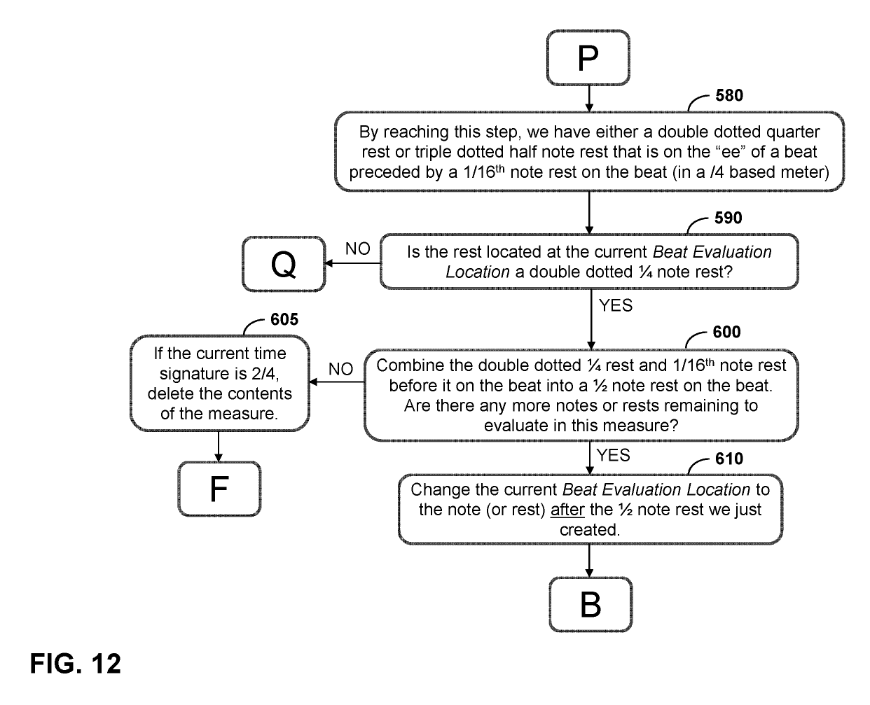

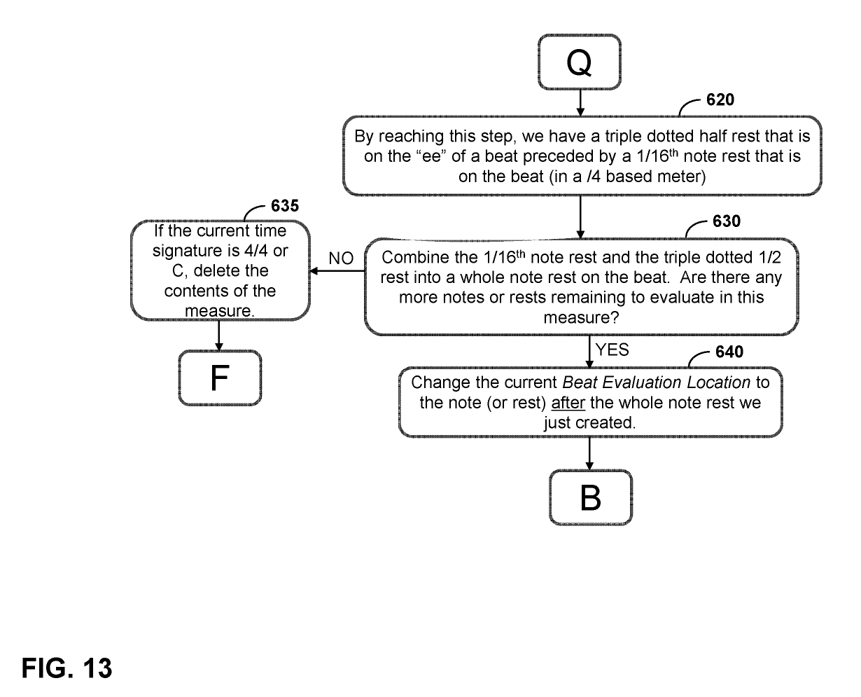

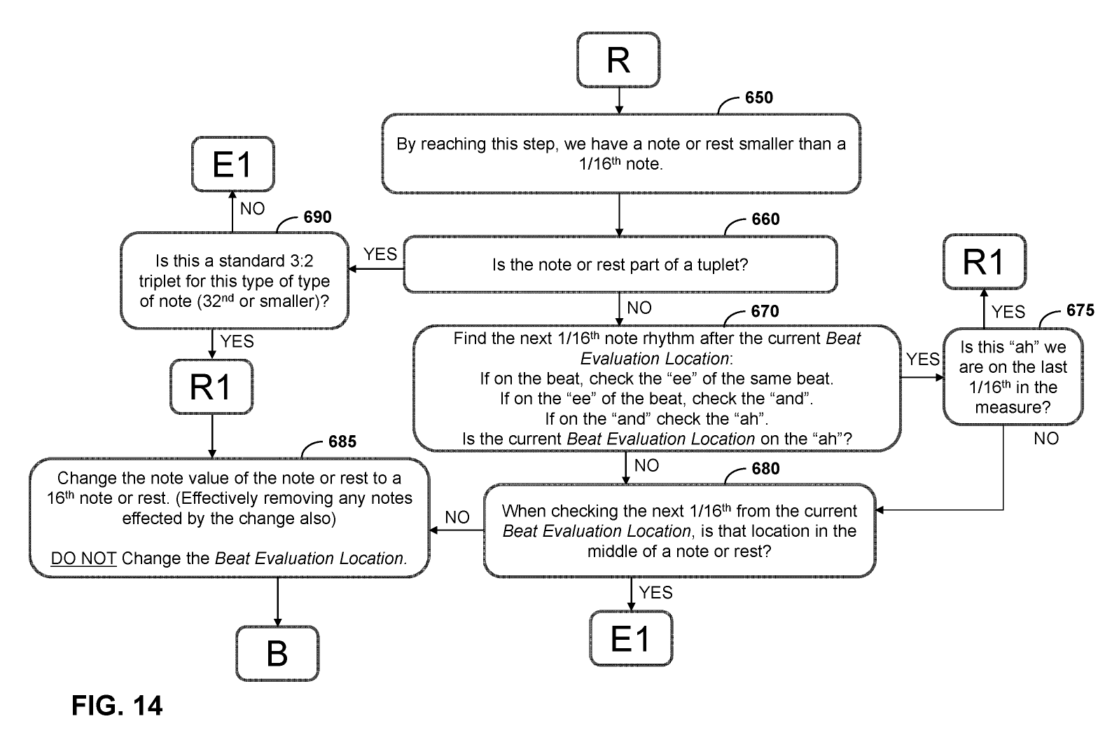

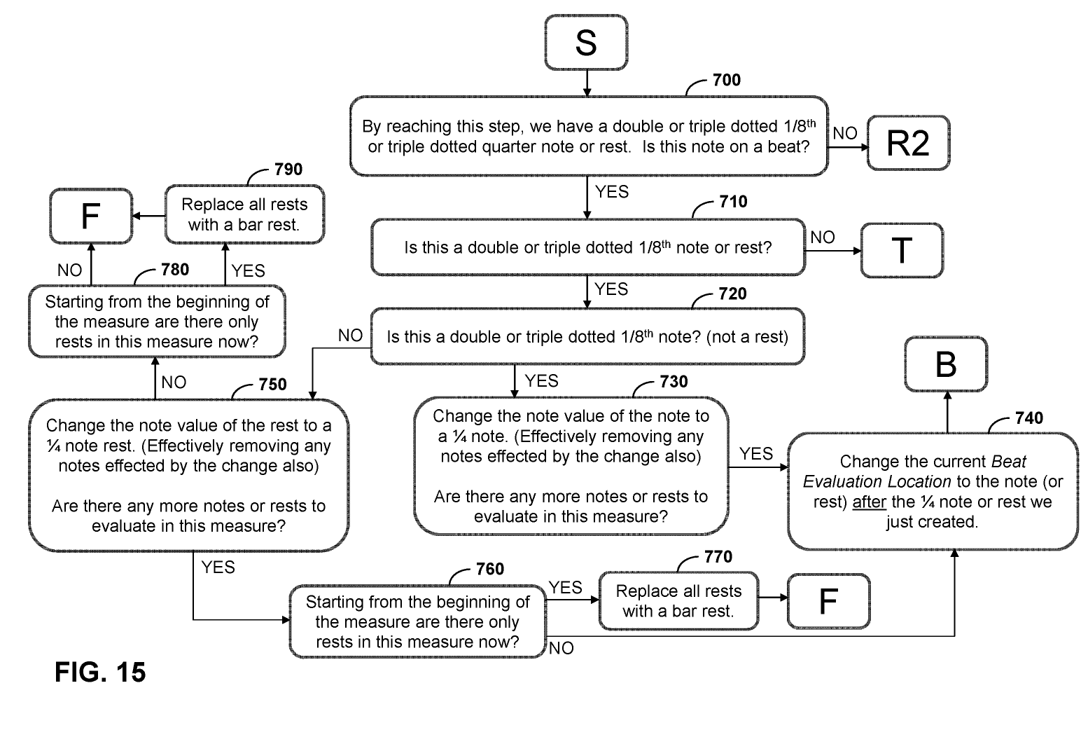

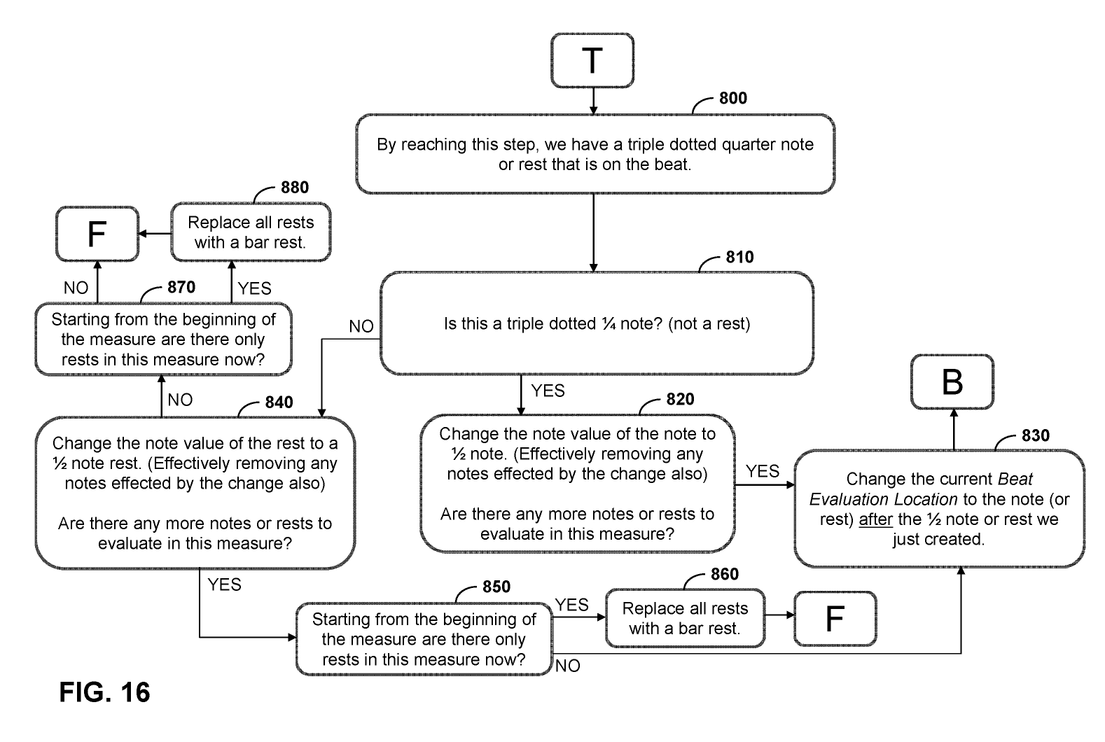

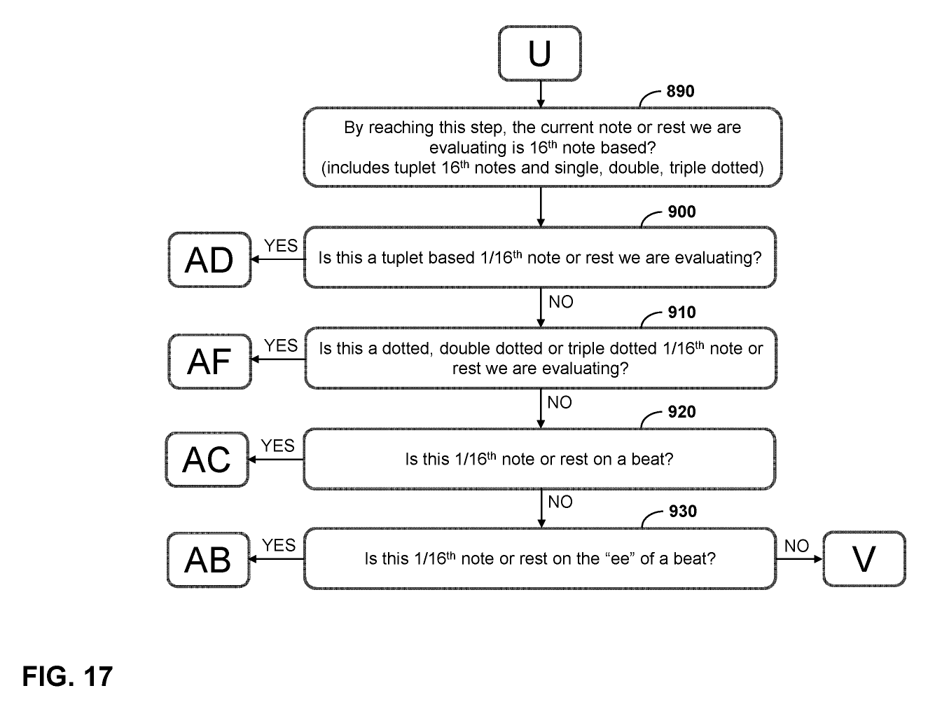

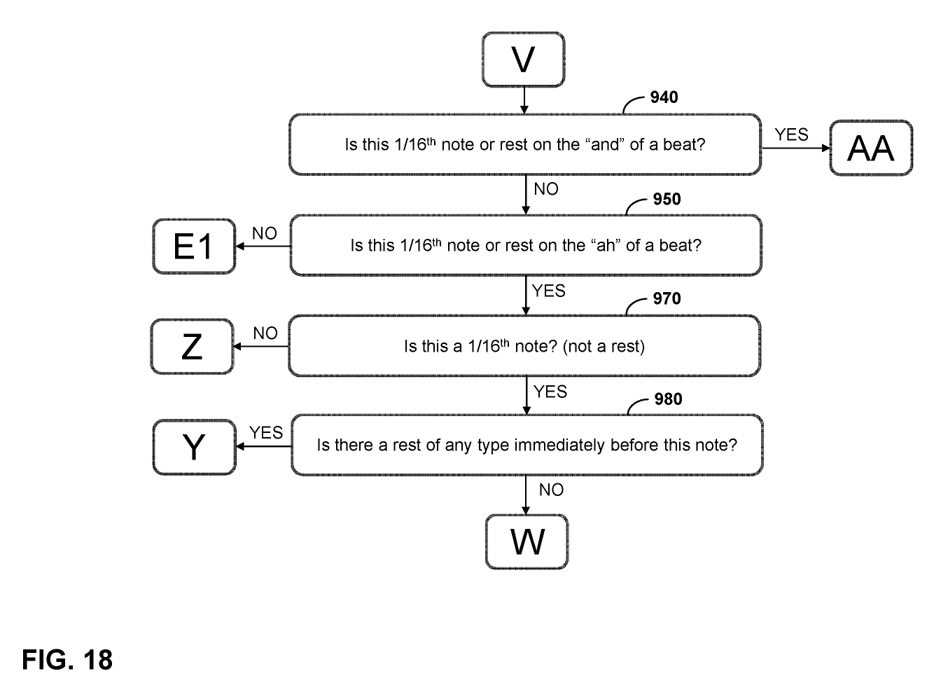

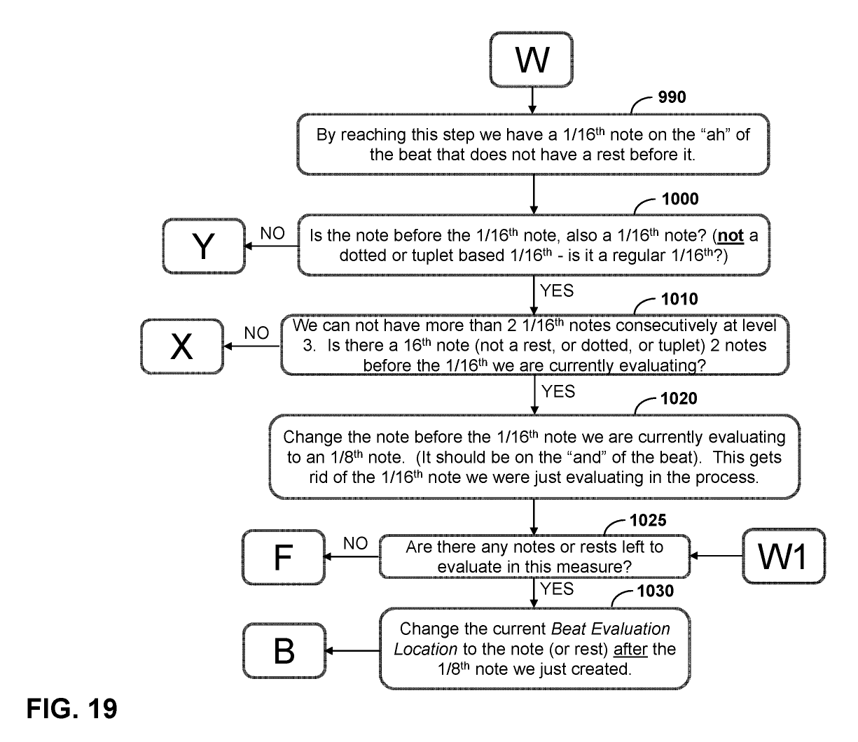

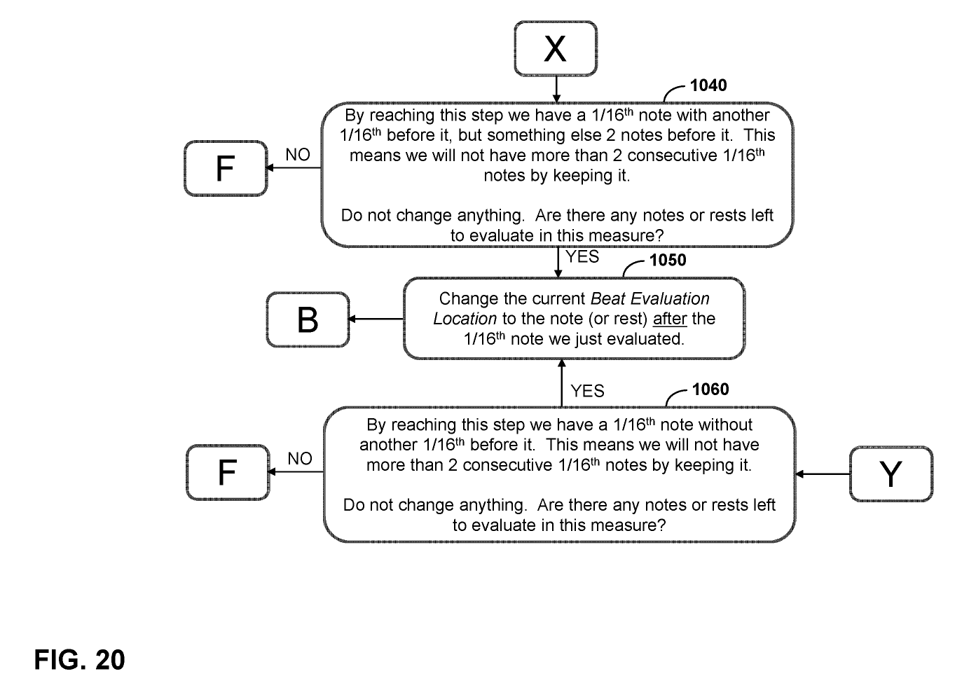

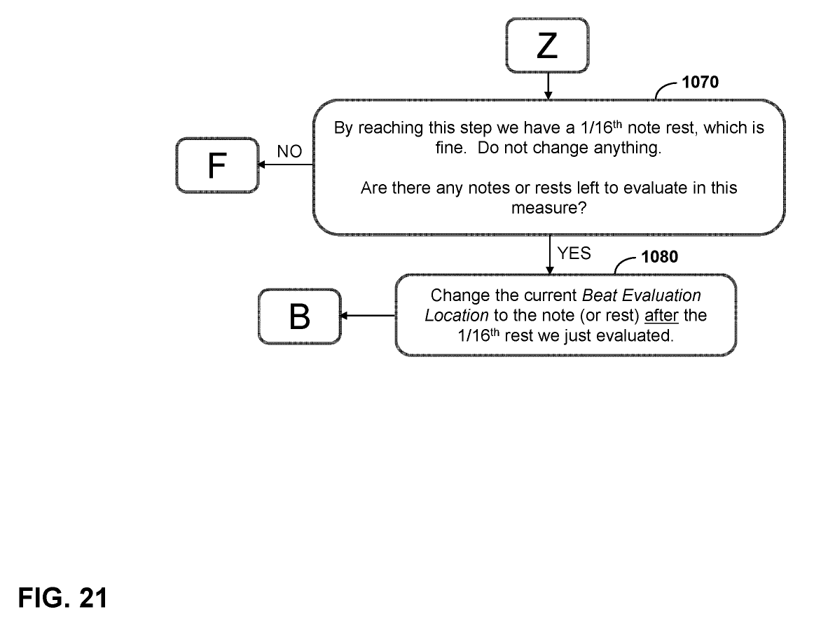

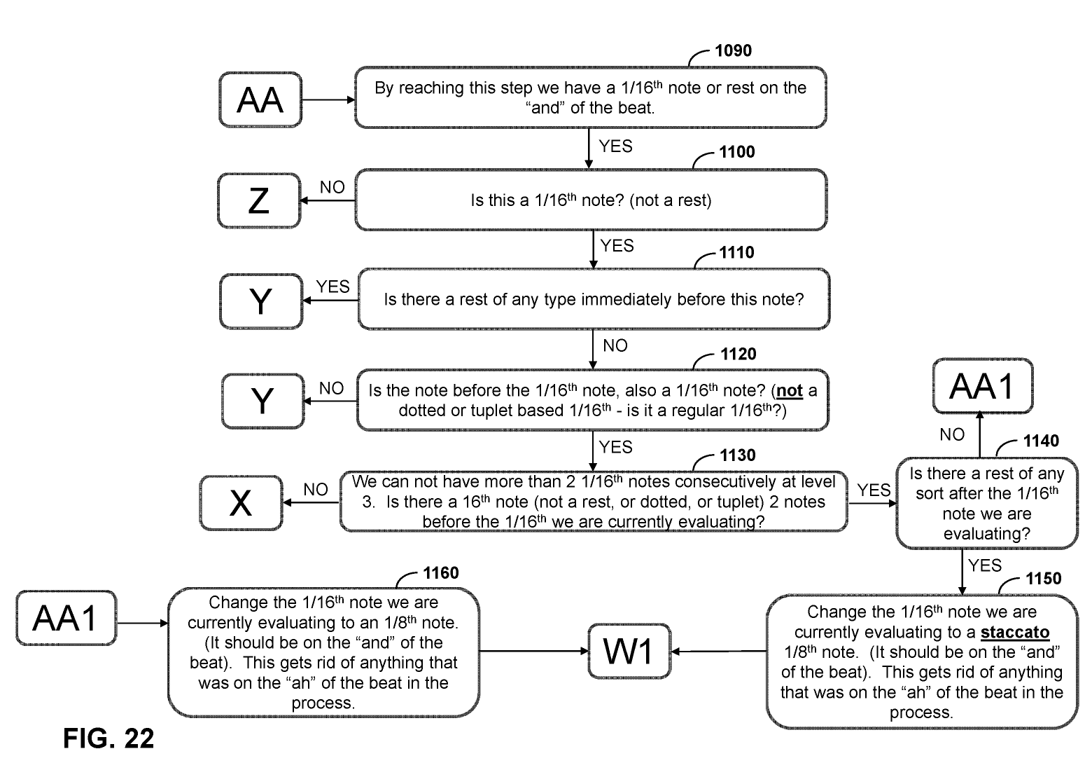

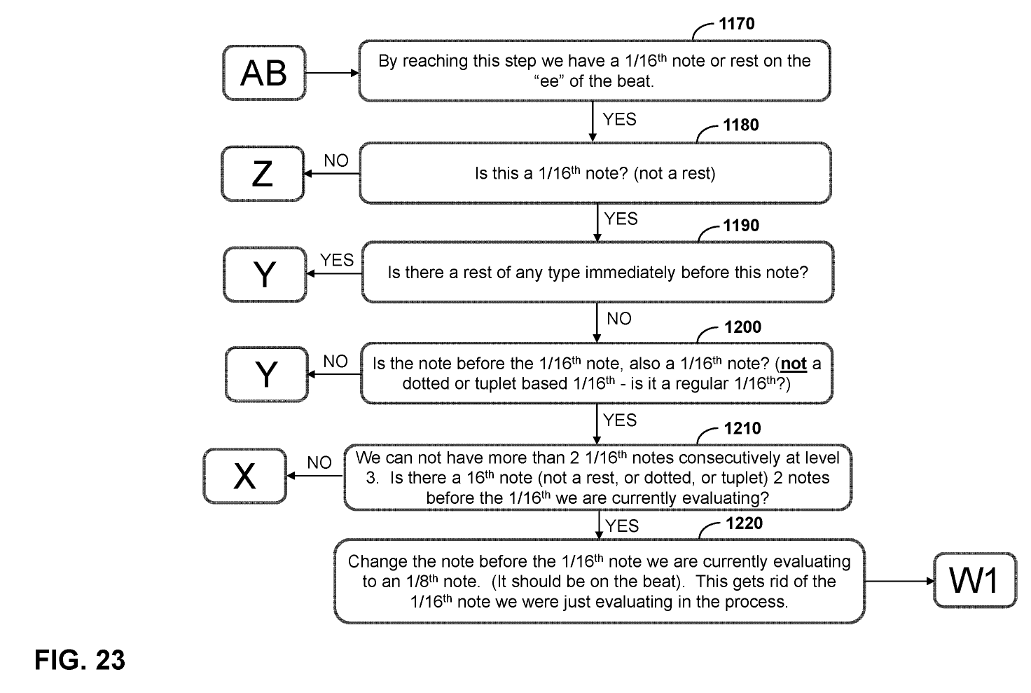

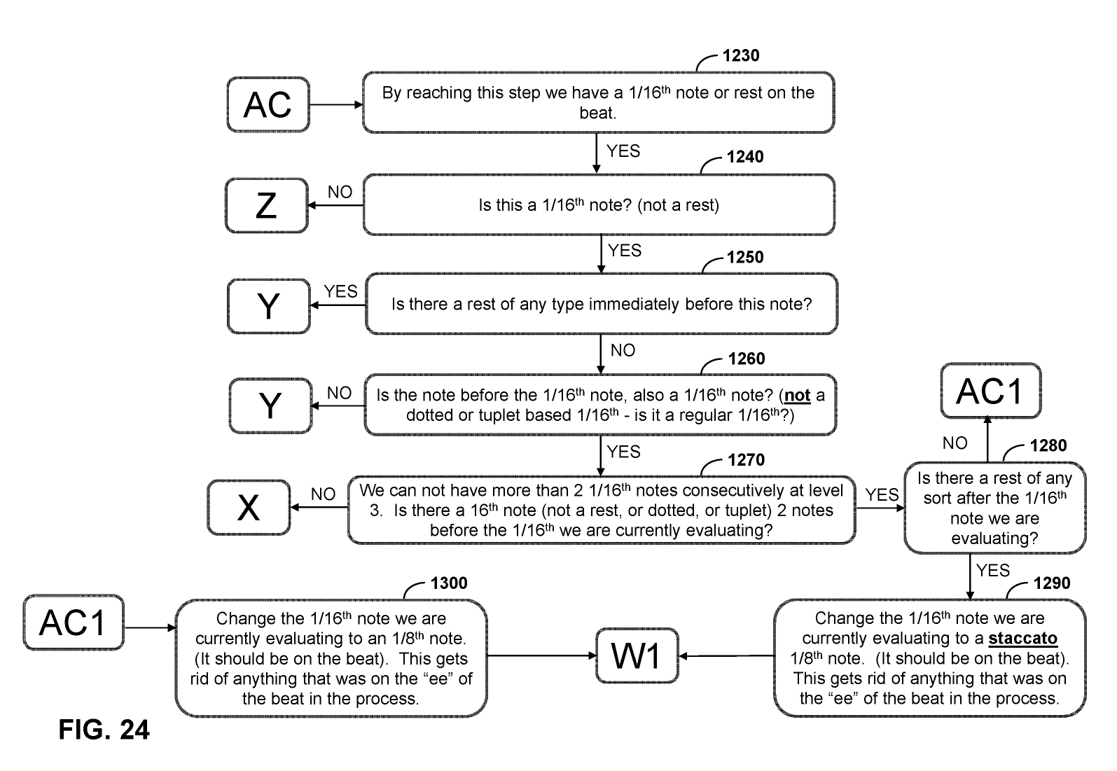

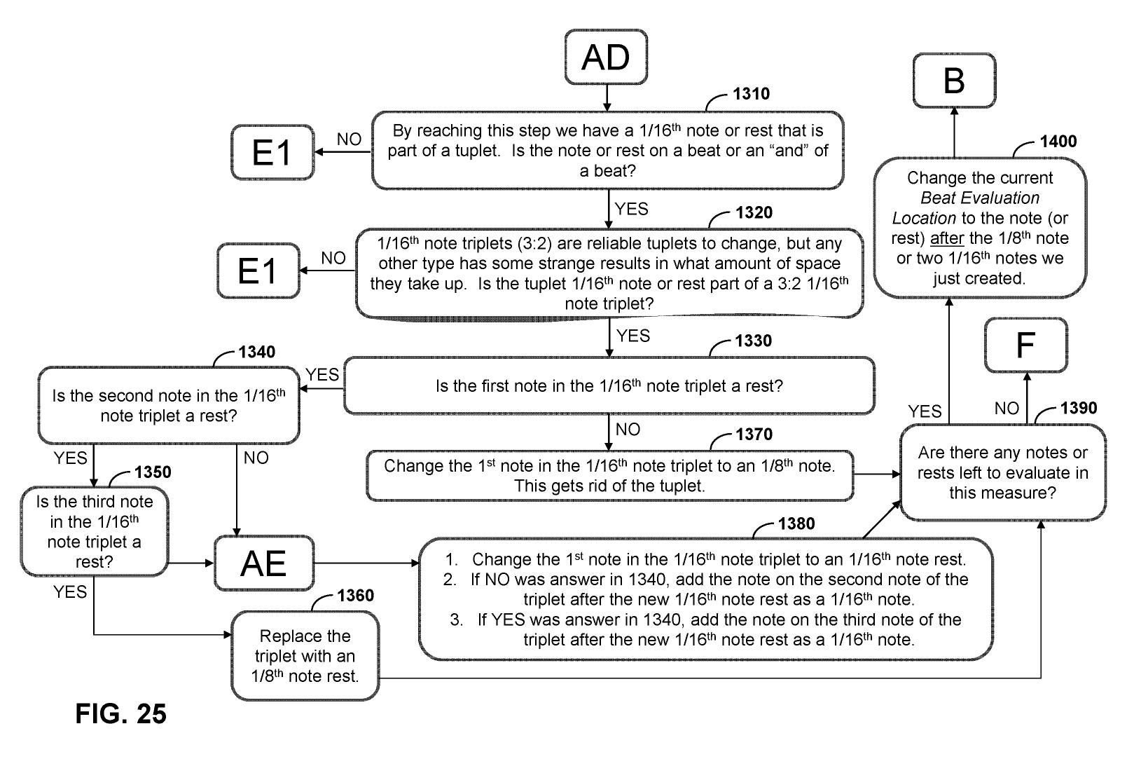

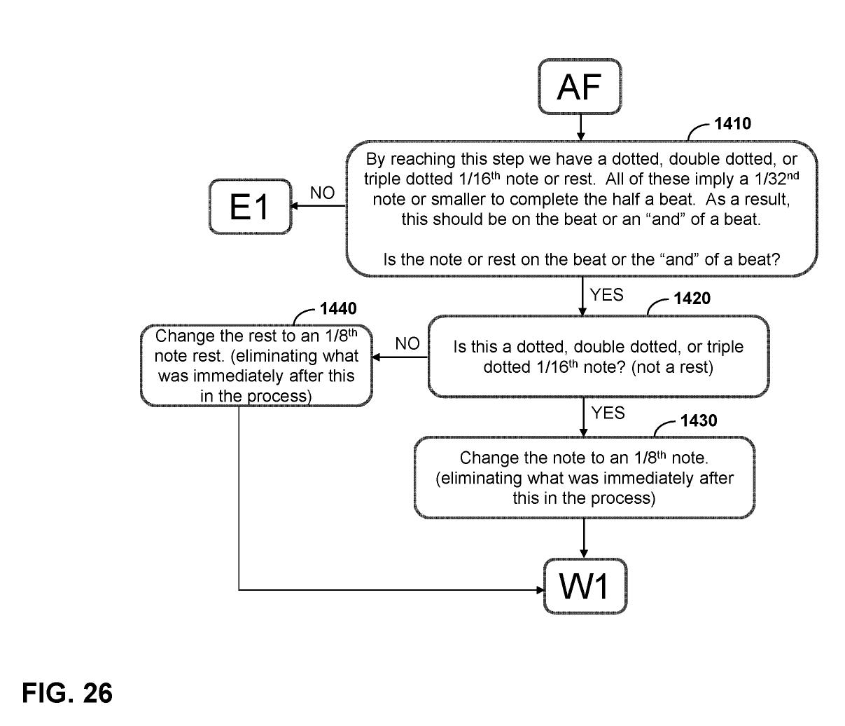

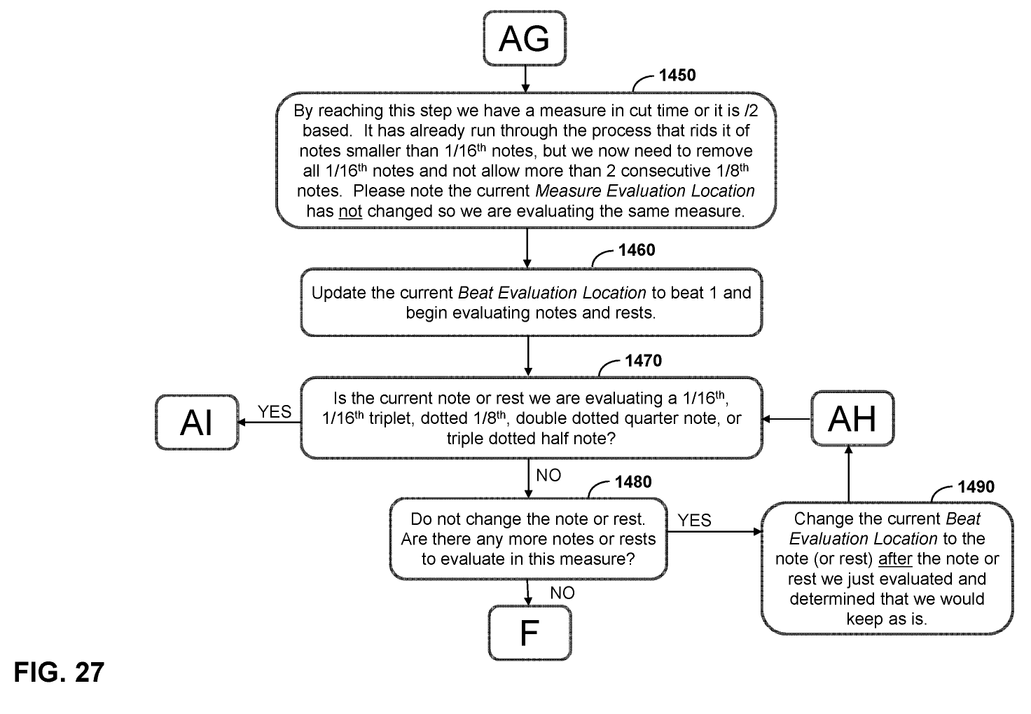

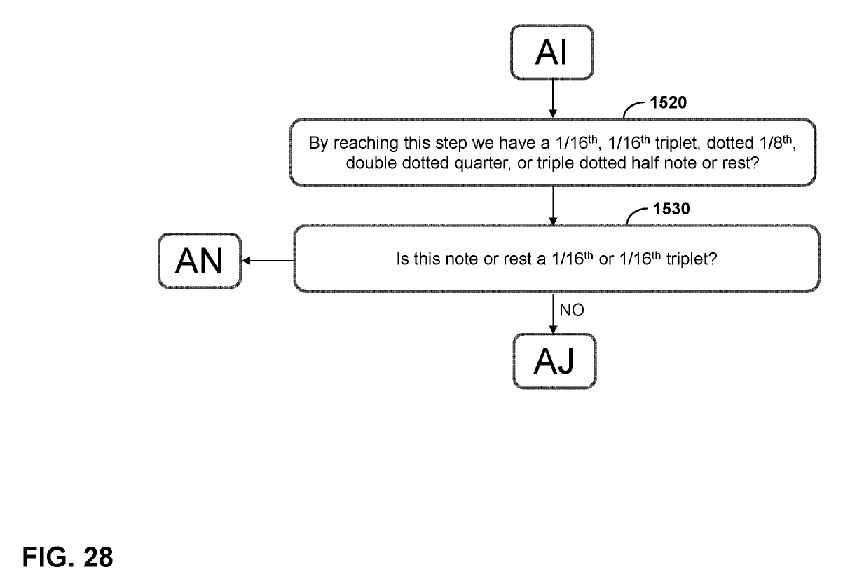

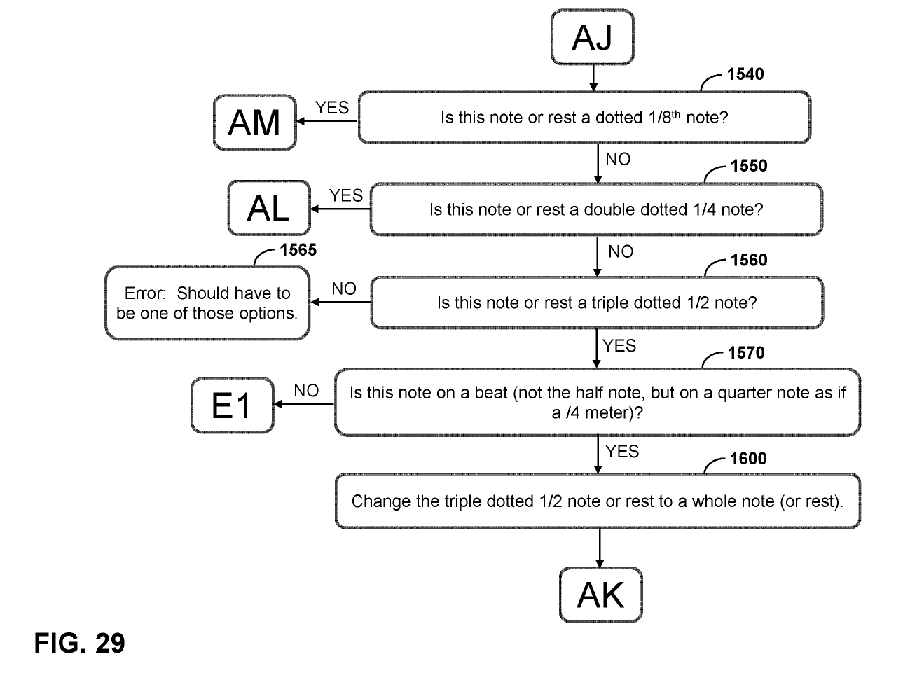

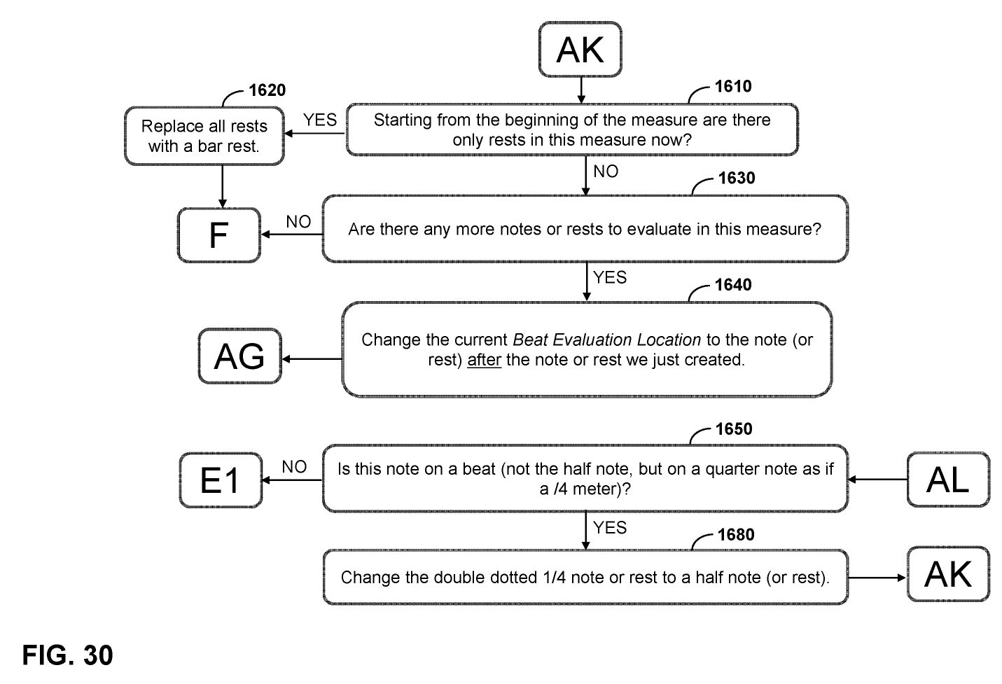

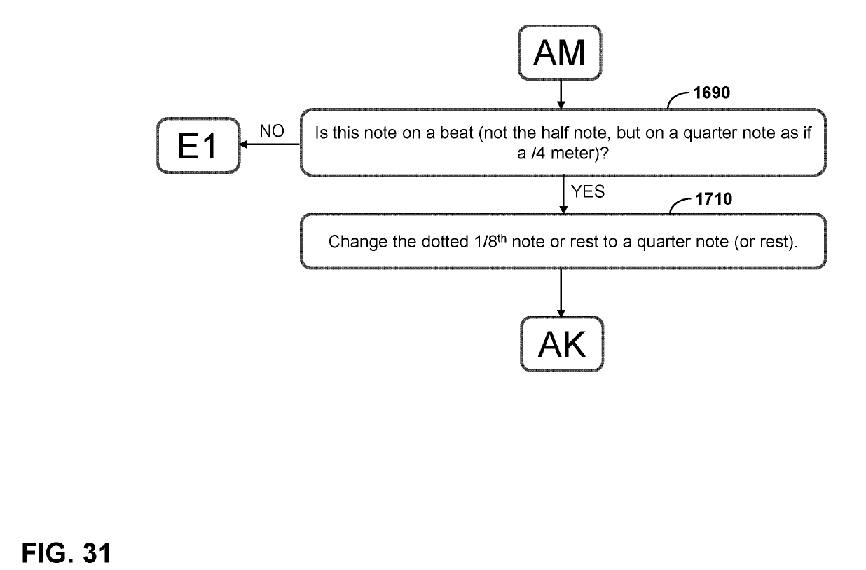

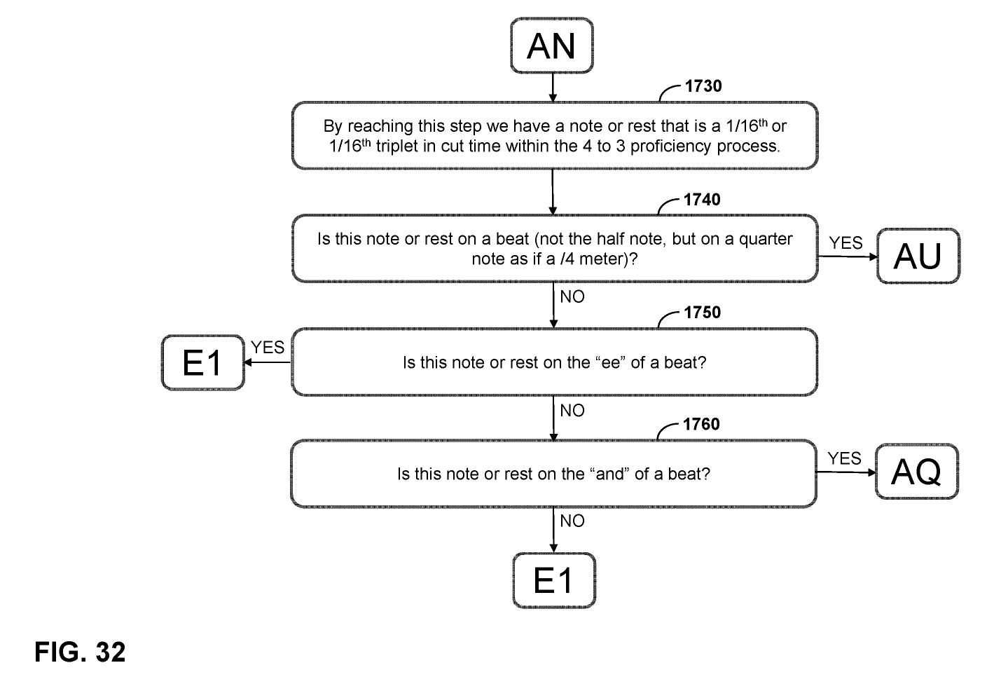

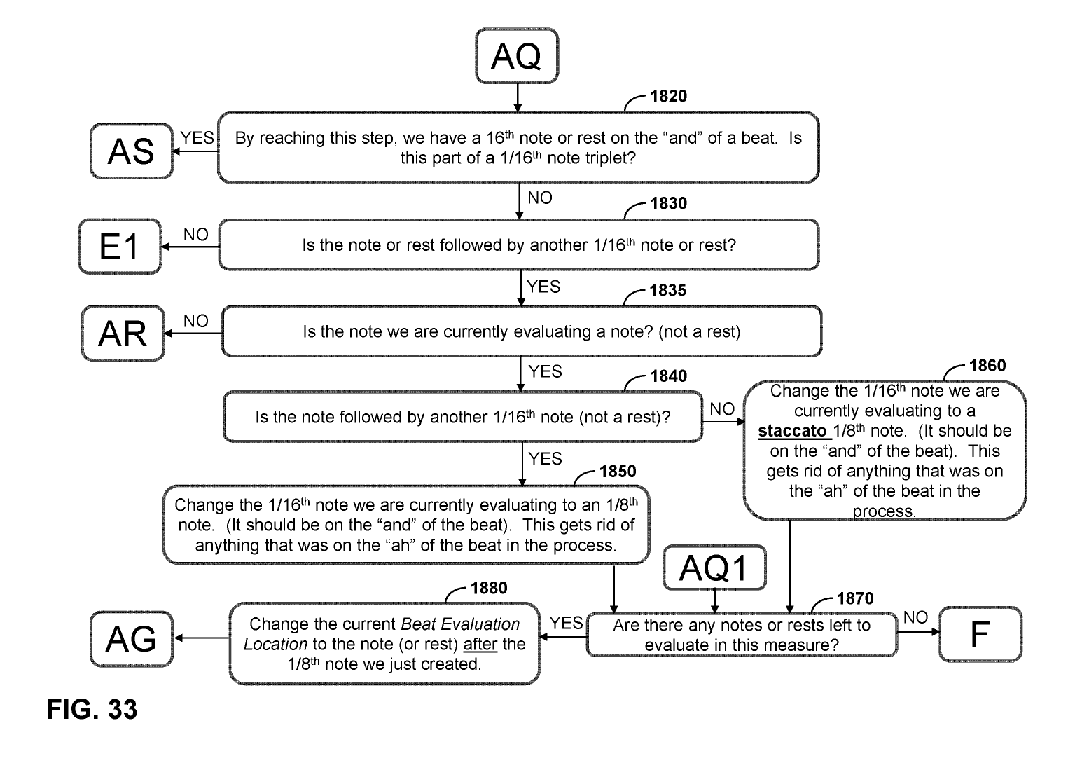

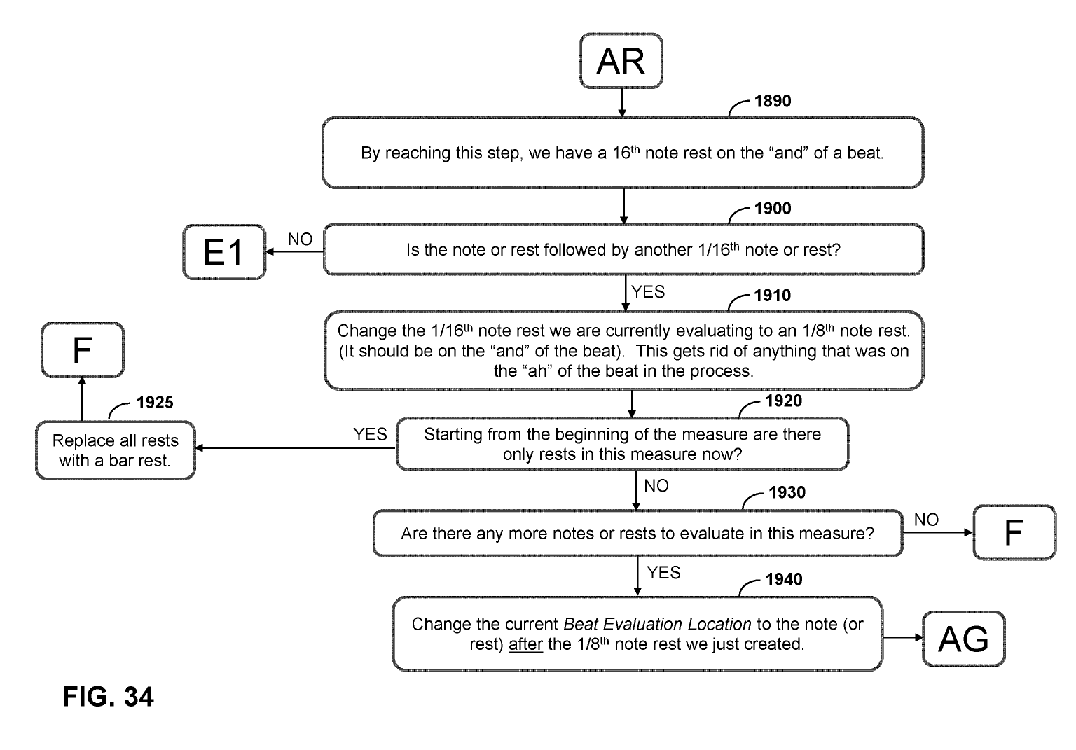

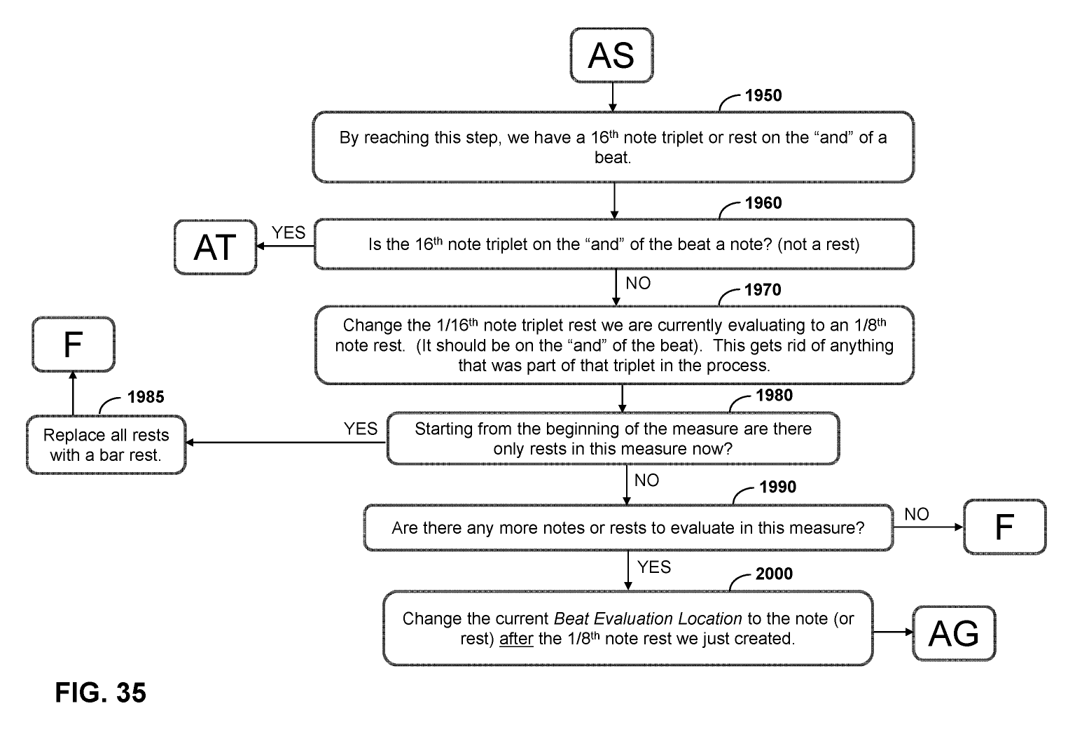

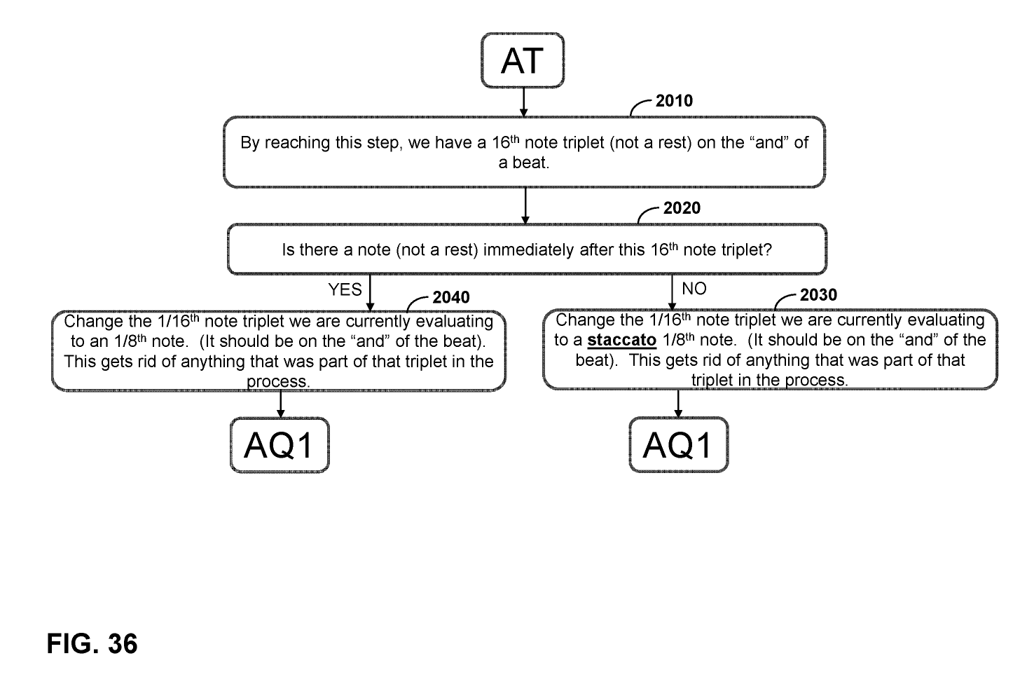

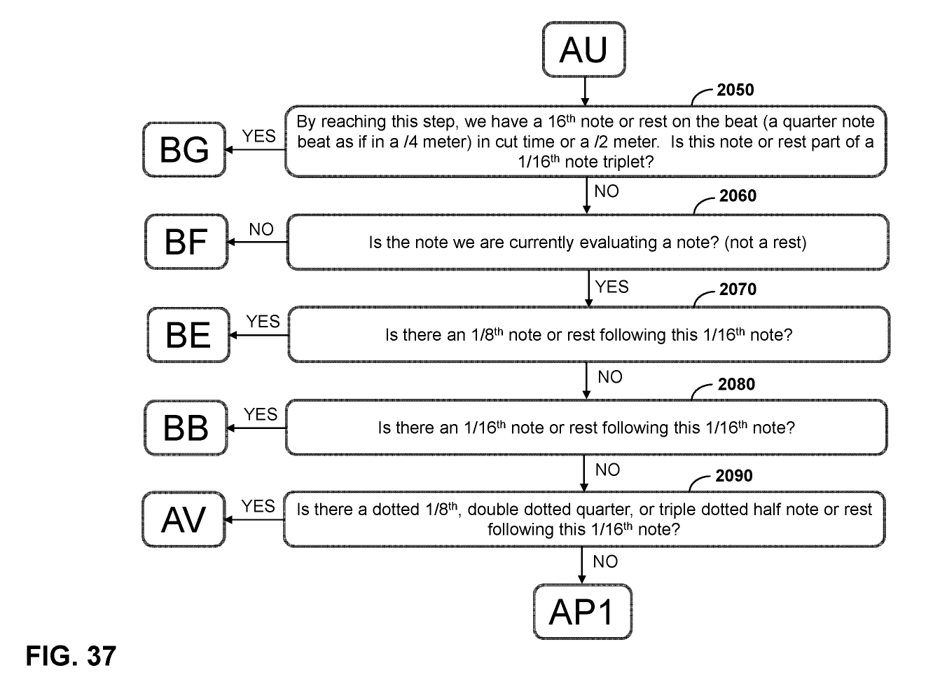

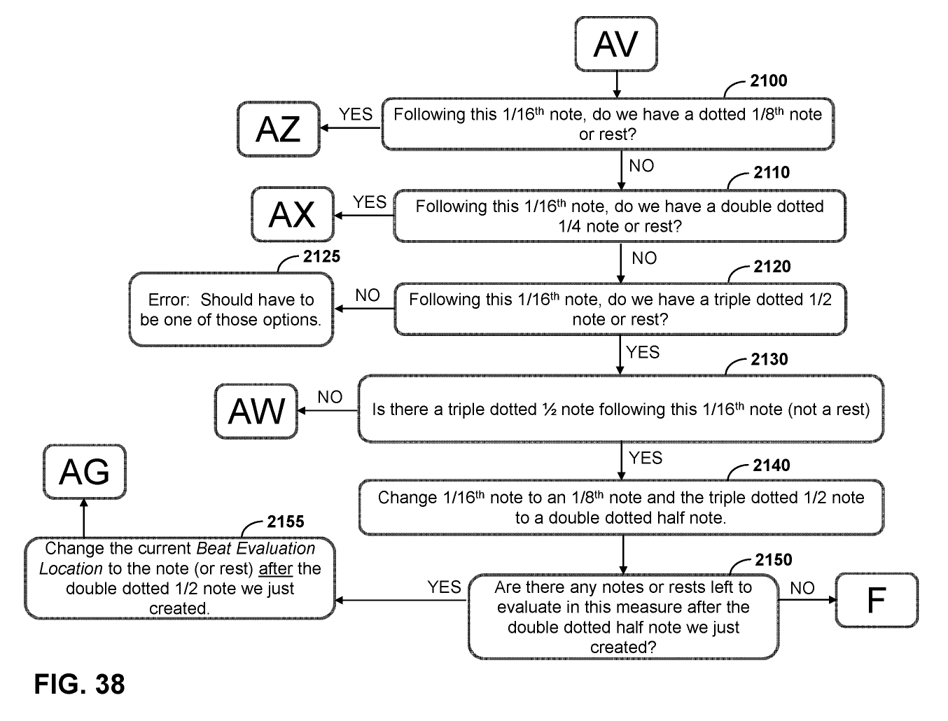

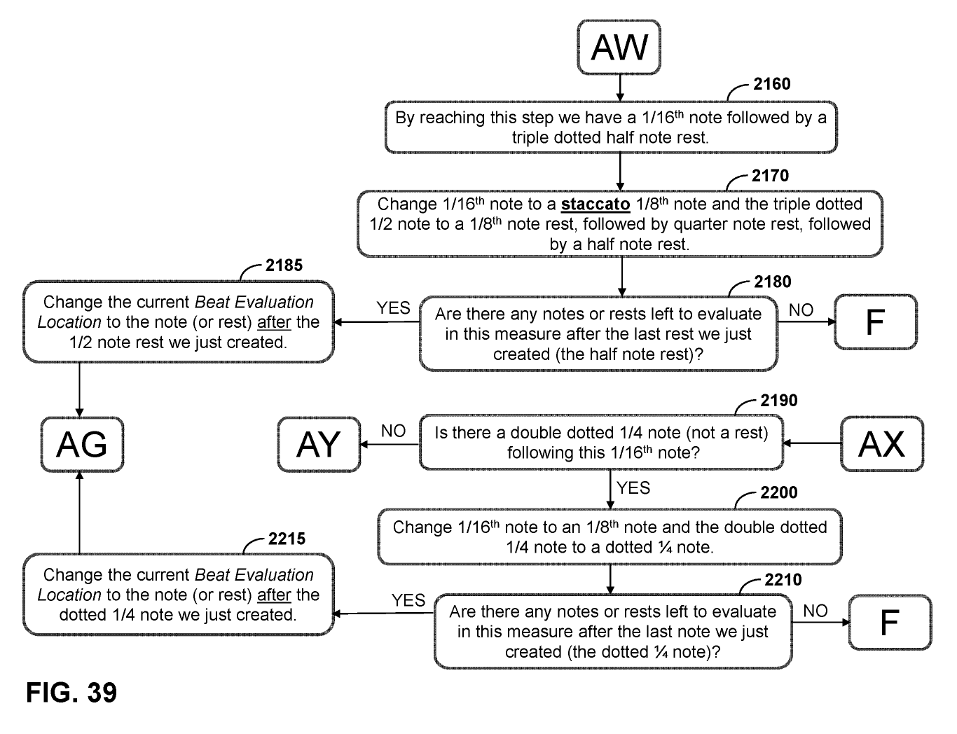

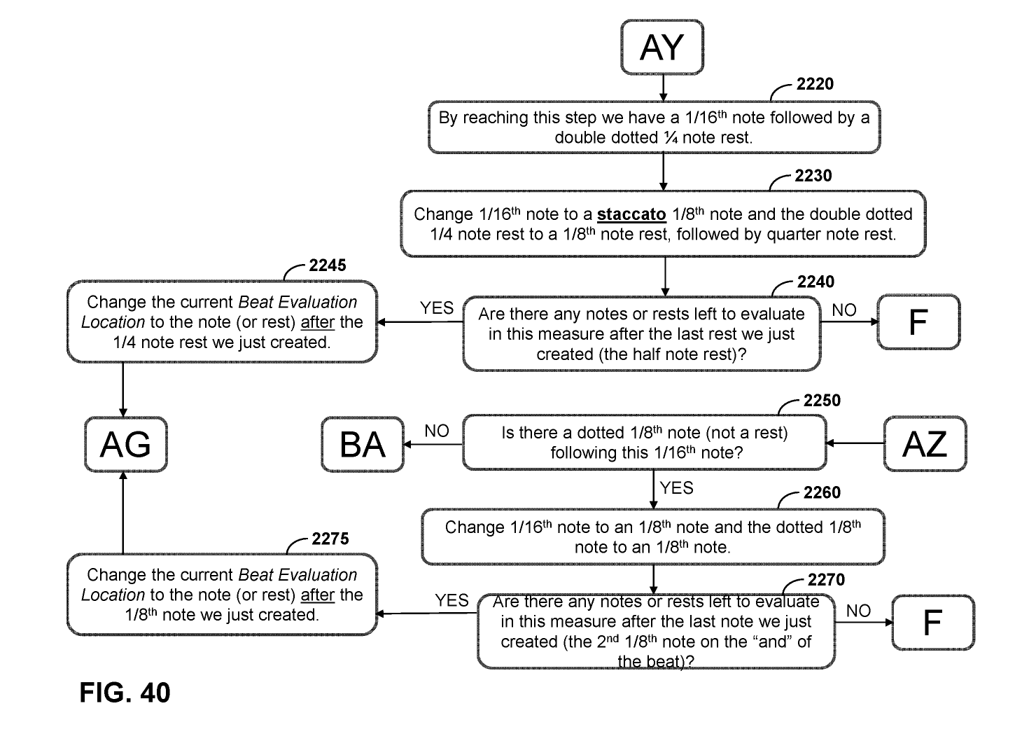

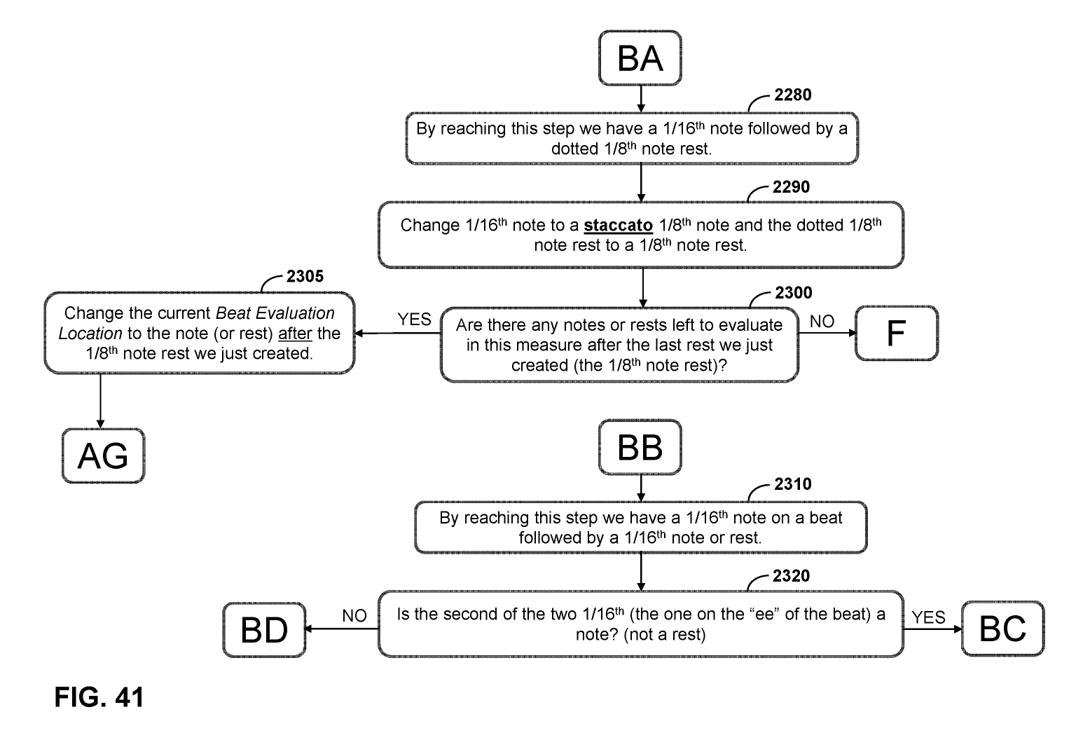

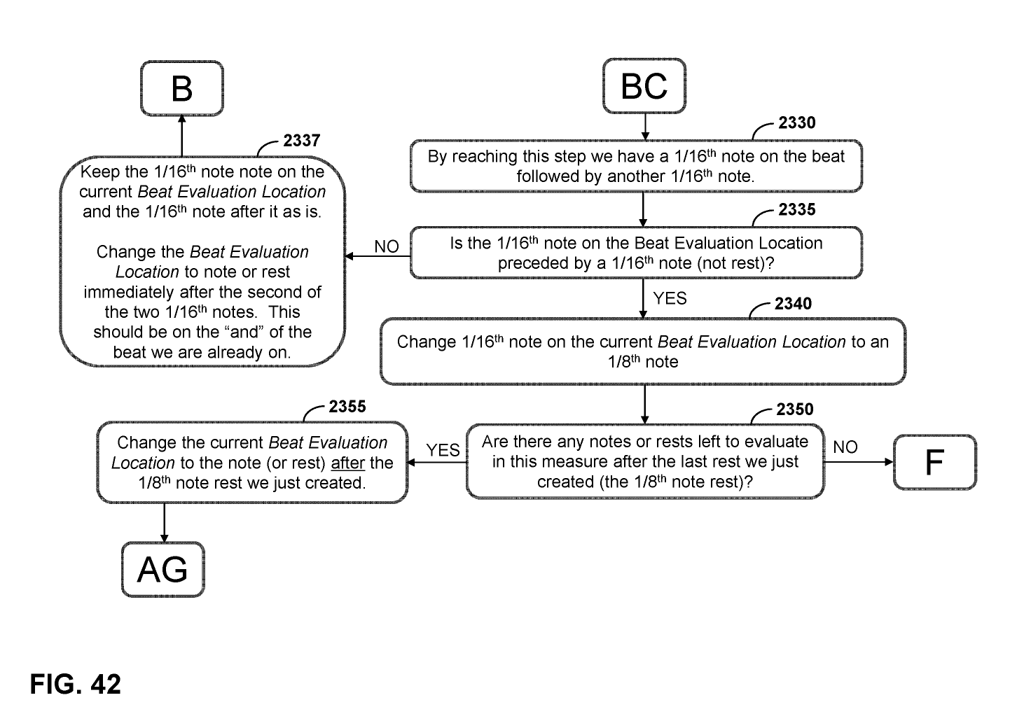

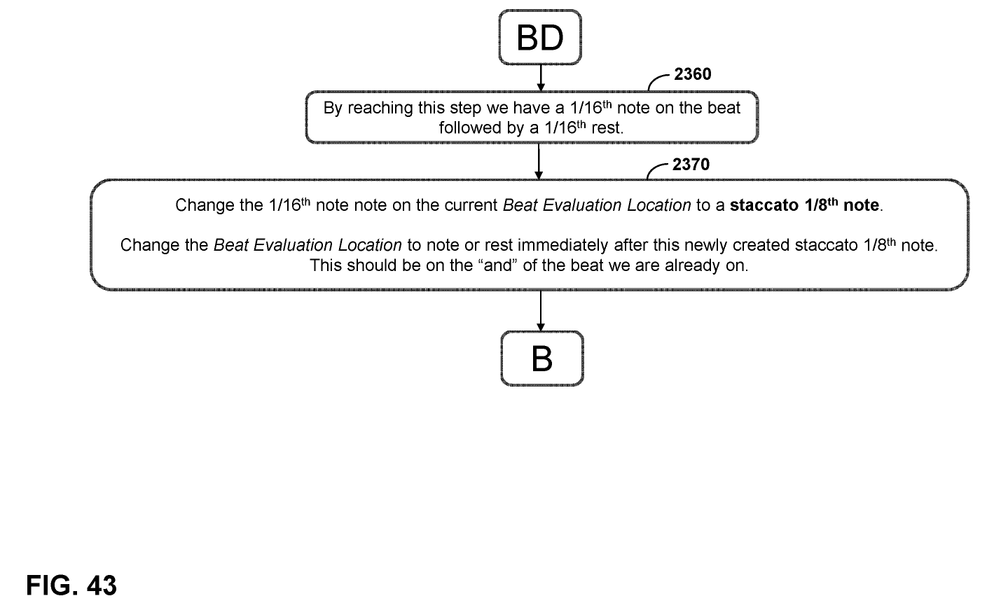

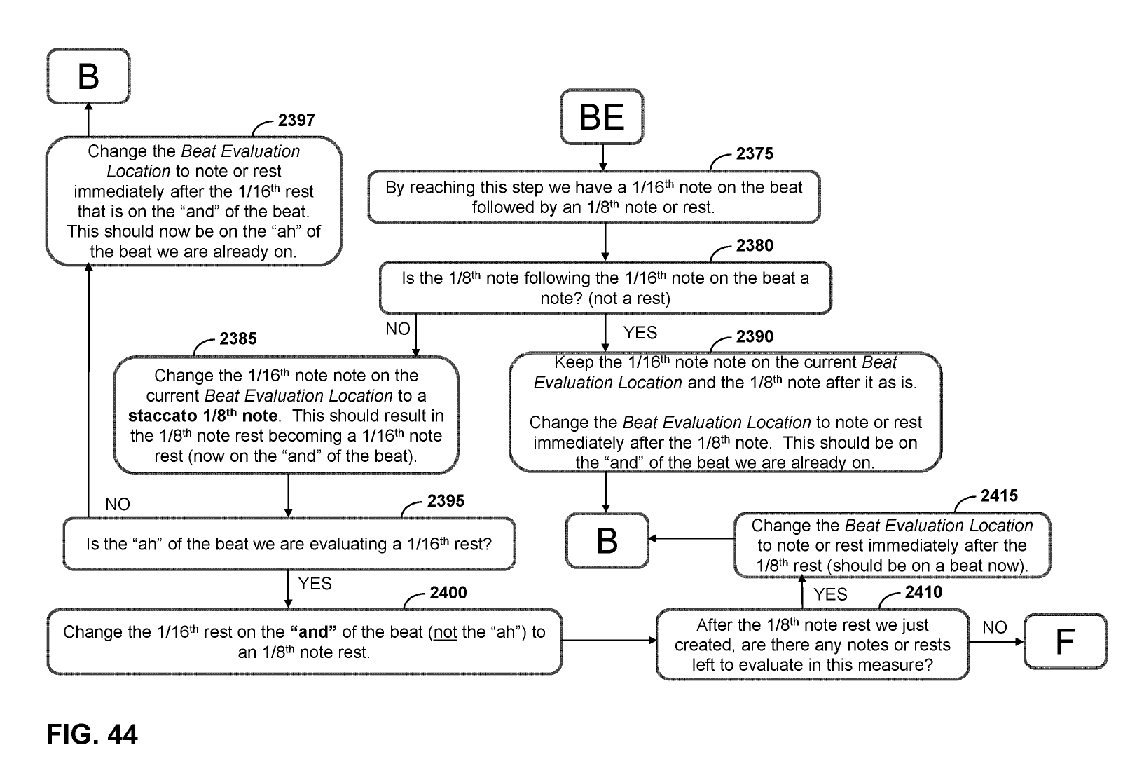

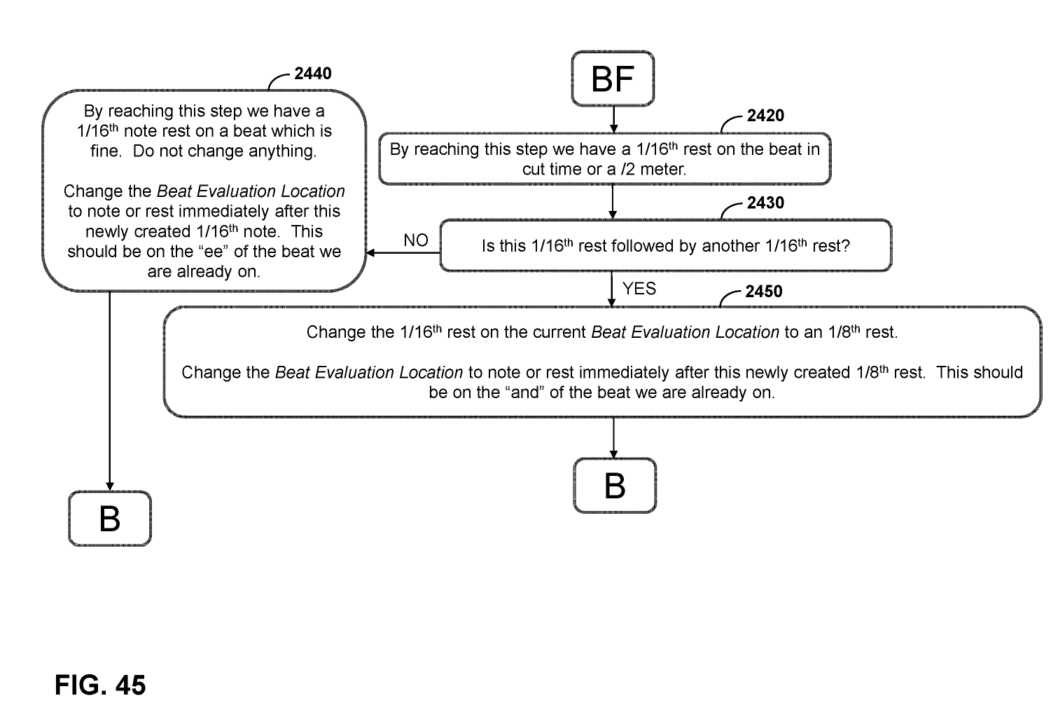

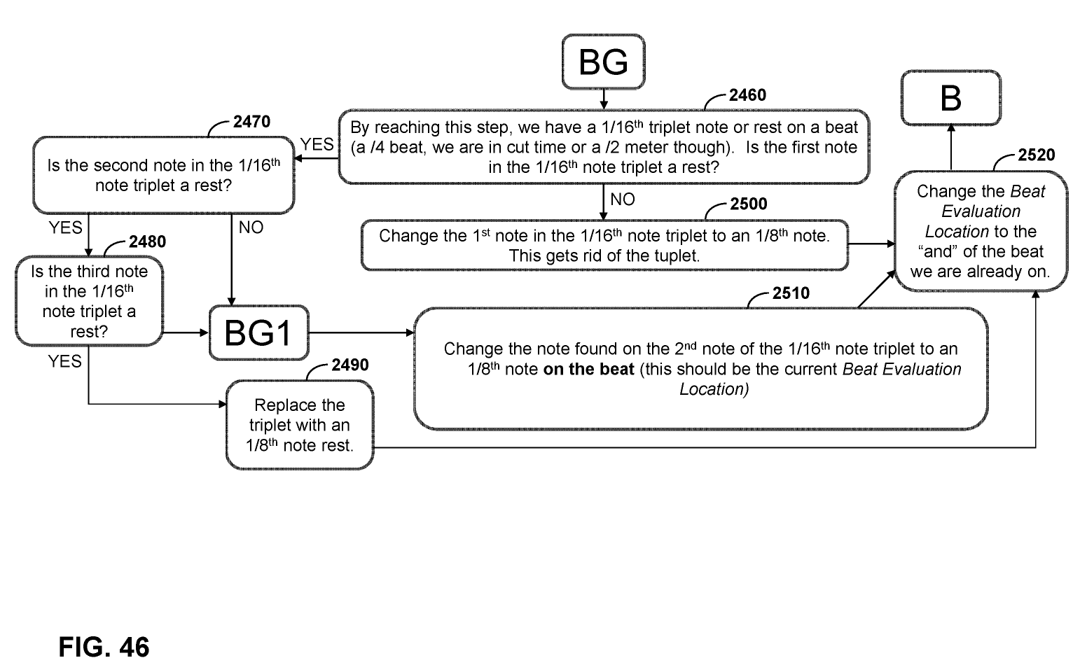

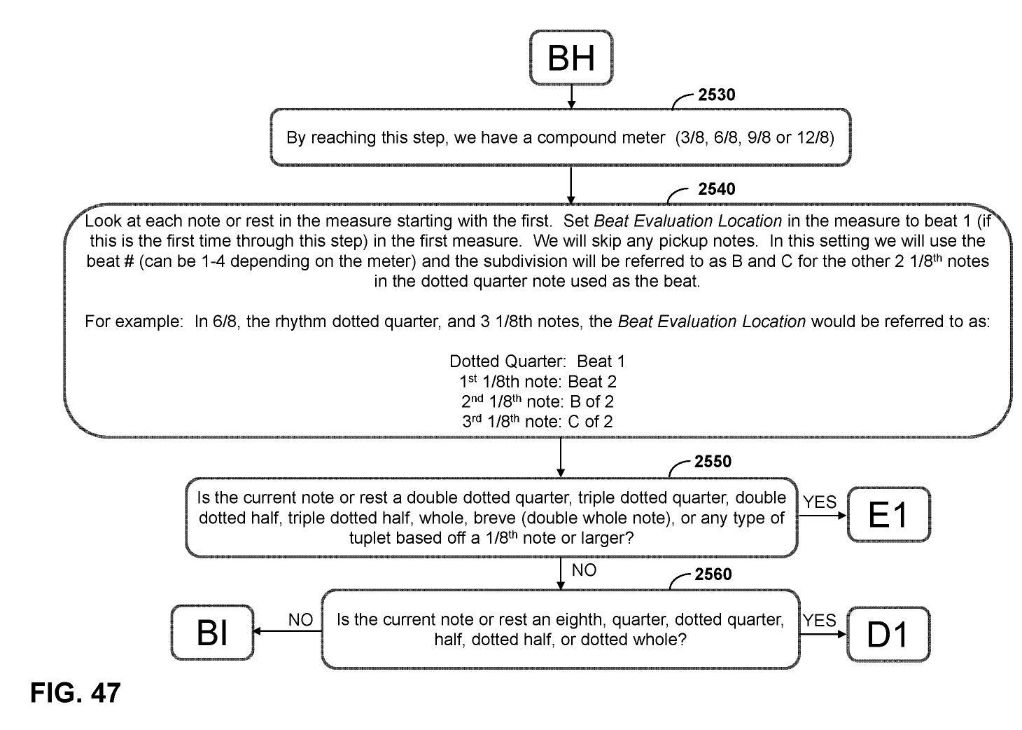

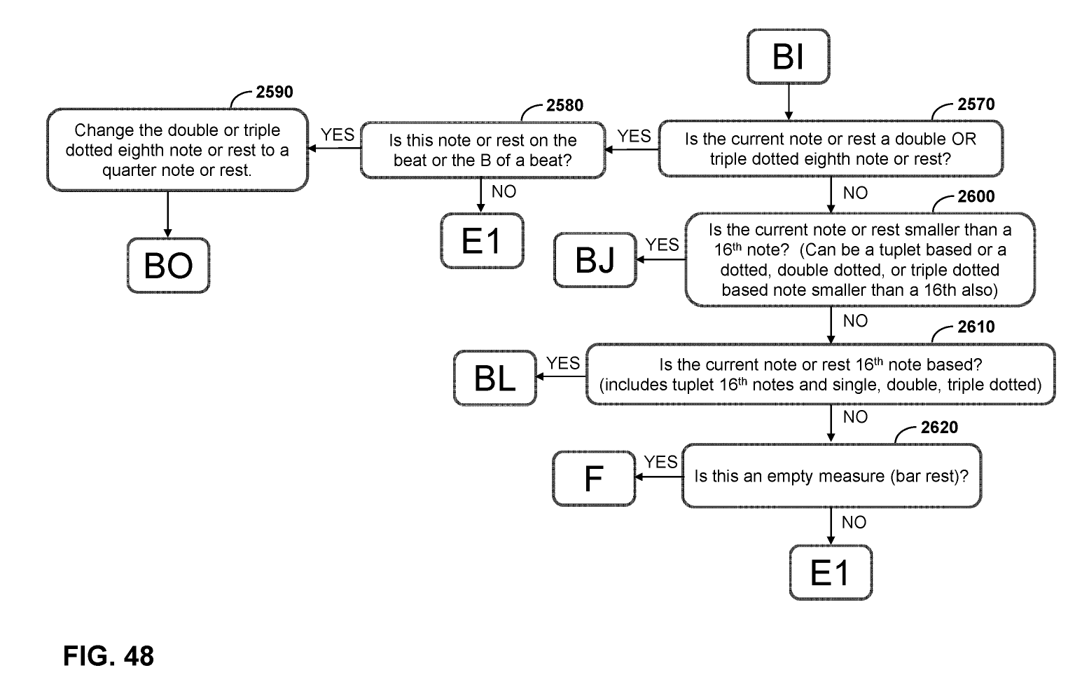

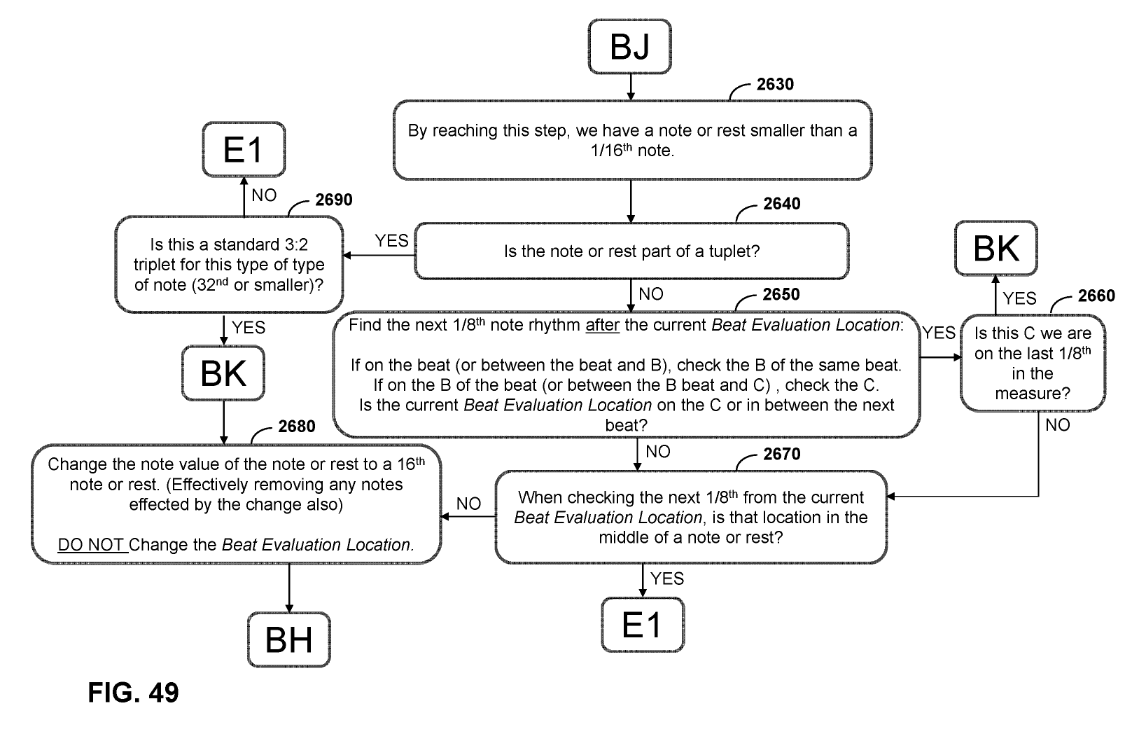

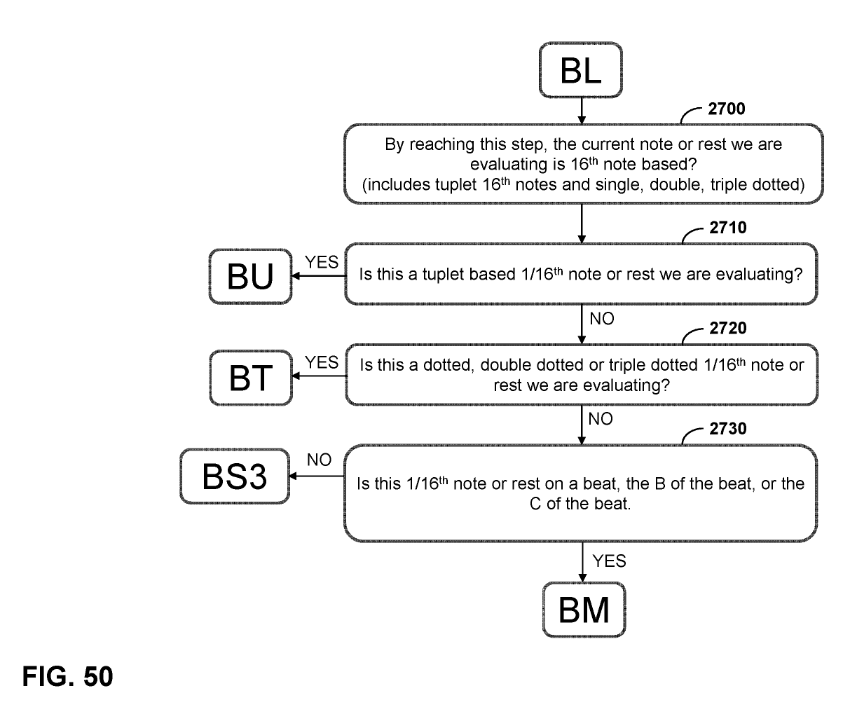

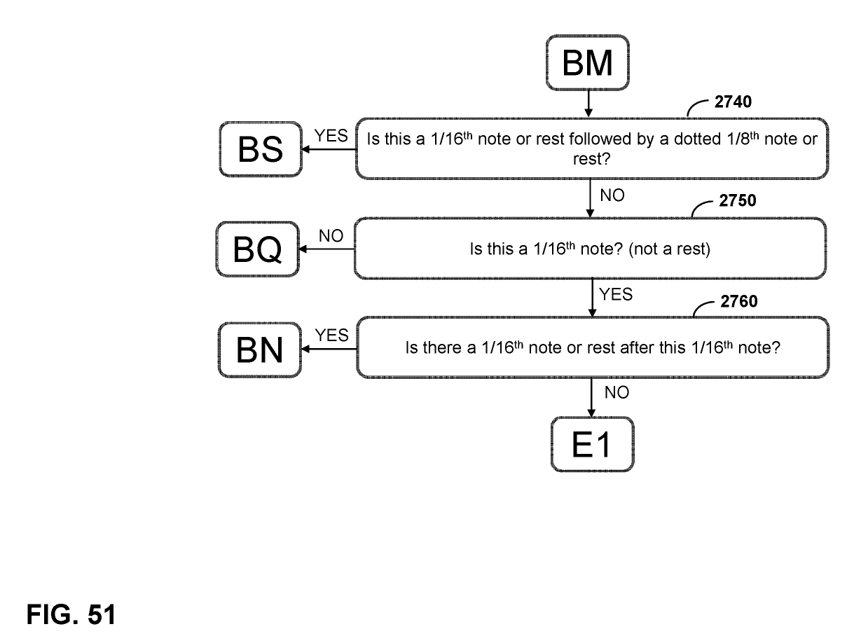

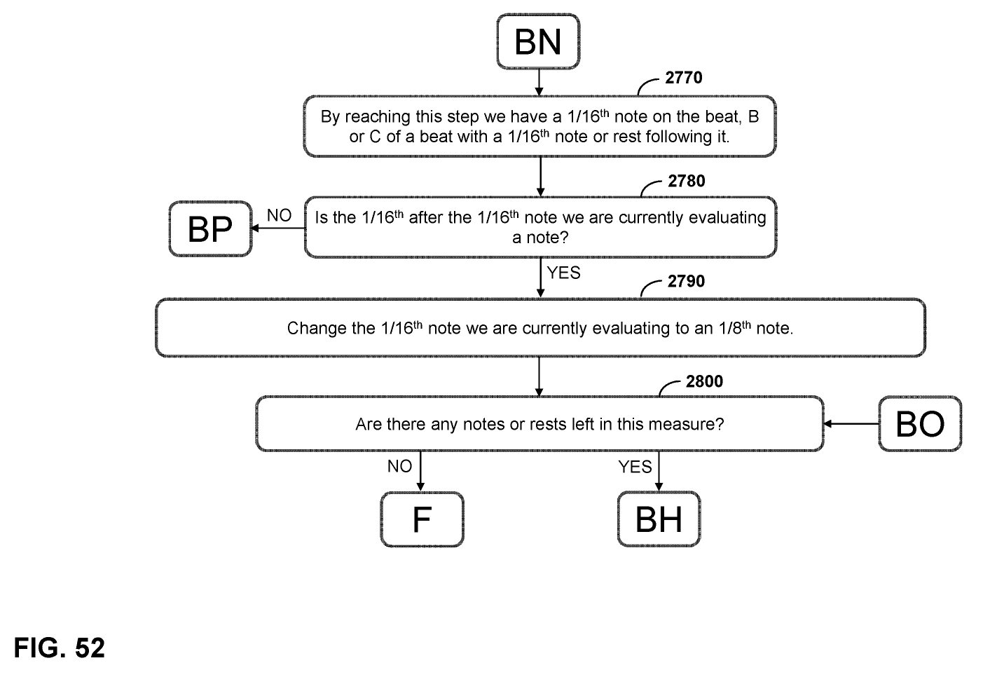

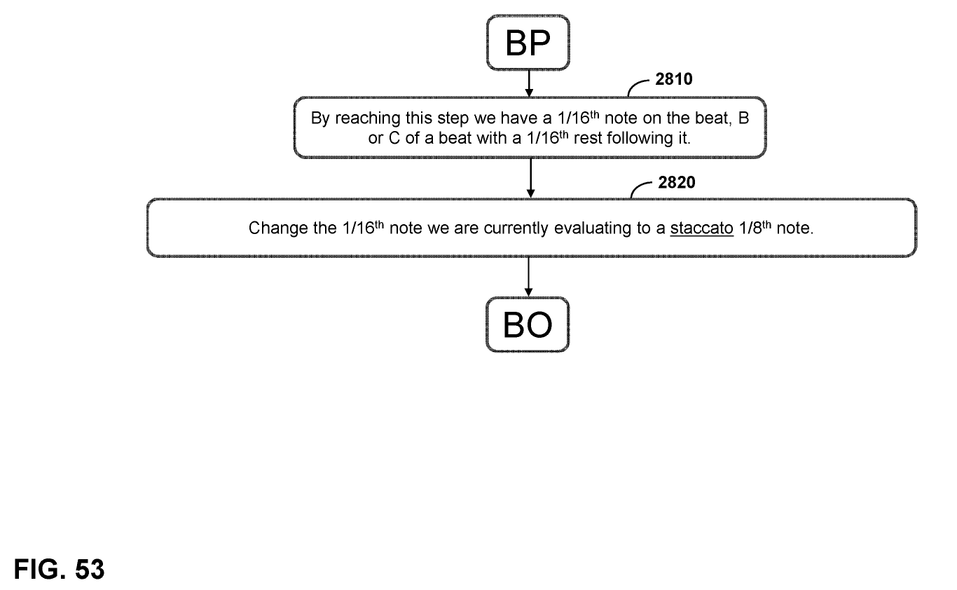

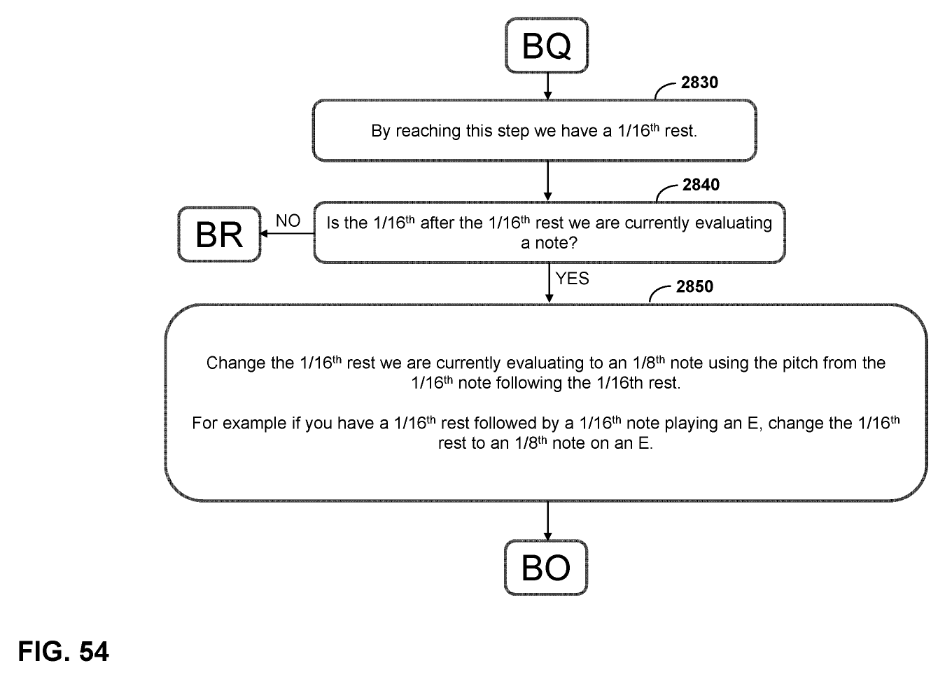

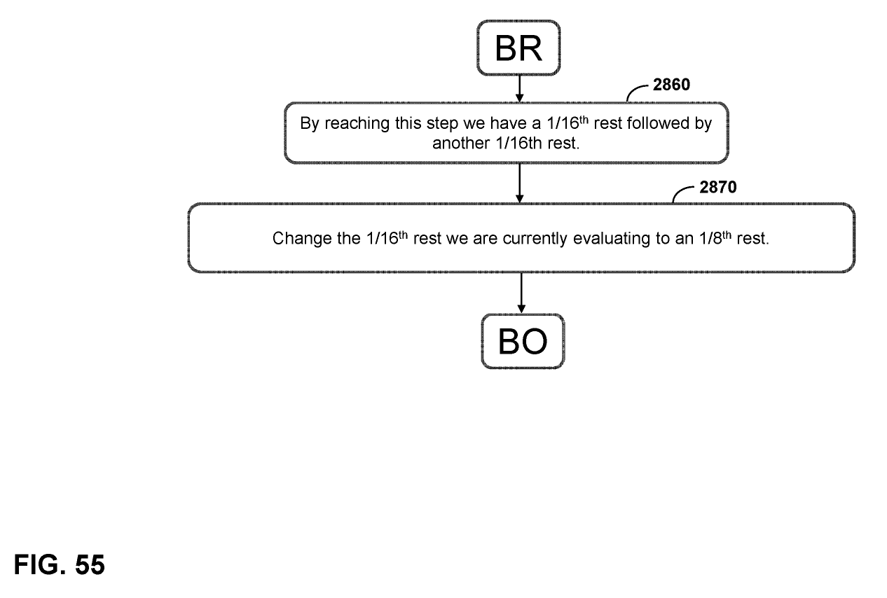

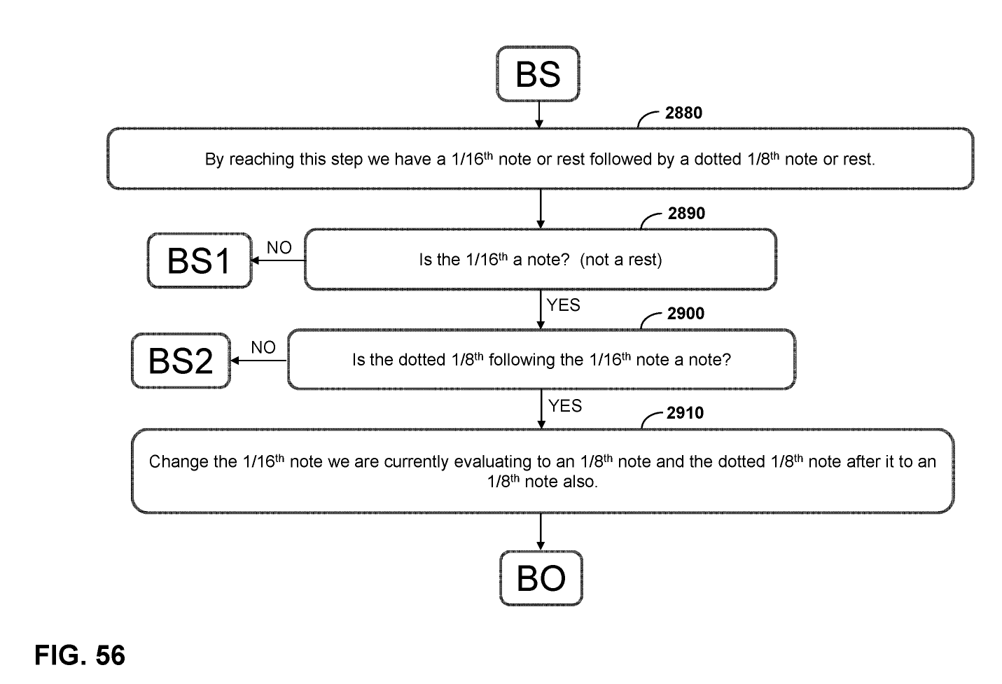

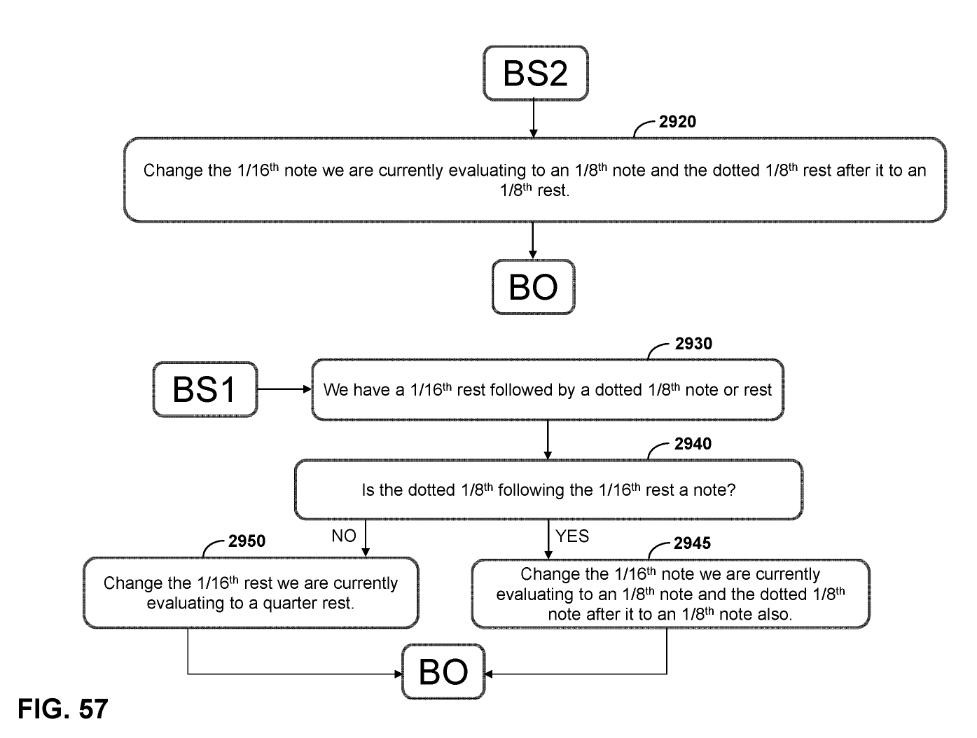

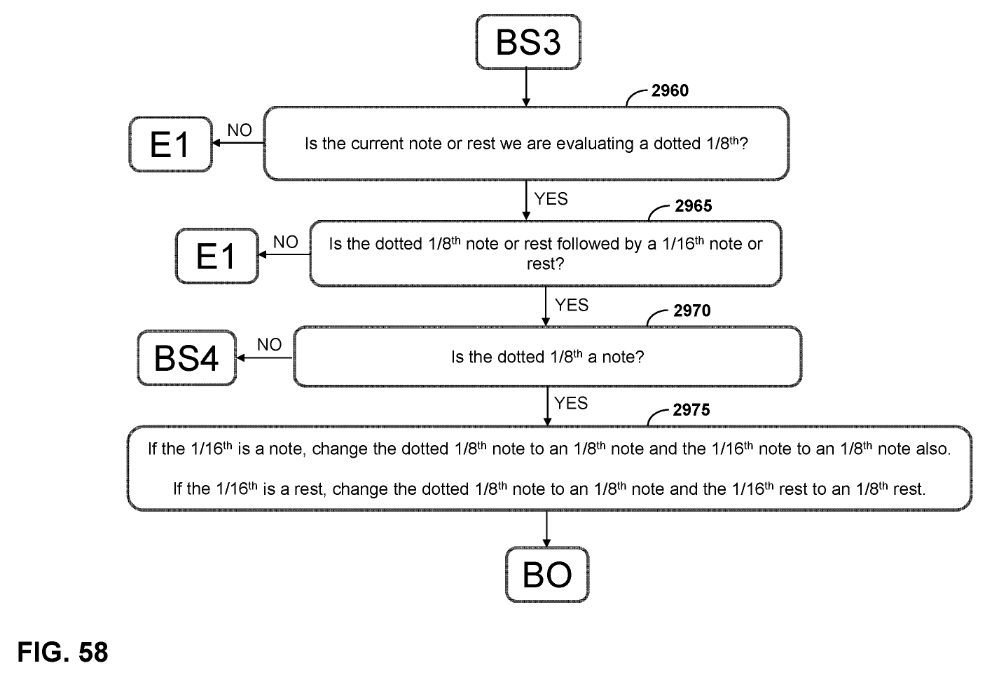

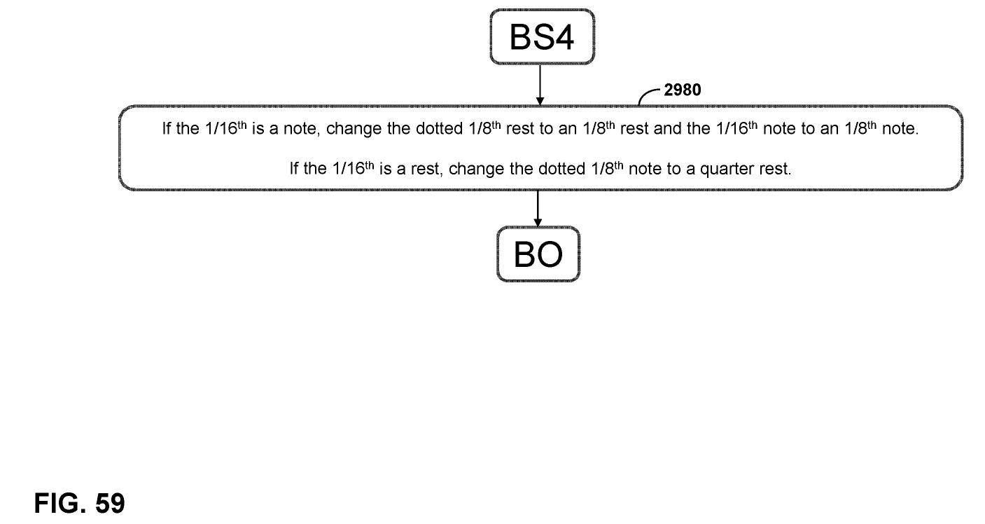

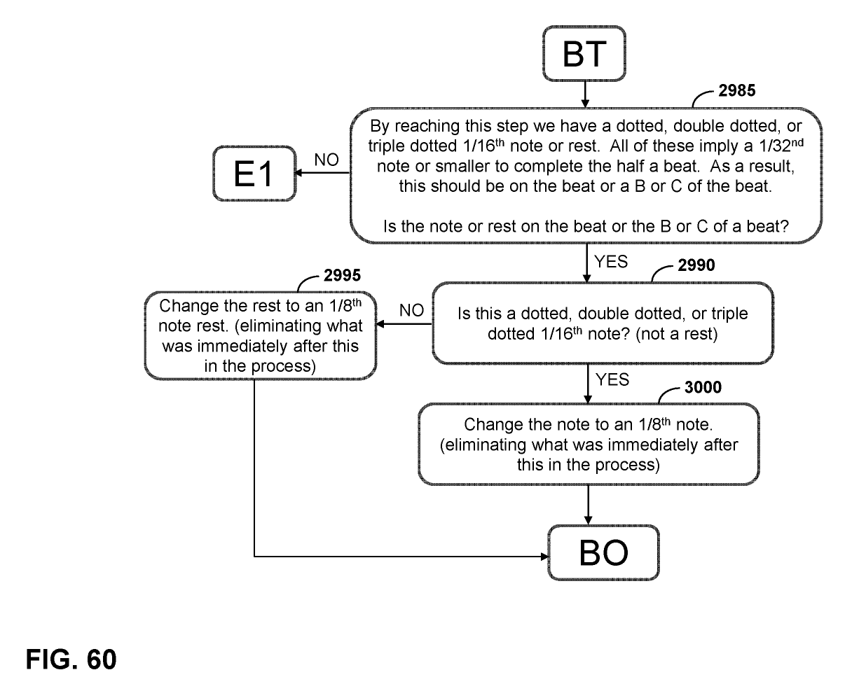

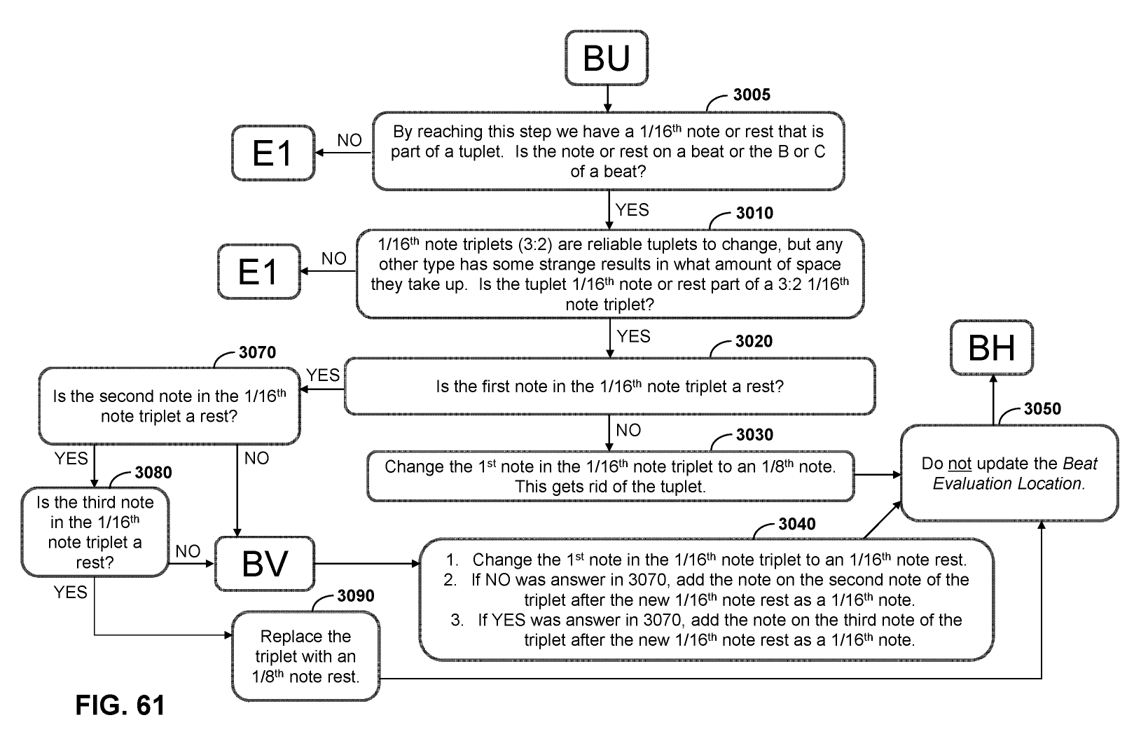

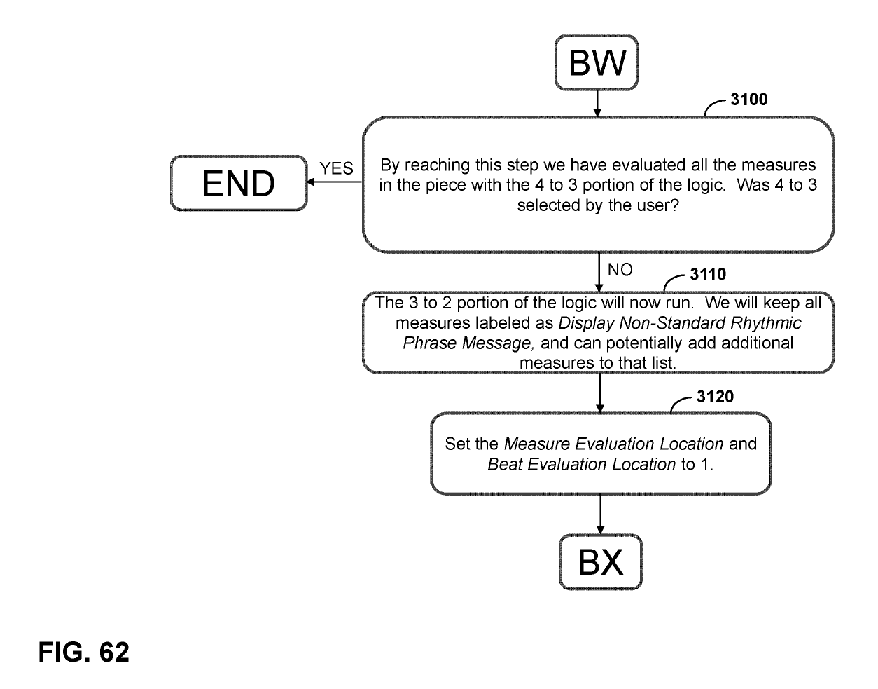

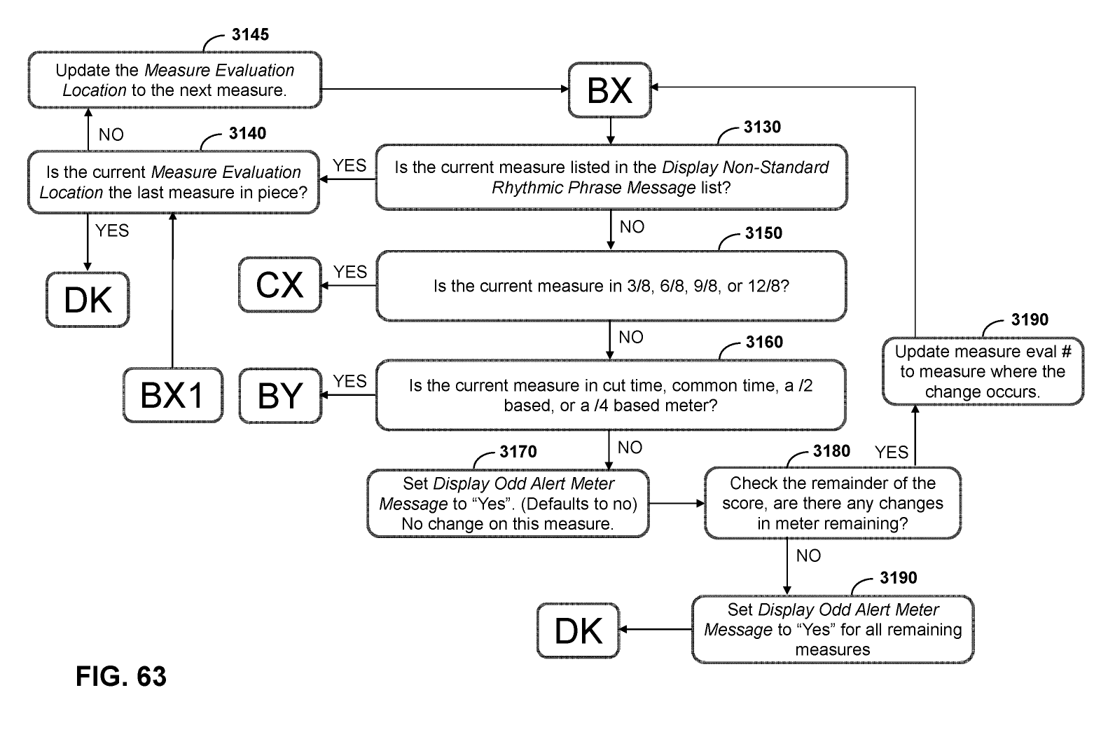

In FIG. 62, an end point to the 4 to 3 process is reached (steps 3100-3120). If either 3 to 2 or 2 to 1 is used, processing continues on to FIG. 63 which begins the 3 to 2 process.

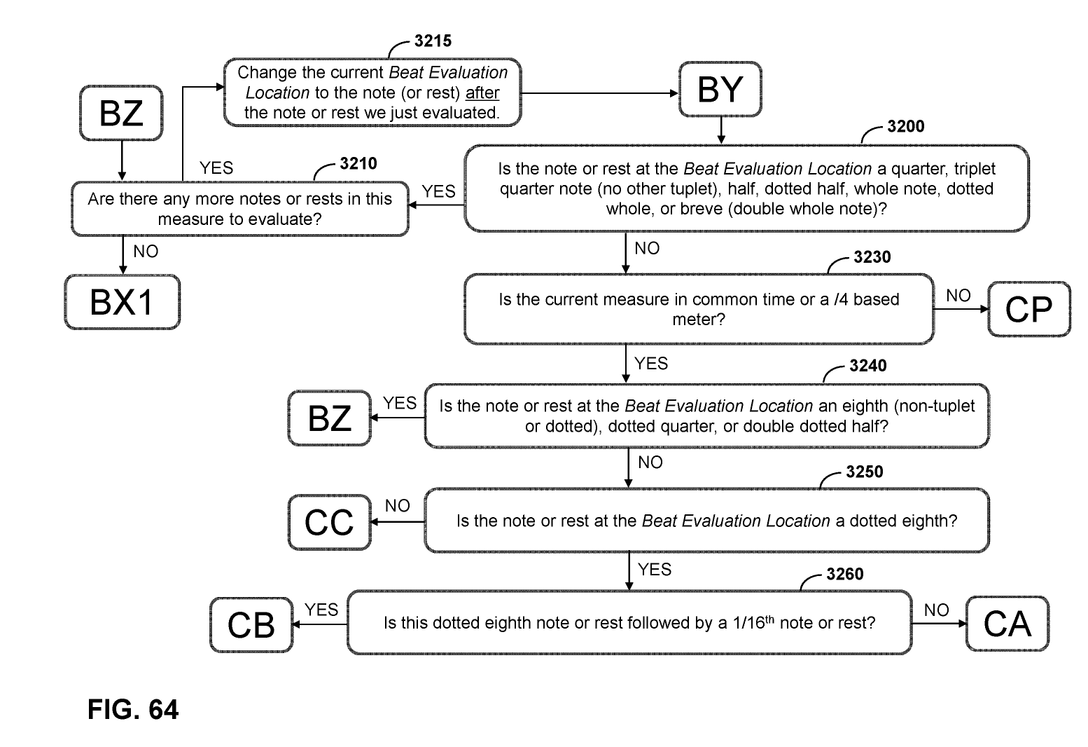

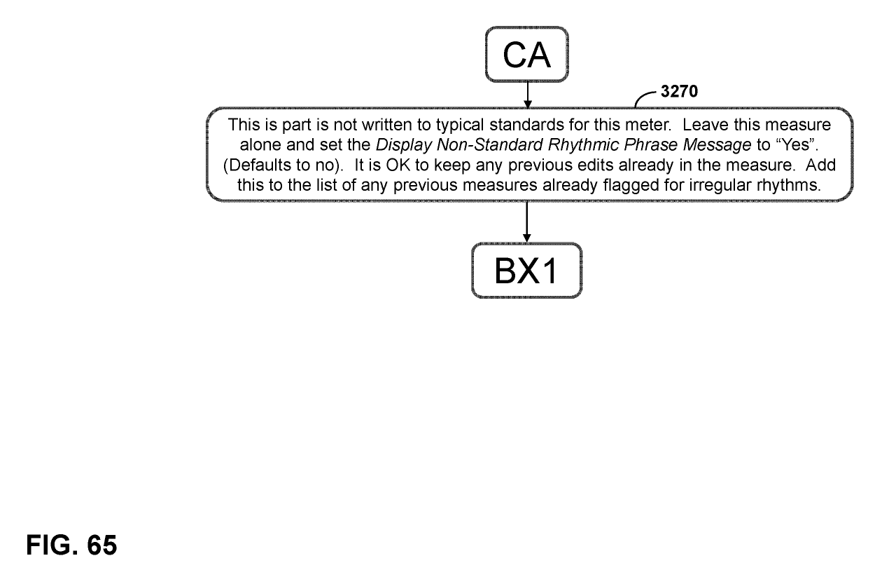

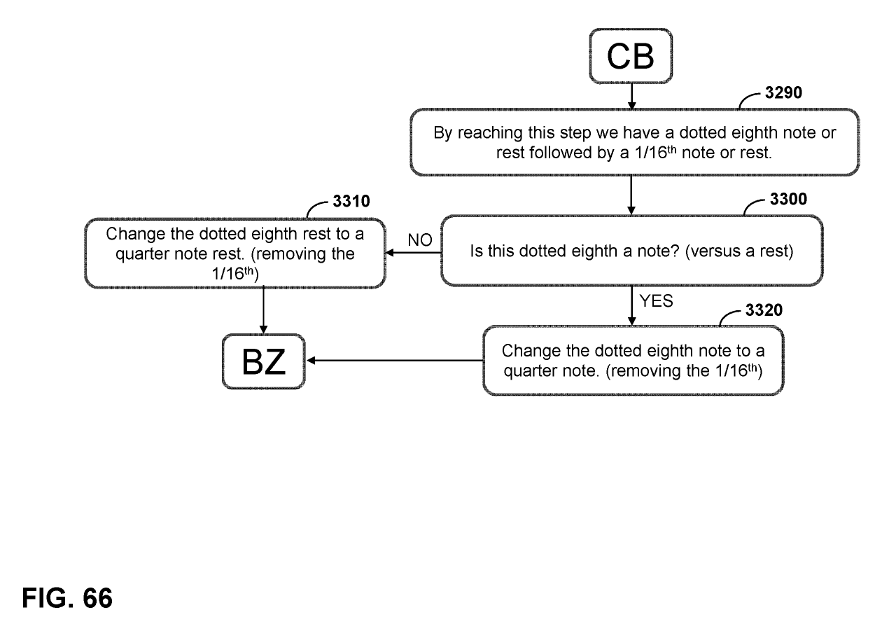

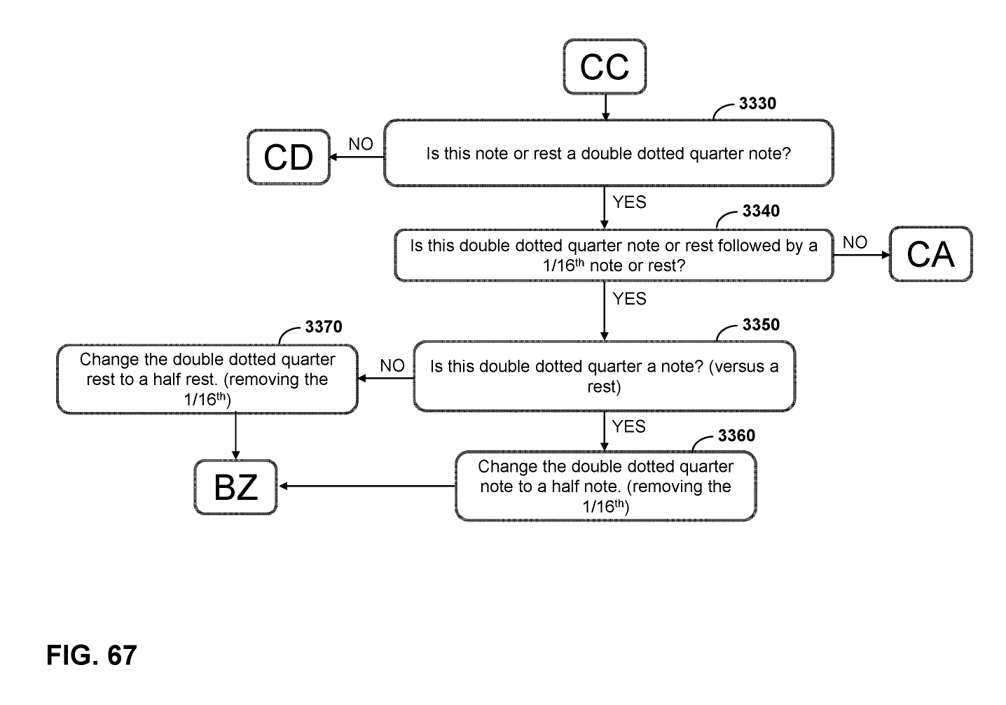

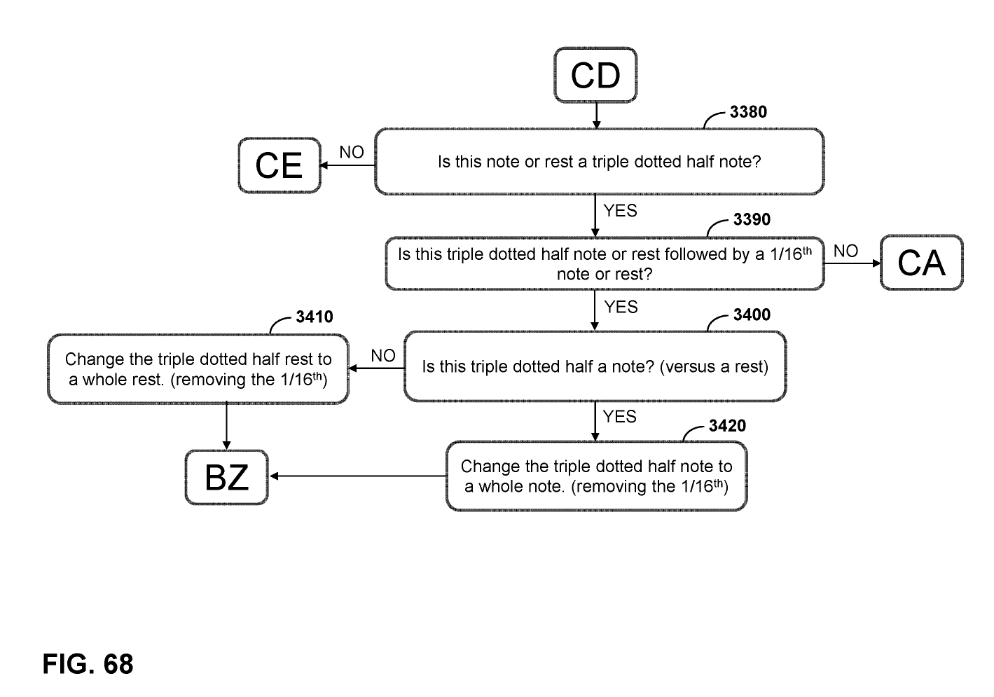

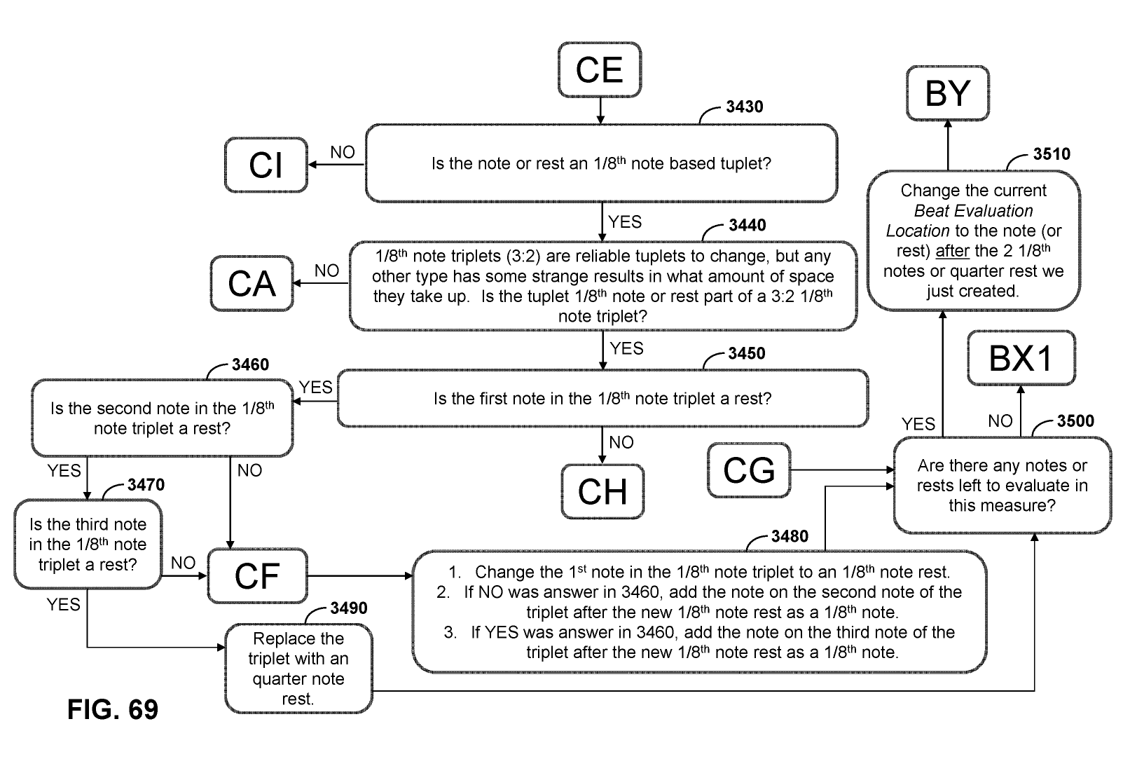

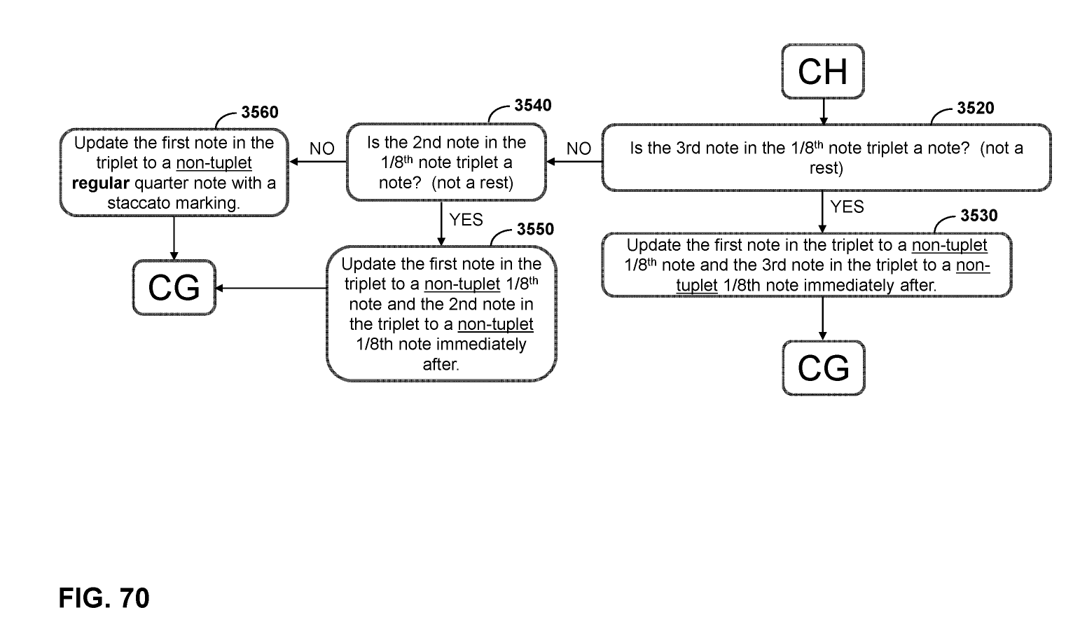

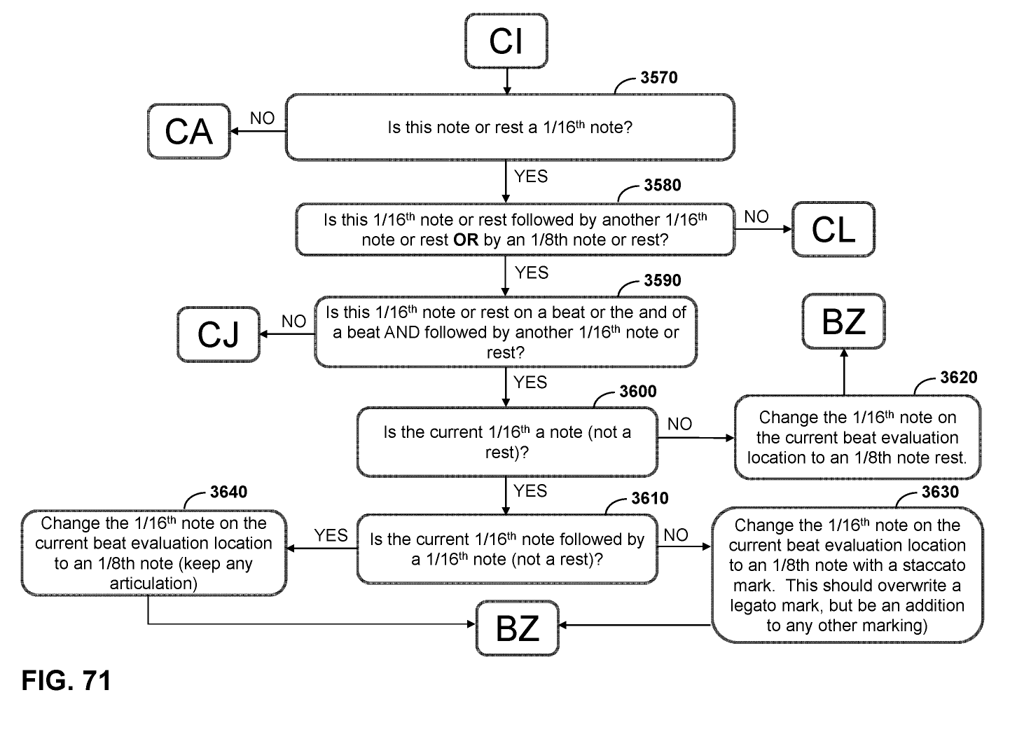

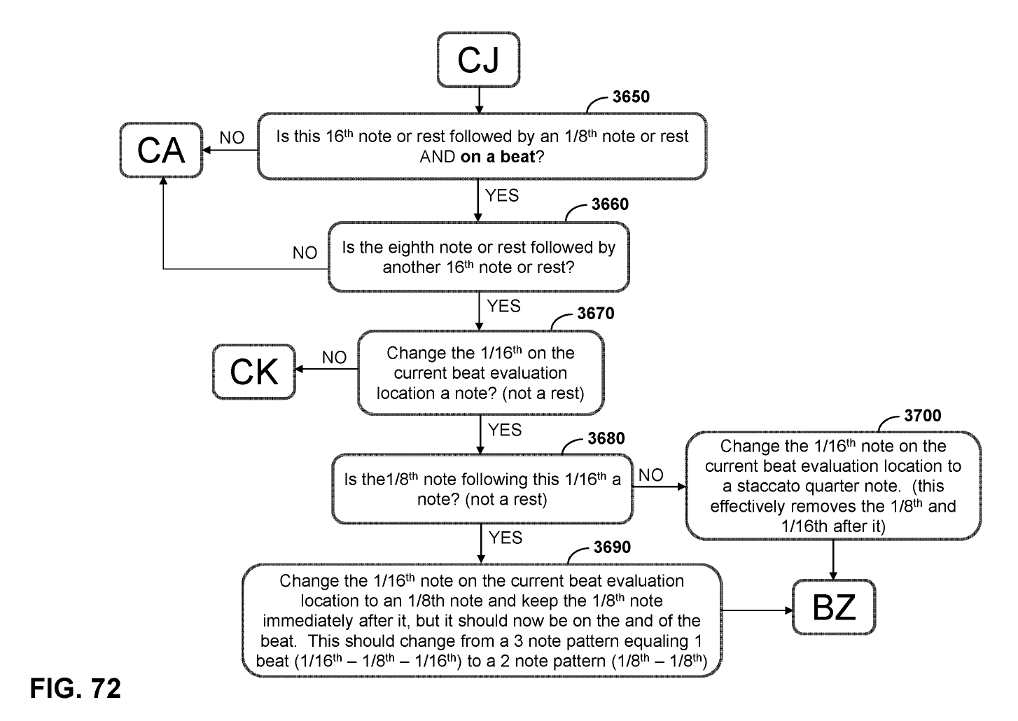

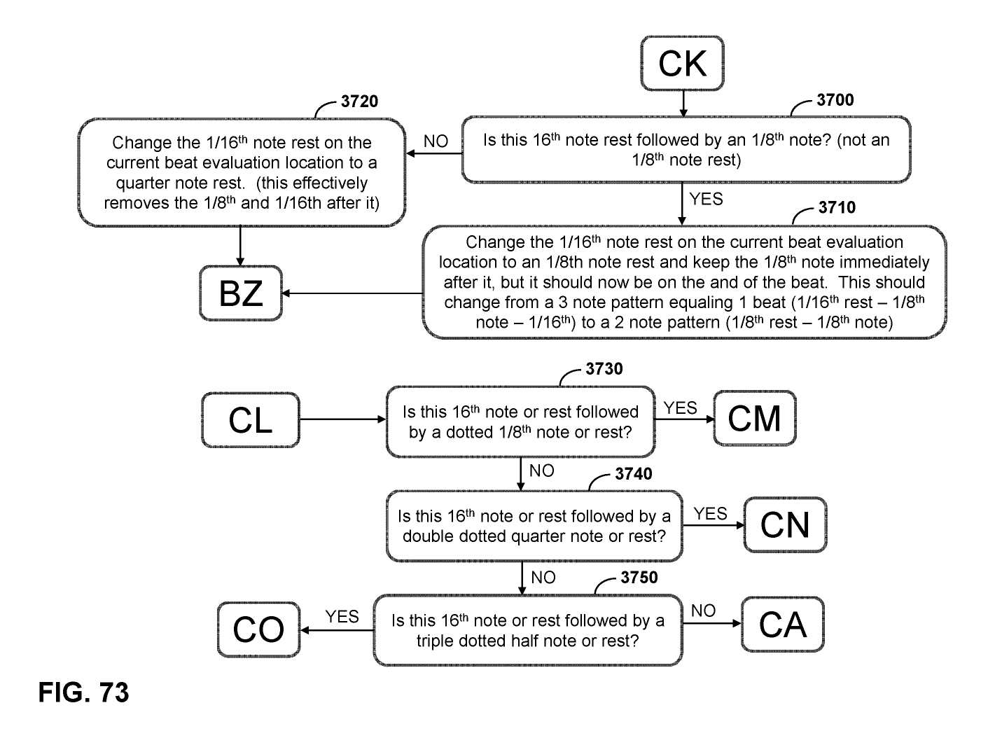

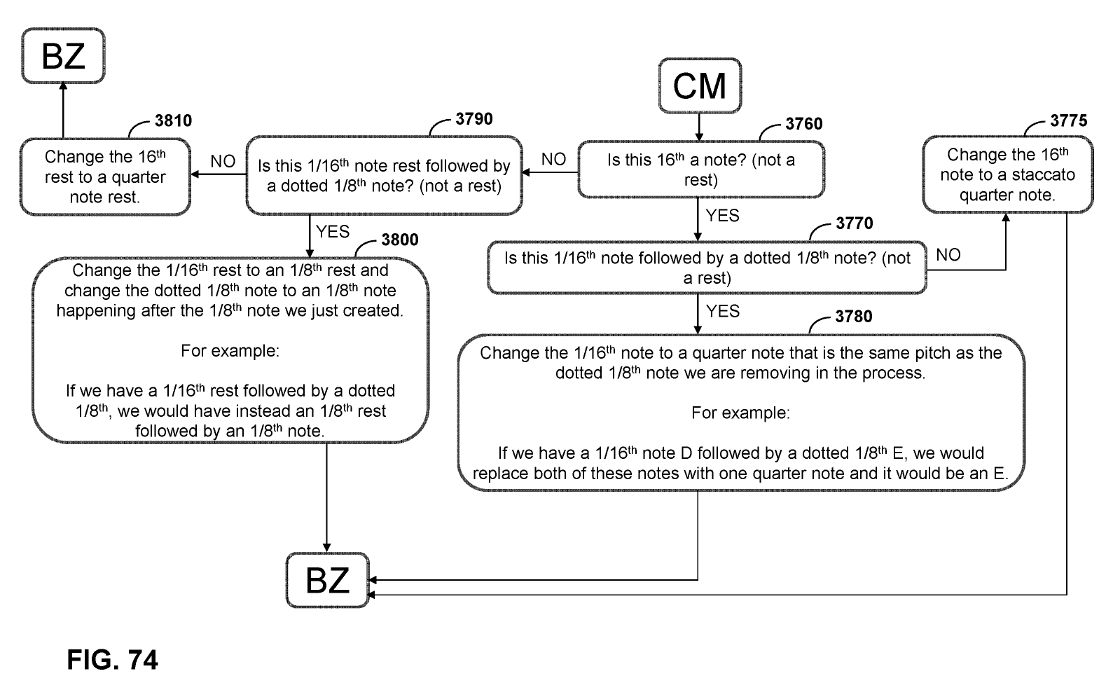

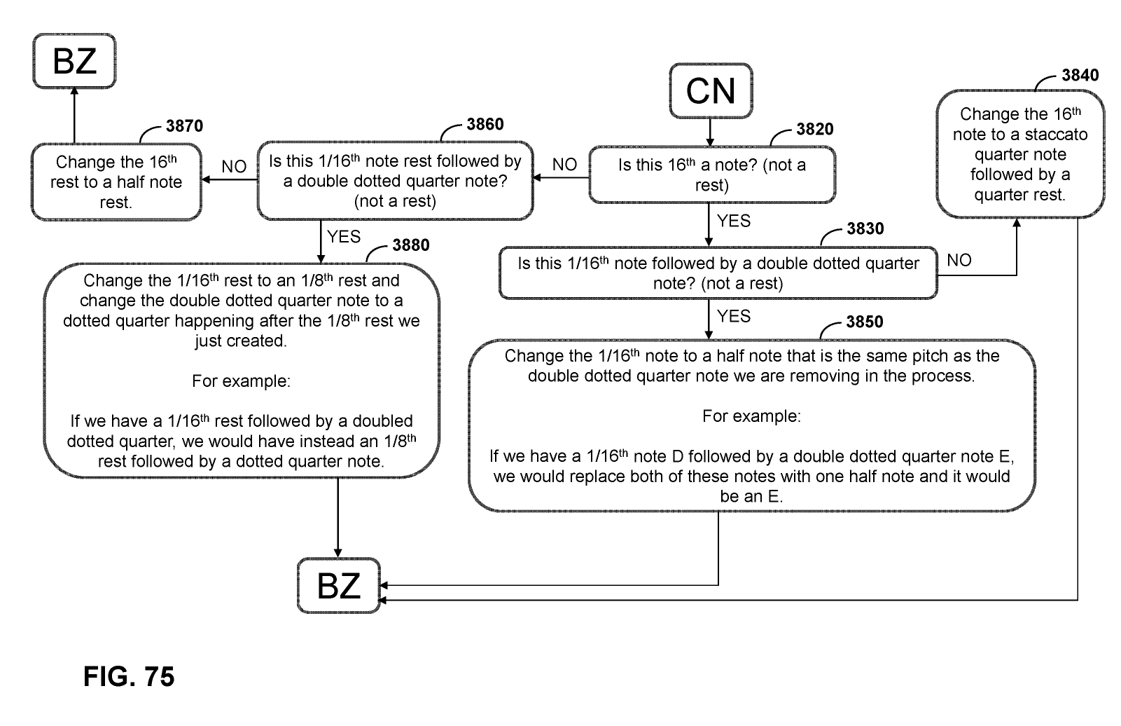

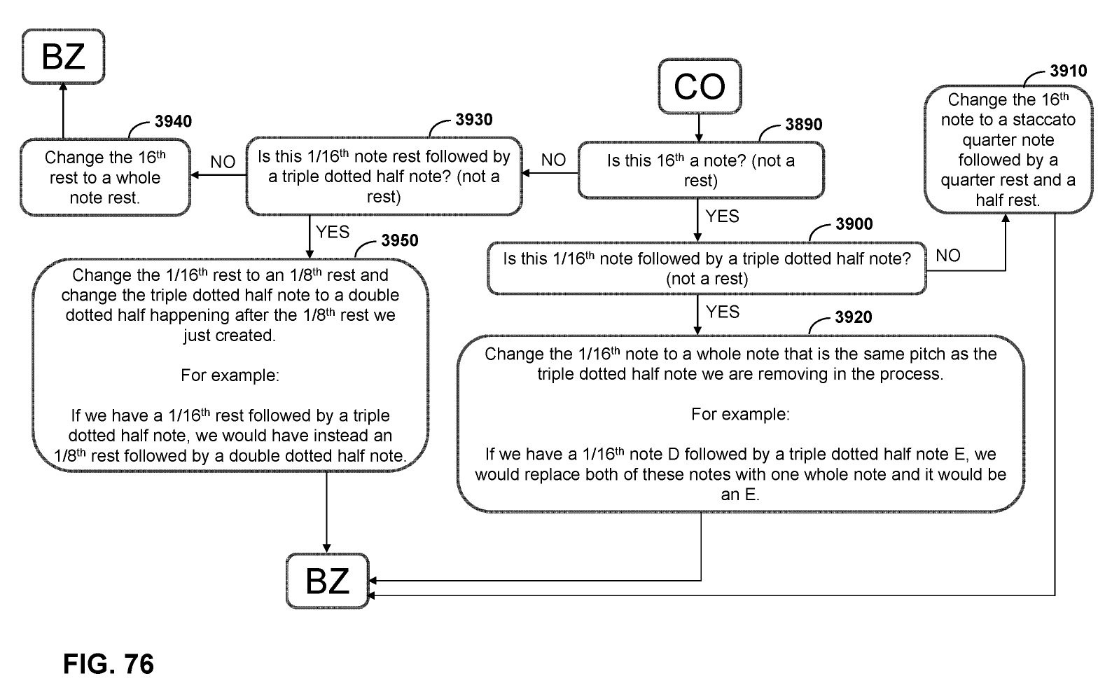

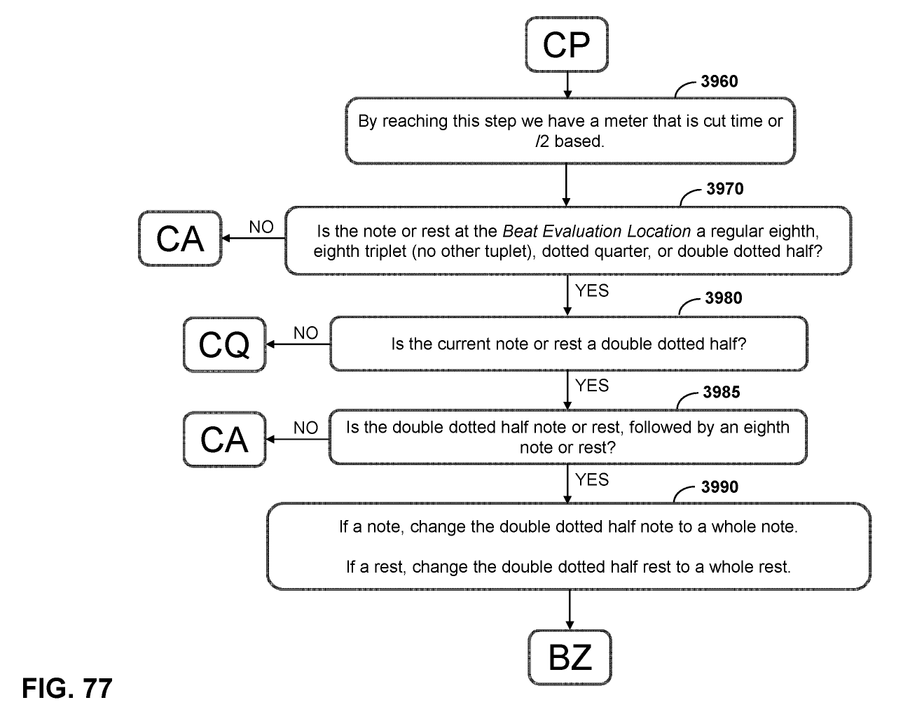

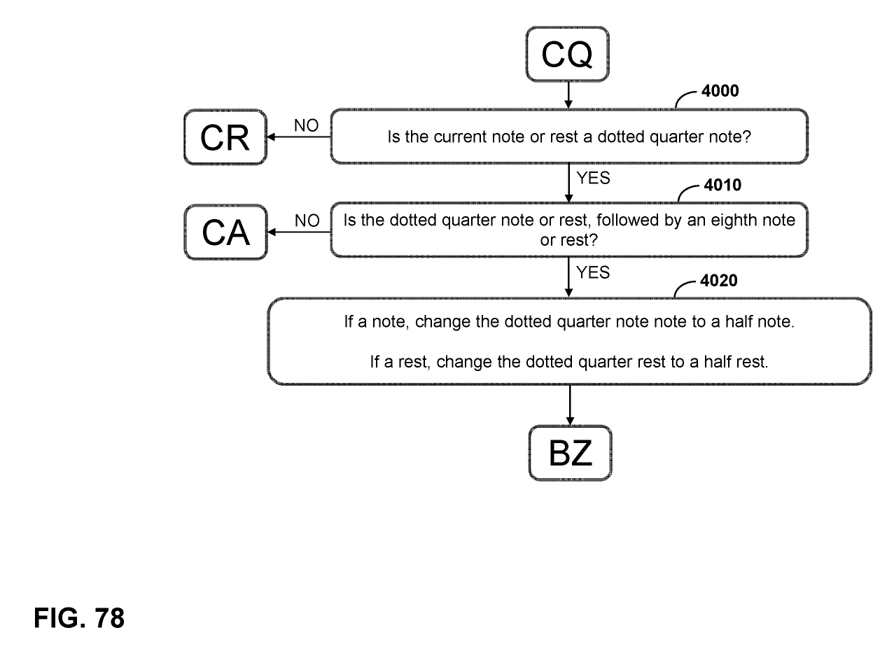

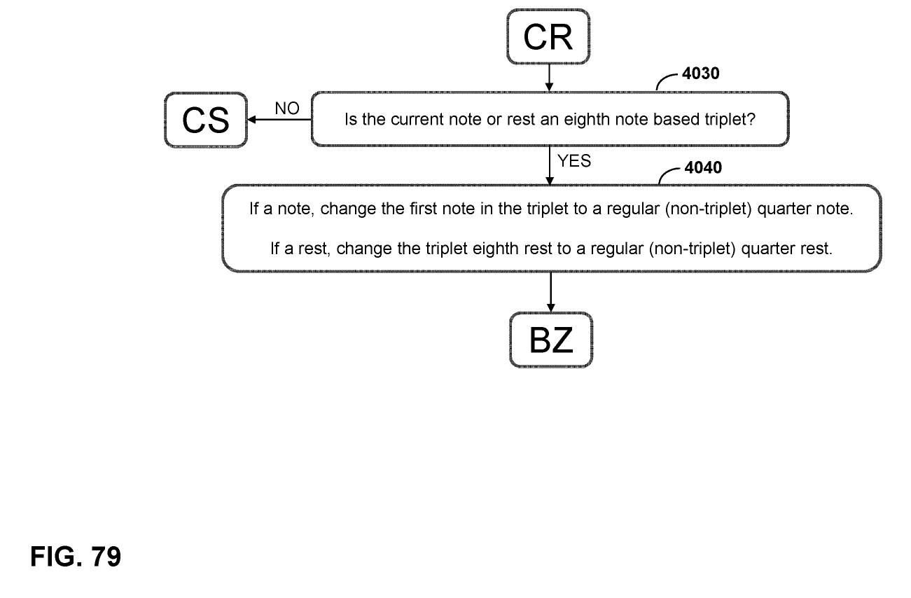

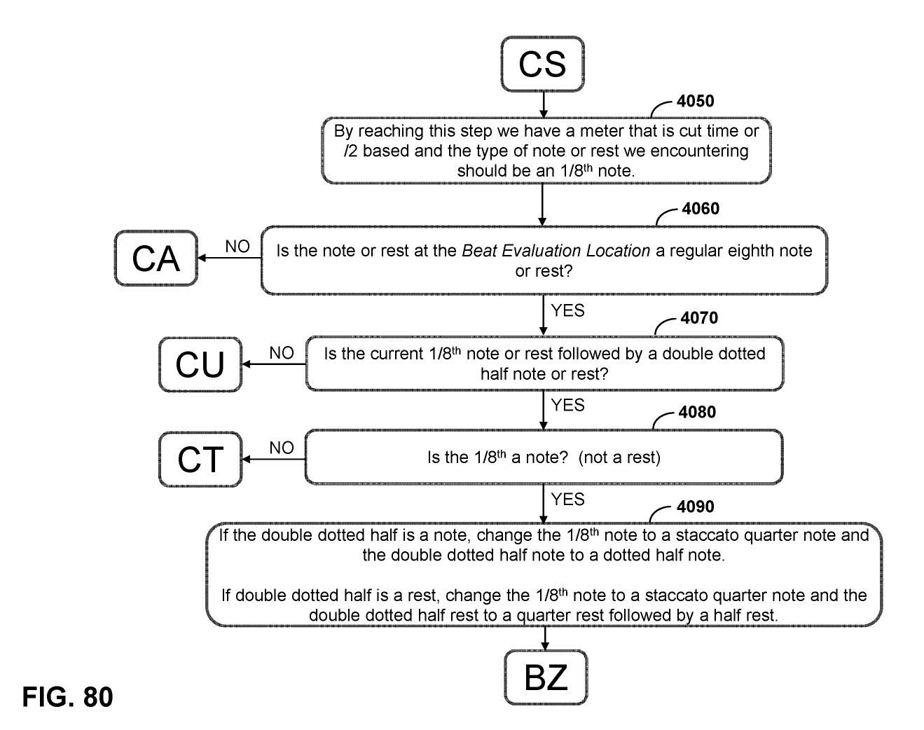

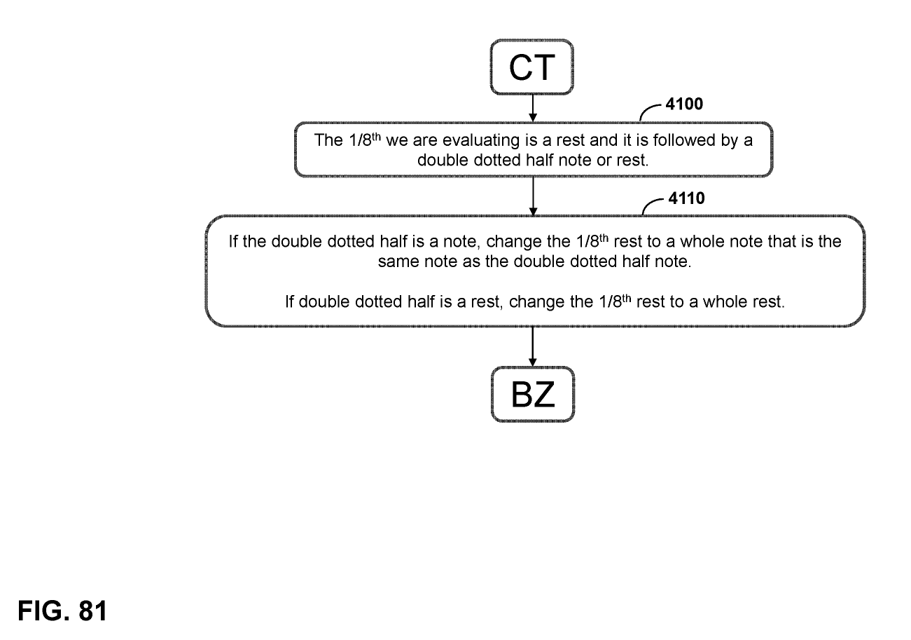

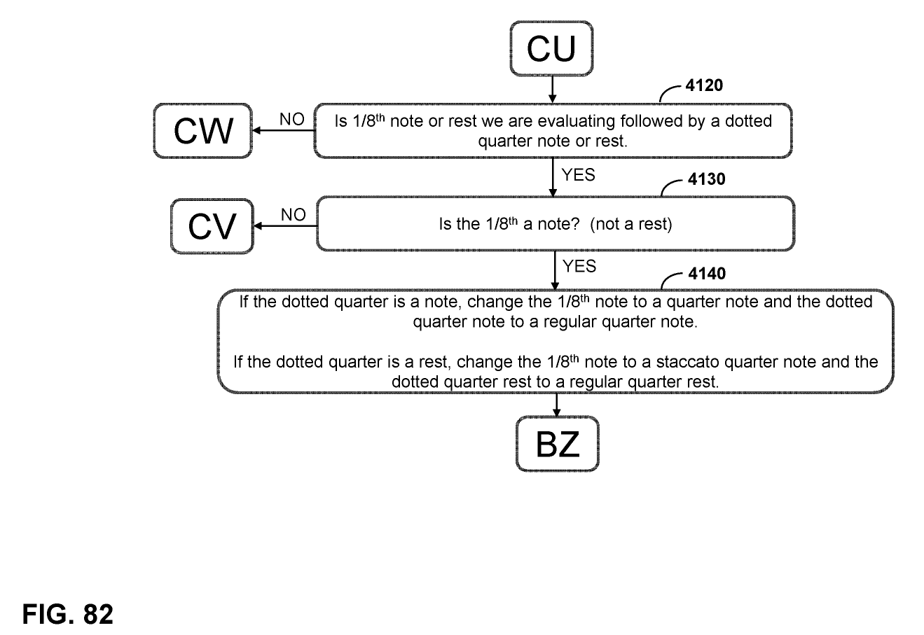

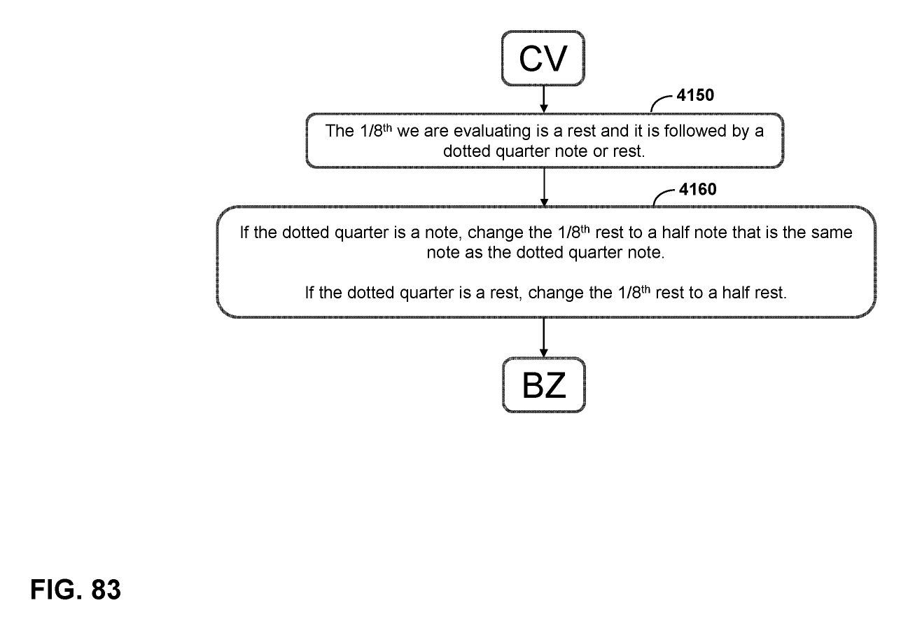

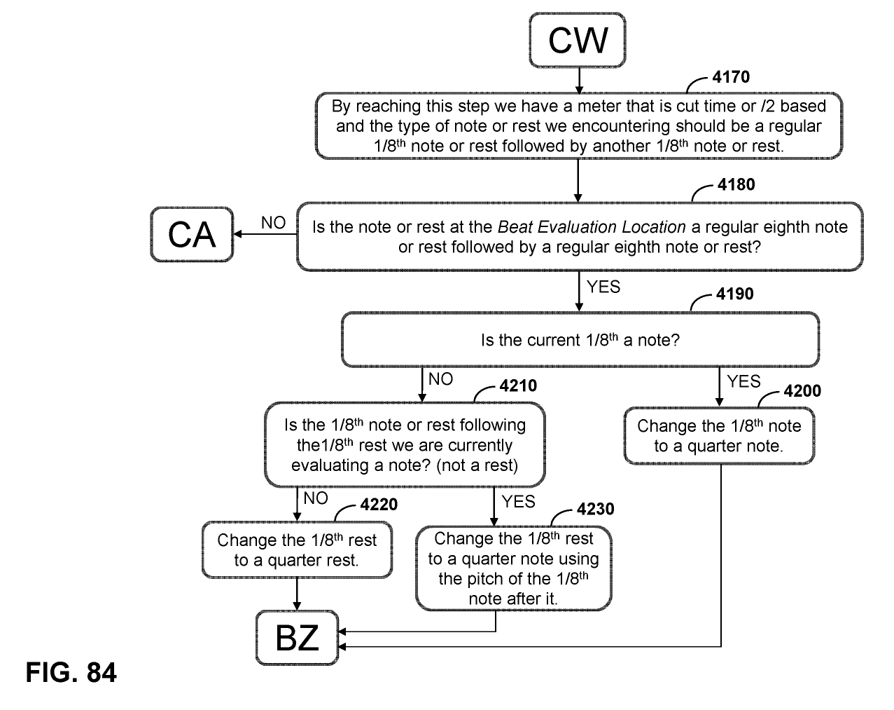

FIG. 63-FIG. 84 illustrate a process for simplifying rhythms in common time, cut time, and all time signatures over 4 and 2 which represent quarter notes or half notes representing the beat, respectively. This section focuses on simplifying rhythms from proficiency 3 to proficiency 2. Initial evaluation is undertaken at steps 3130-3270 to identify non-standard and odd meters. This section includes, without limitation, the elimination of any notes faster than ⅛^{th} notes and any types of dotted rhythms typically completed with notes faster than ⅛^{th} notes in an effort to present notation more in line with a beginner player at a moderate tempo (steps 3290-4040). Cut time and time signatures where the half note is considered the beat (/2 meters) have a slightly different process that takes the simplification further (steps 4050-4230).

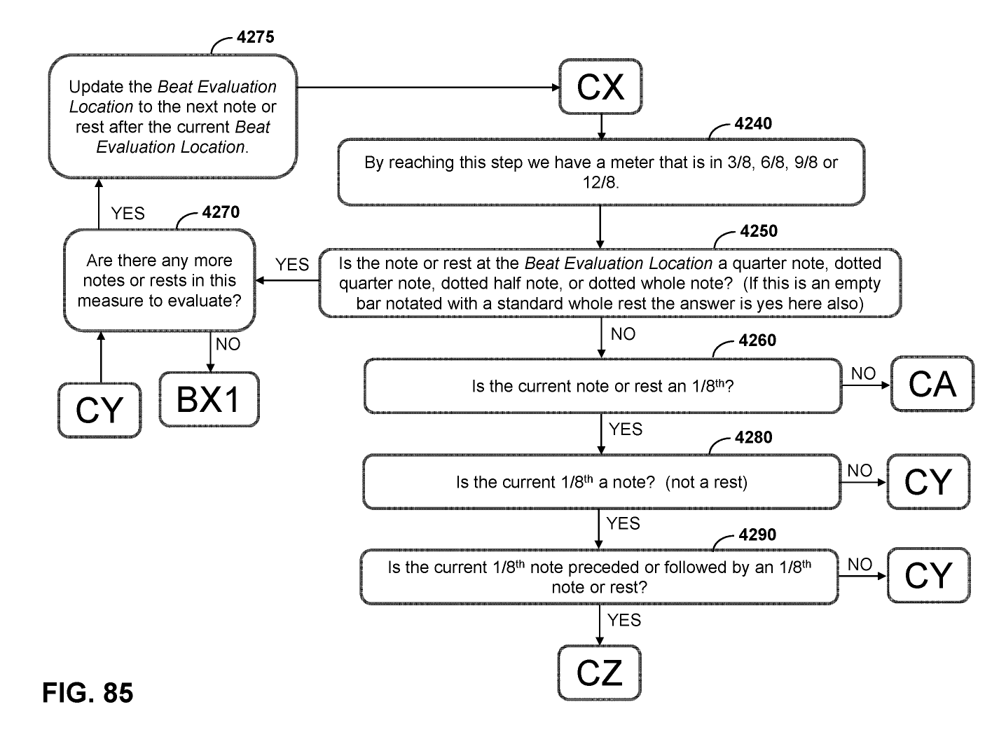

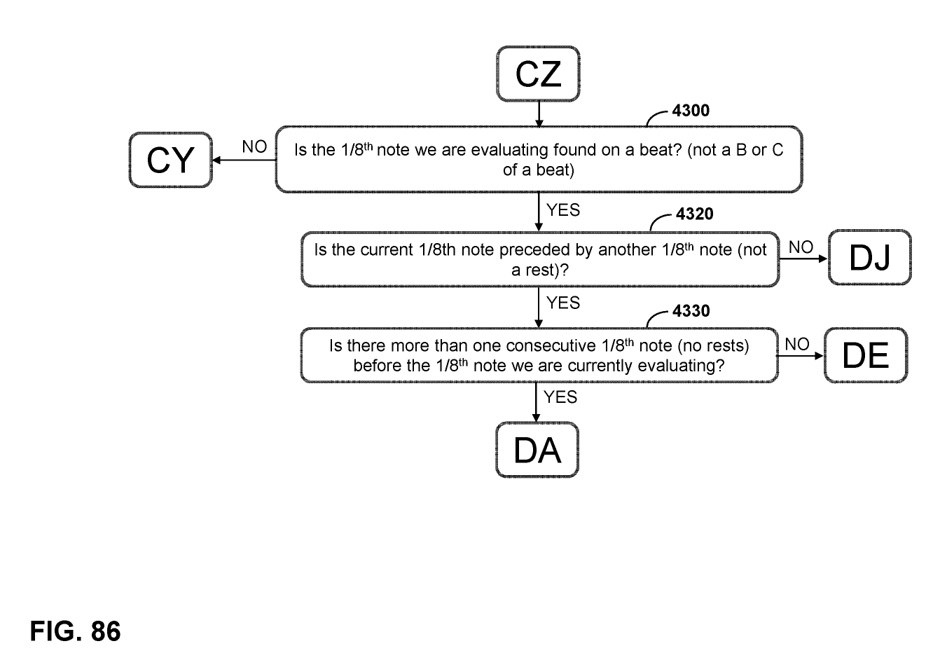

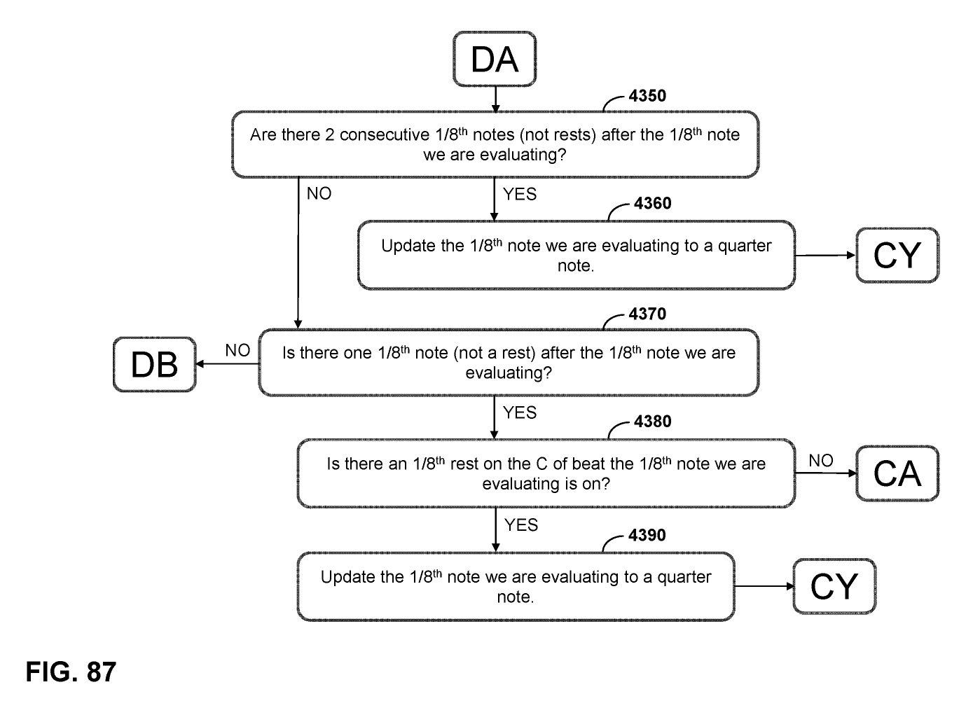

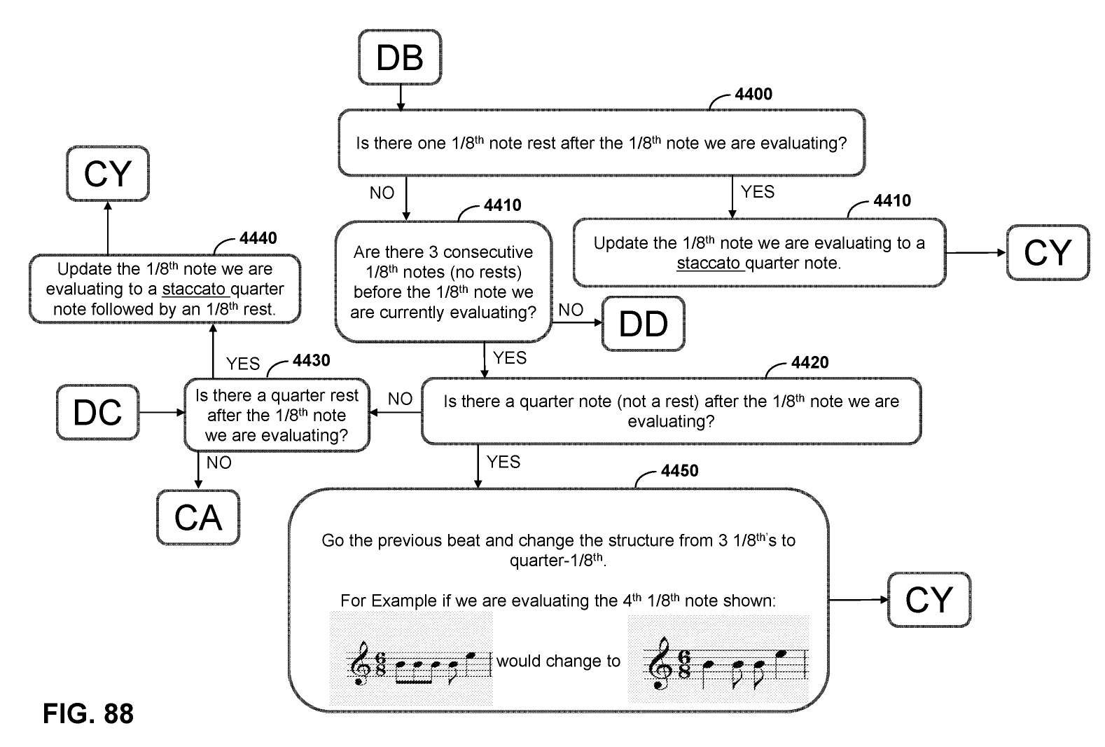

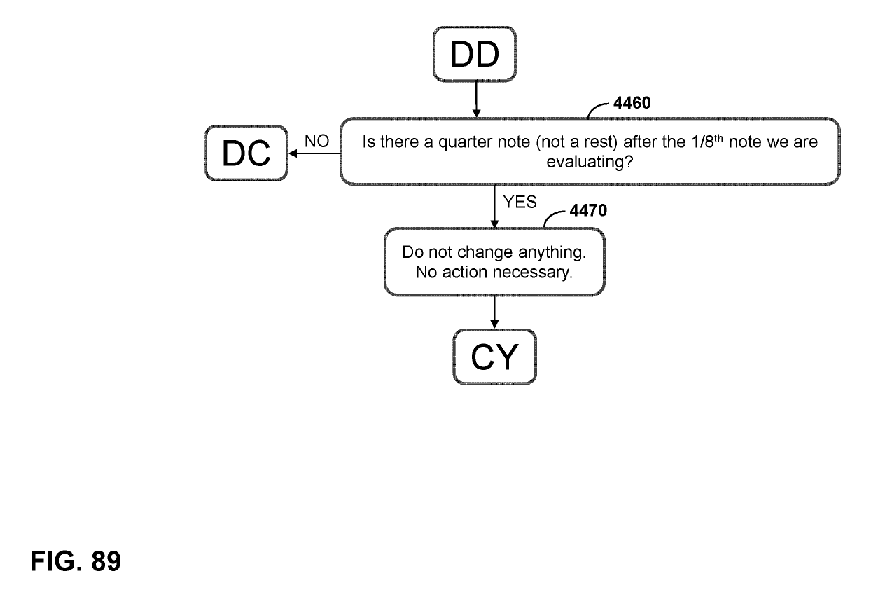

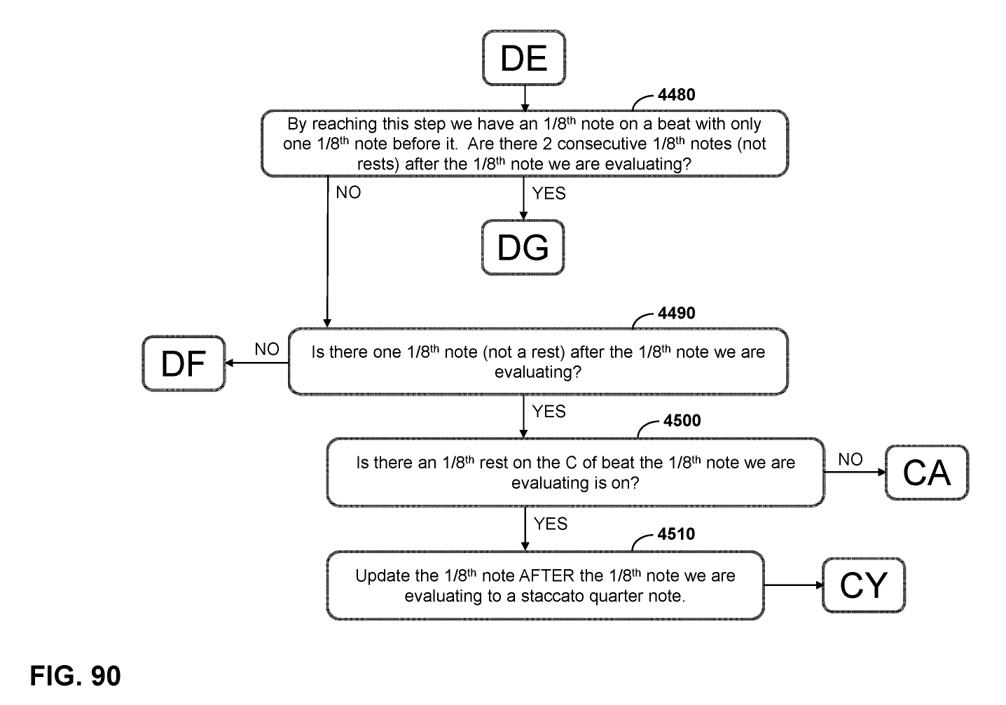

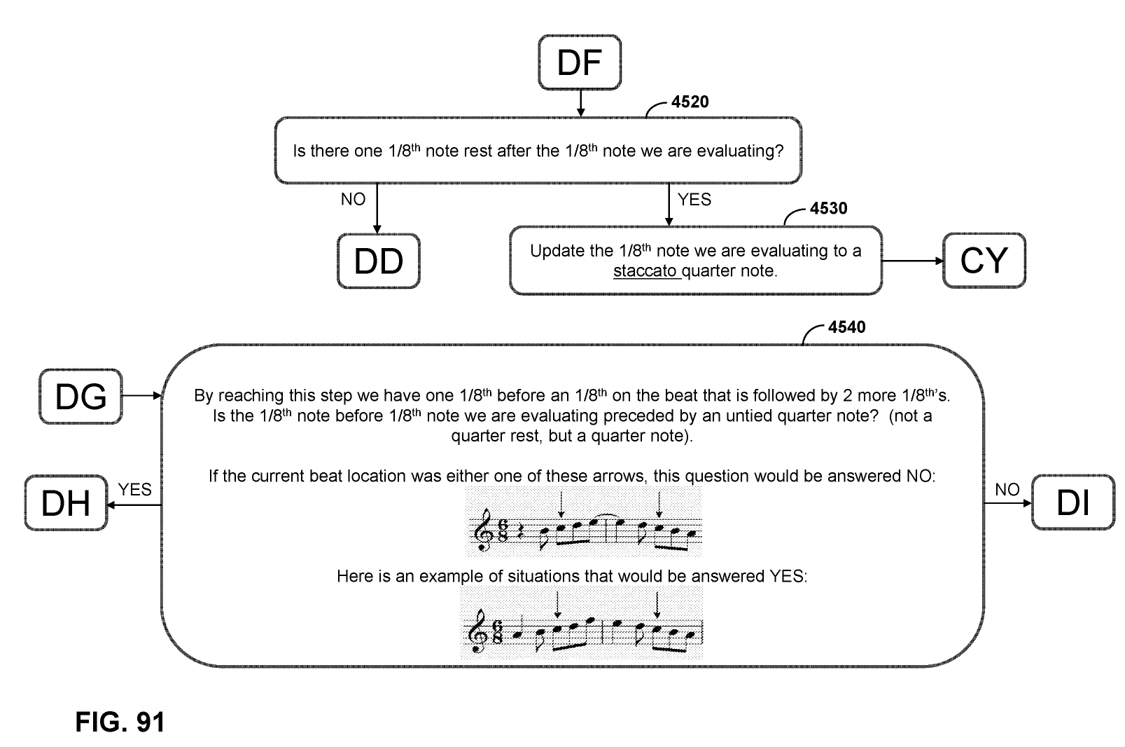

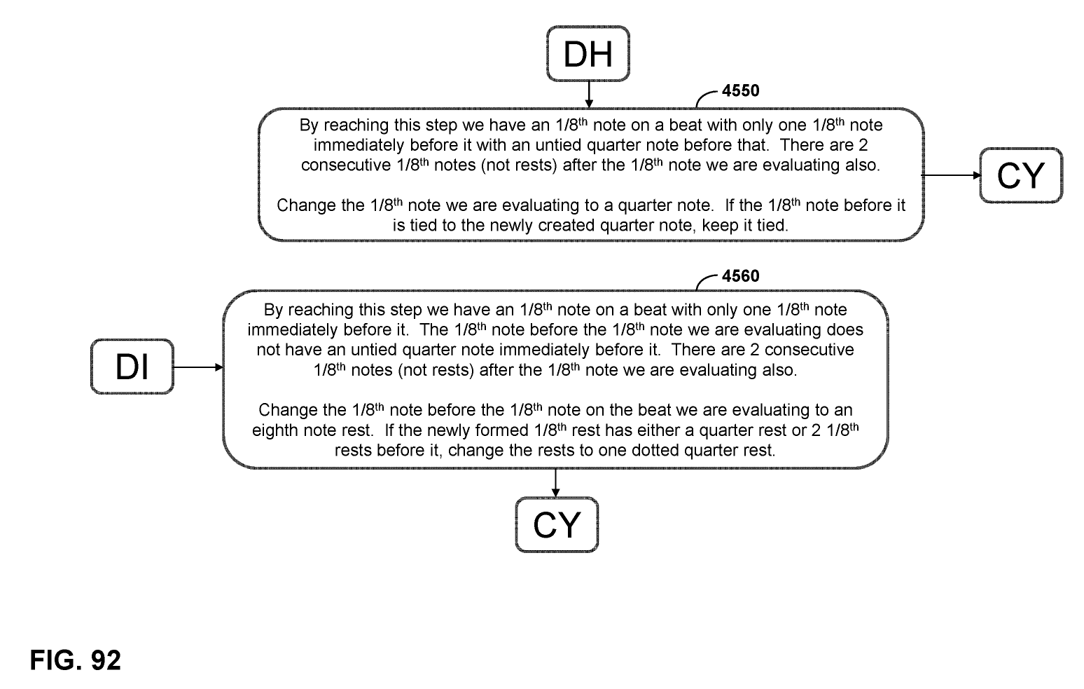

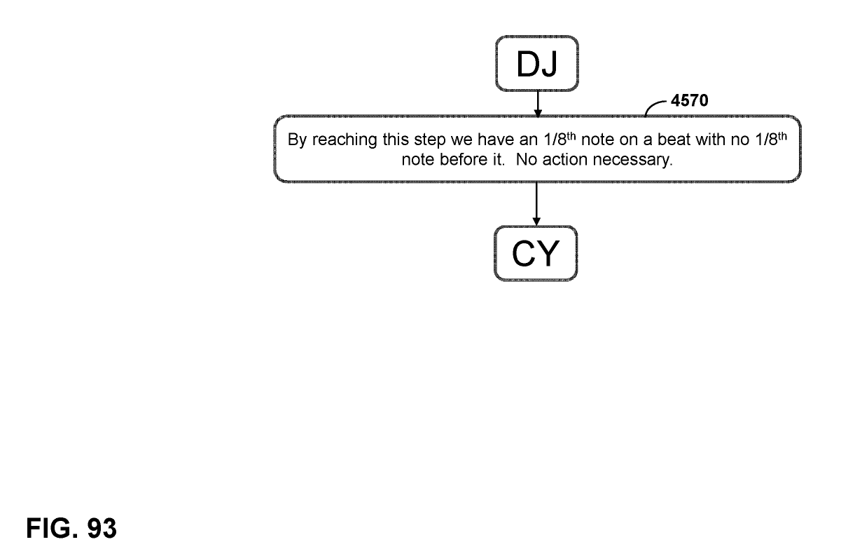

FIGS. 85-93 depict a process for simplifying rhythms in ⅜, 6/8, 9/8 and 12/8 which represent common time signatures where dotted quarter notes represent the beat. This section also focuses on simplifying rhythms from proficiency 3 to proficiency 2. This section includes, without limitation, eliminating patterns that contain four or more consecutive ⅛^{th} notes which in line a rhythmic pattern more easily understood by a beginner player at a moderate tempo (steps 4240-4570).

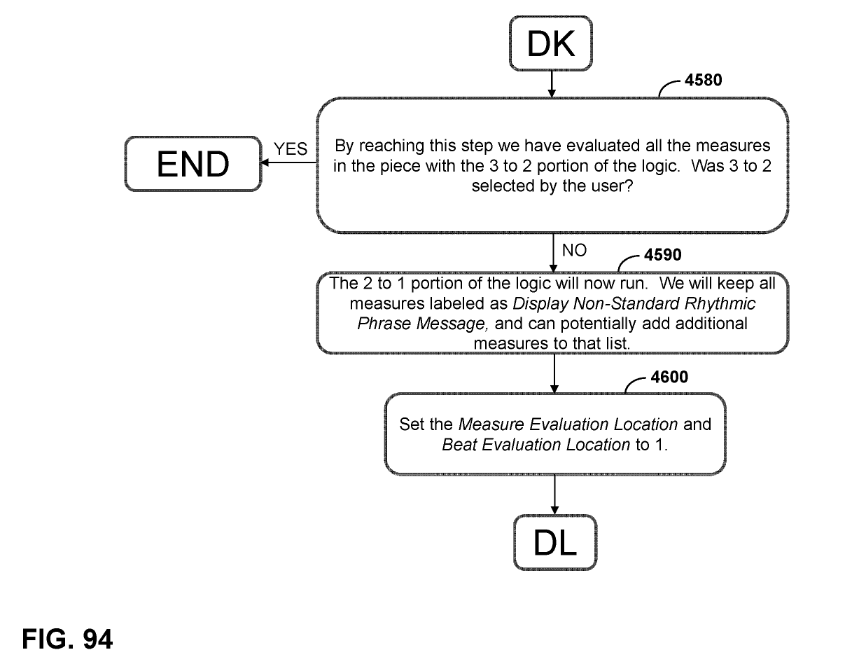

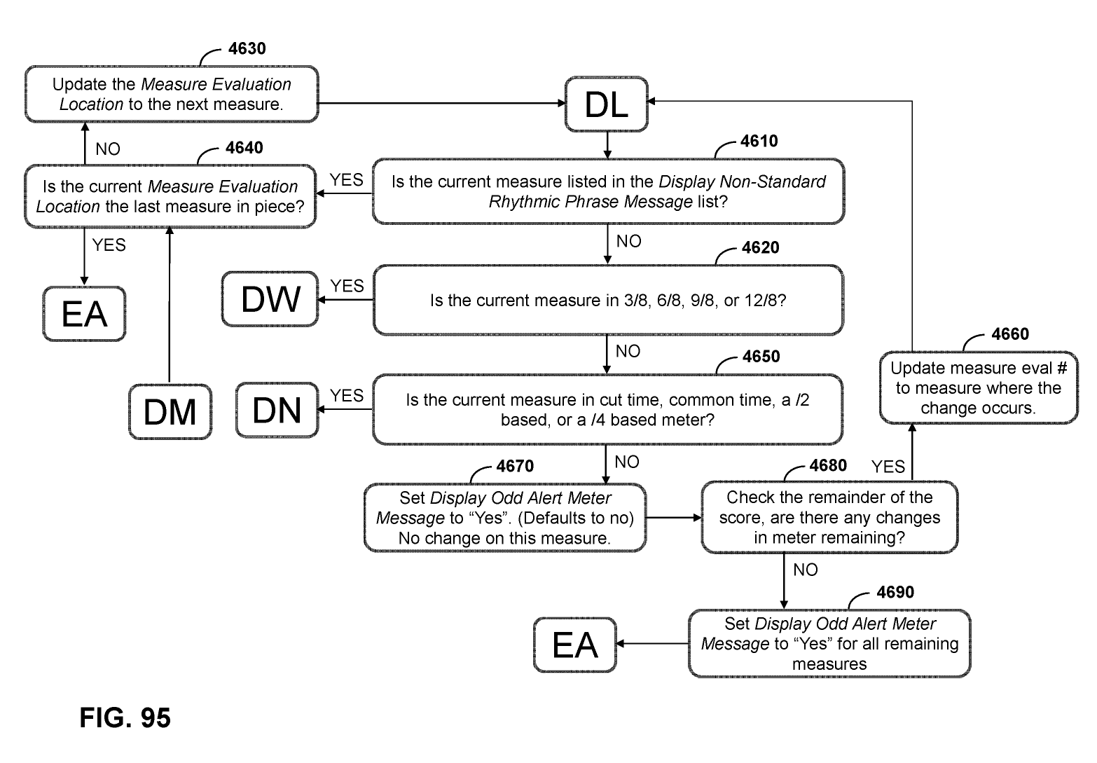

In FIG. 94, the end point of the 3-2 simplification is reached (steps 4580-4600). If the 2-1 process was selected by the user, processing continues at step 4610 (FIG. 95) which begins the level 2 to 1 simplification process.

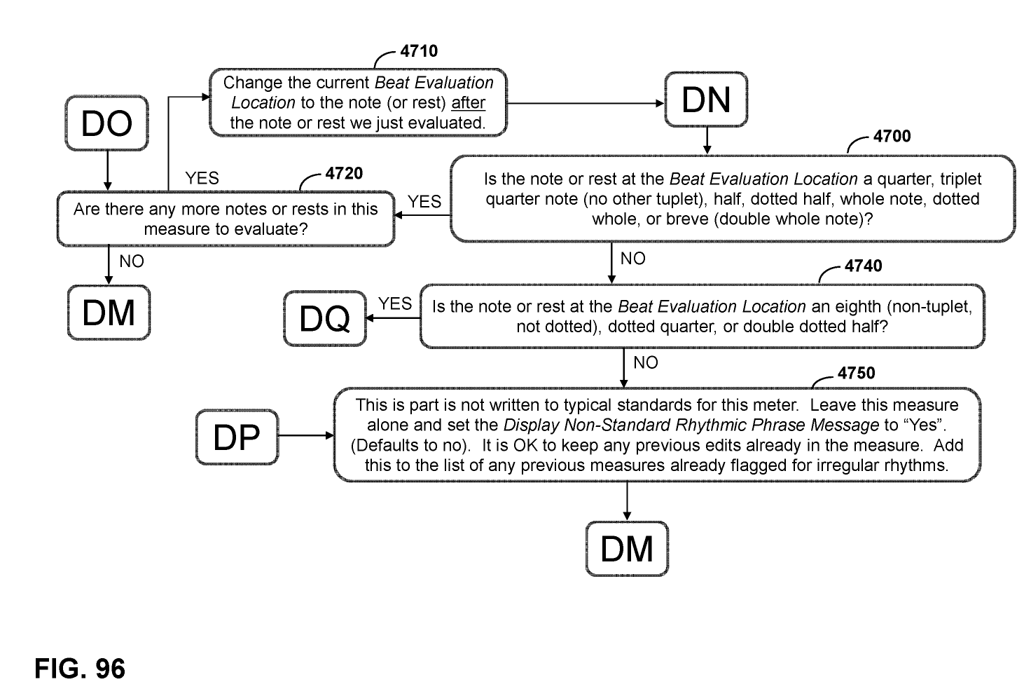

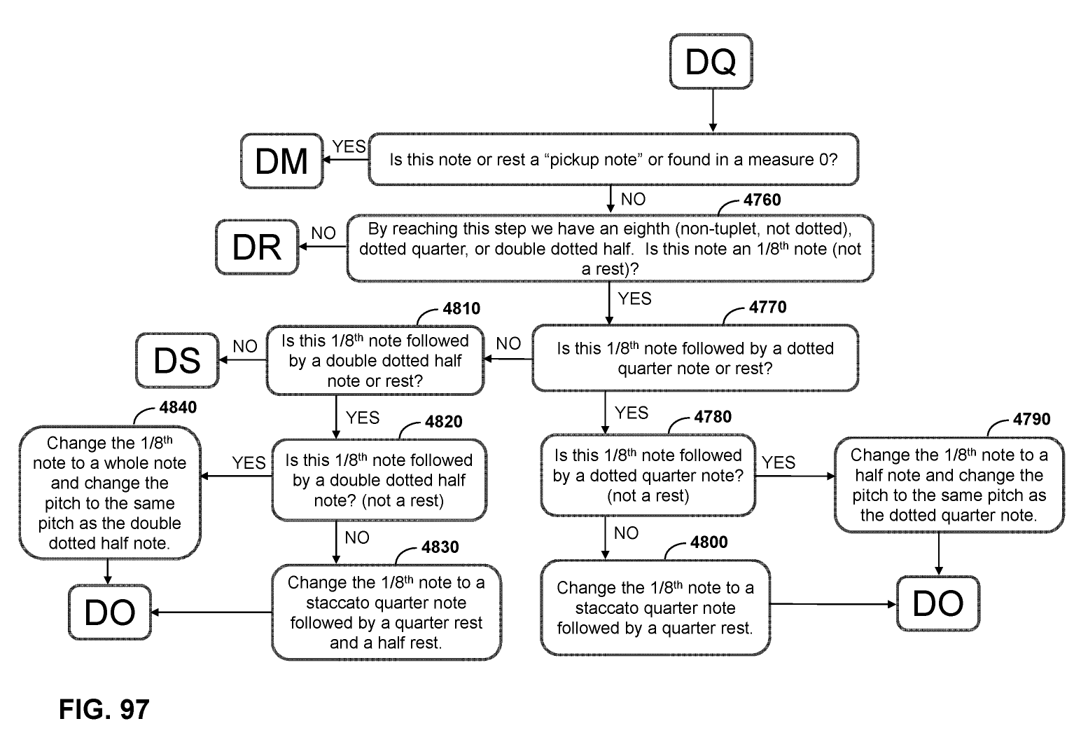

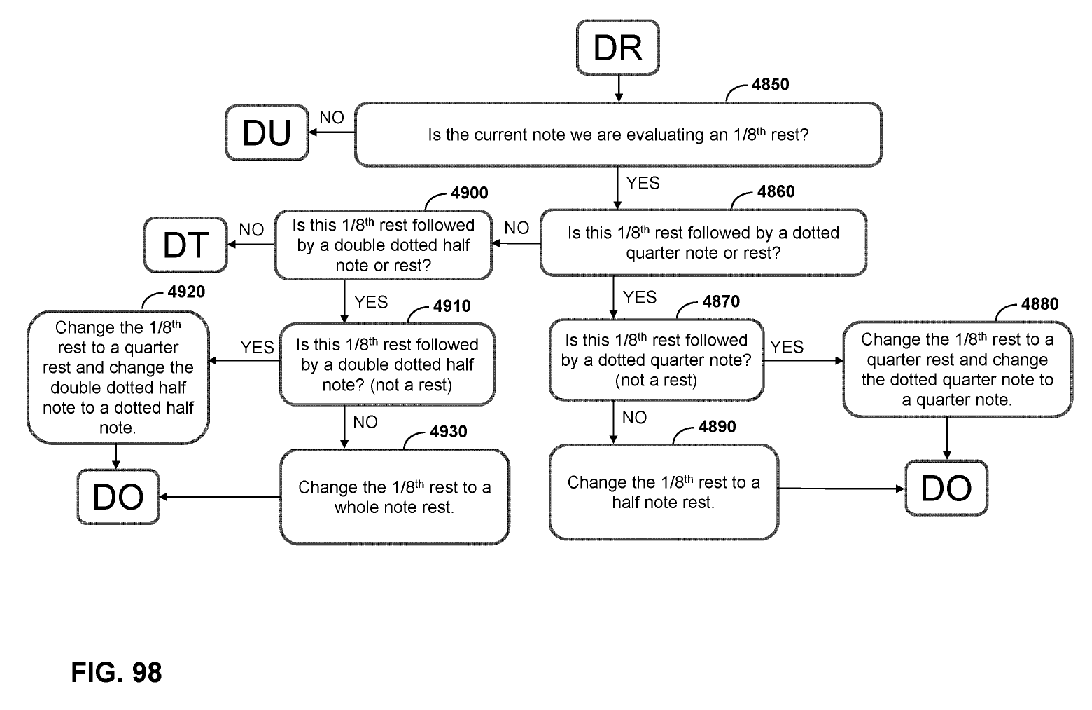

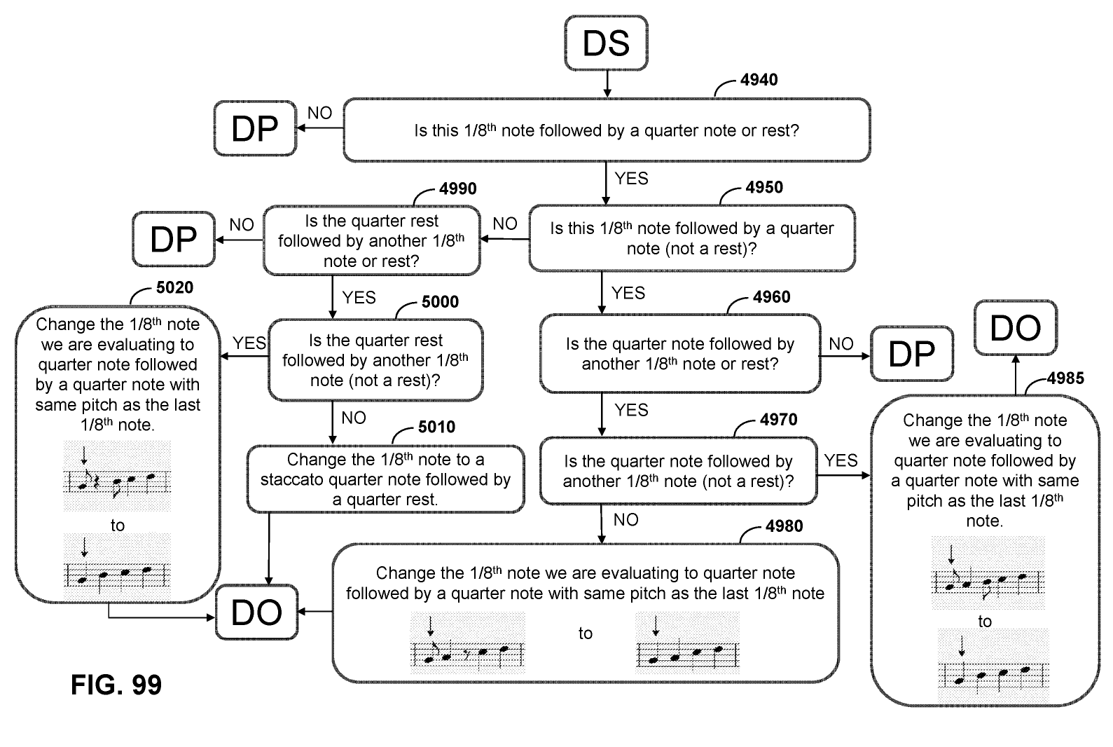

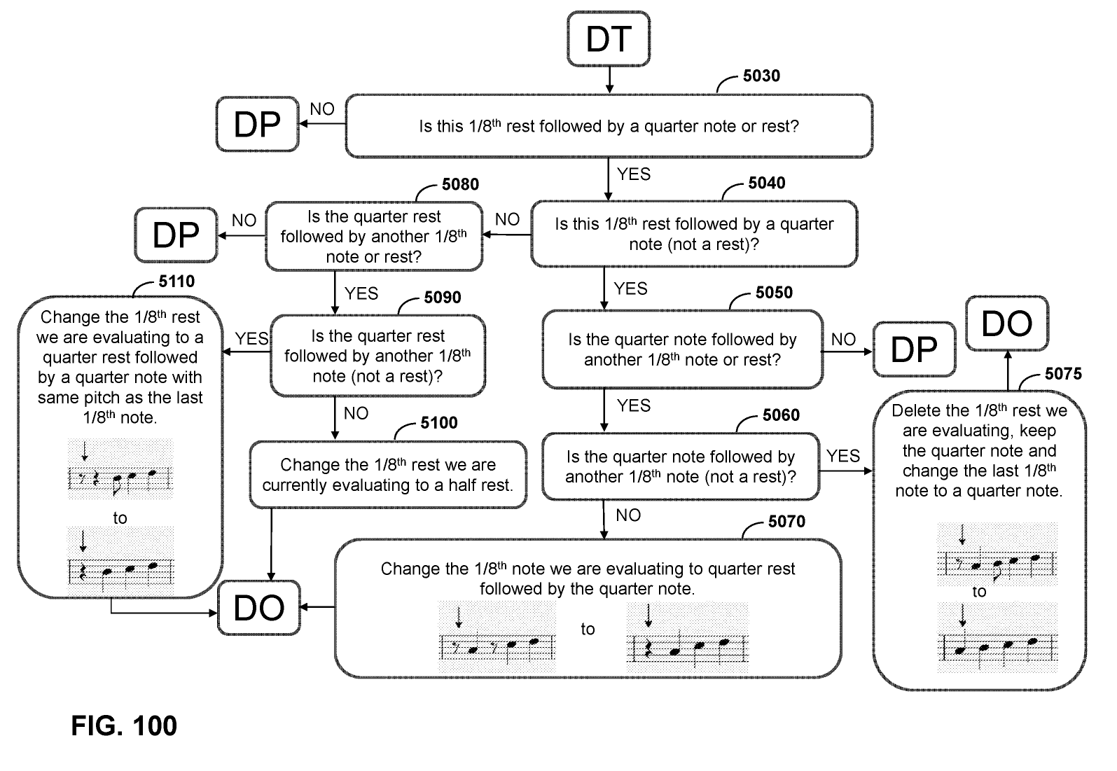

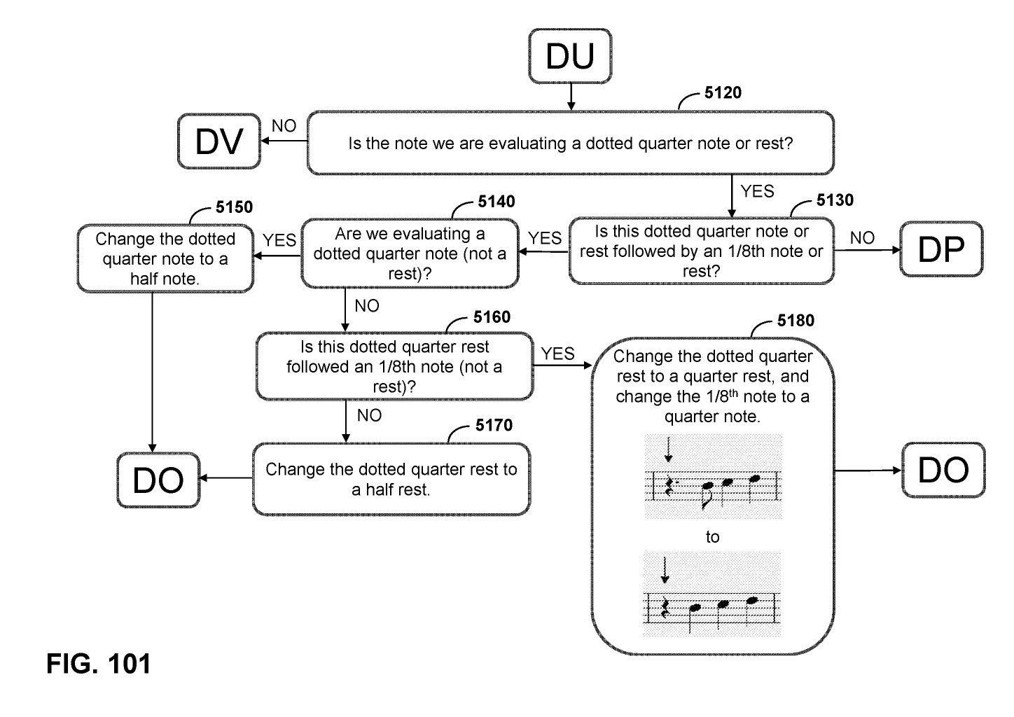

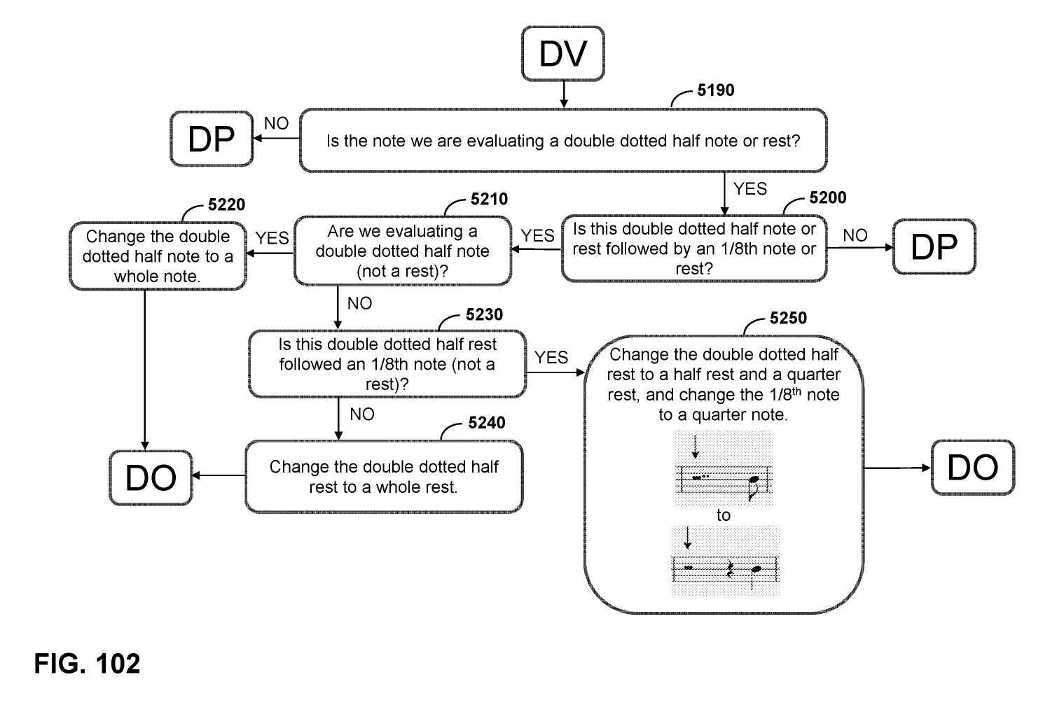

In FIGS. 95-102, the process is shown for simplifying rhythms in common time, cut time, and all time signatures over 4 and 2 which represent quarter notes or half notes representing the beat respectively. This section focuses on simplifying rhythms from proficiency 2 to proficiency 1, the objective being that the fastest note presented is a quarter note (steps 4610-5250).

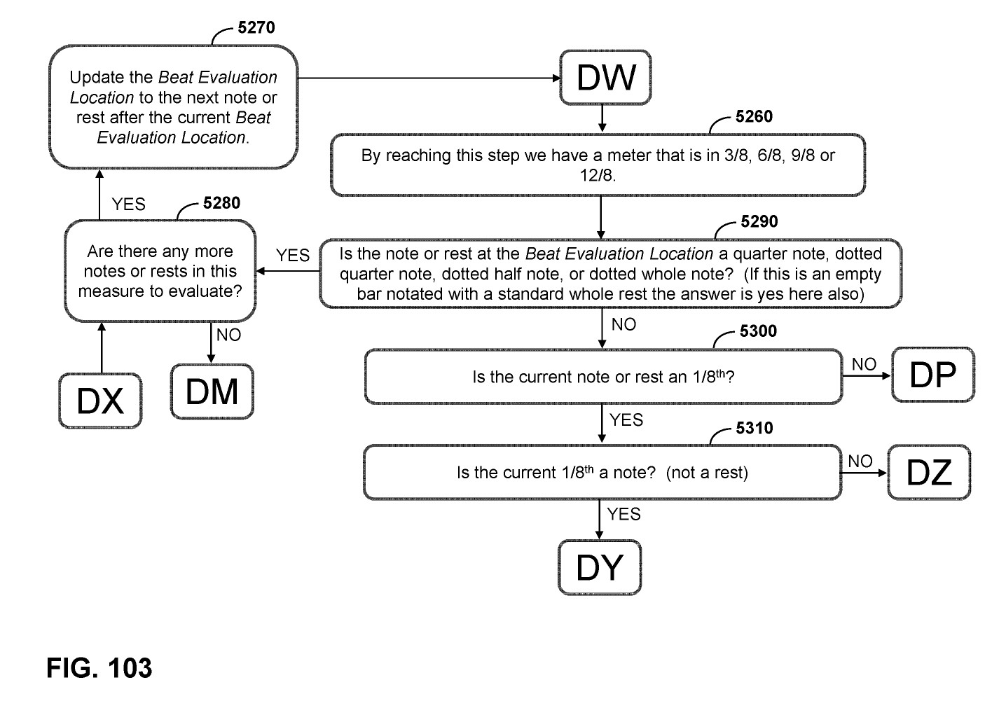

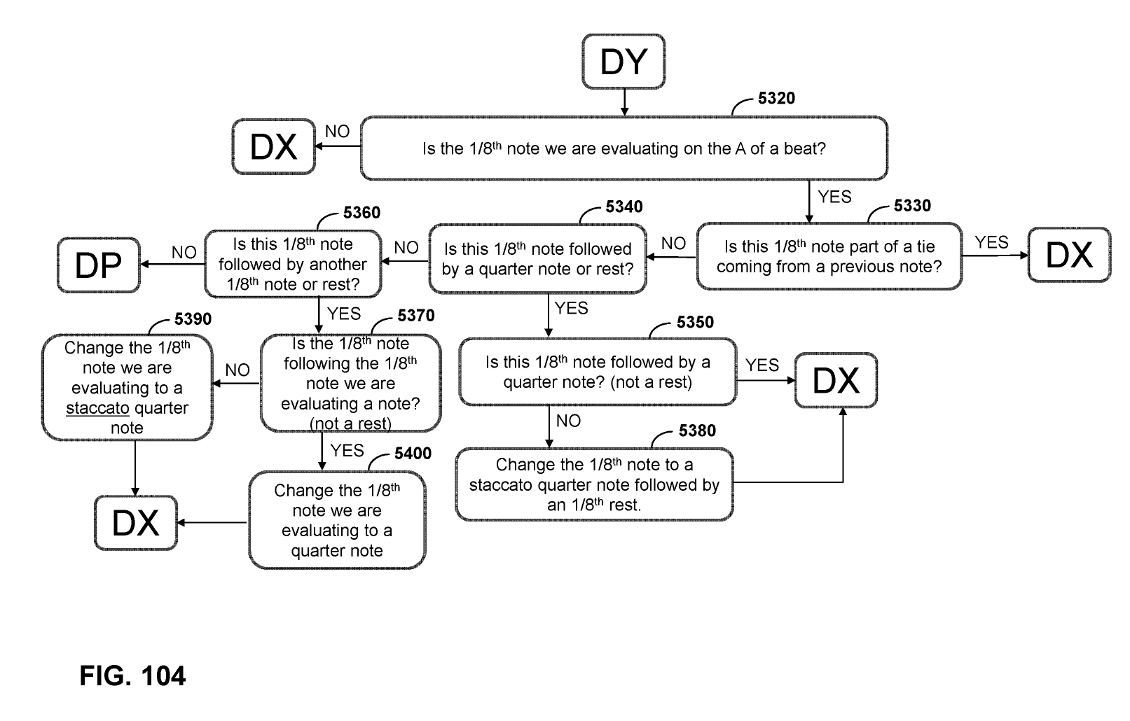

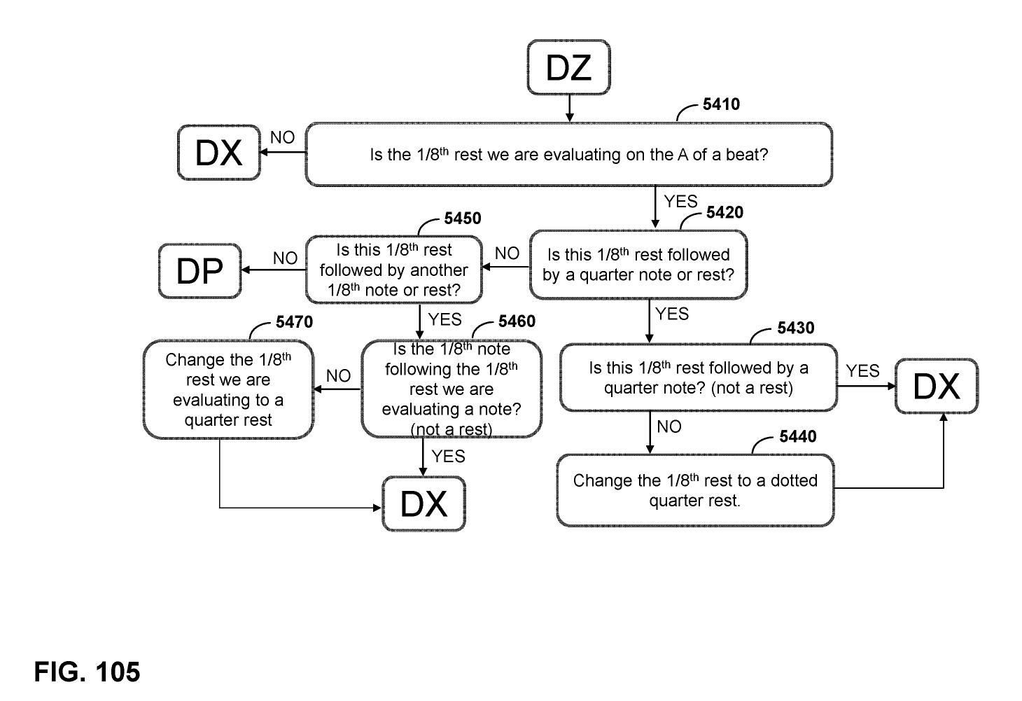

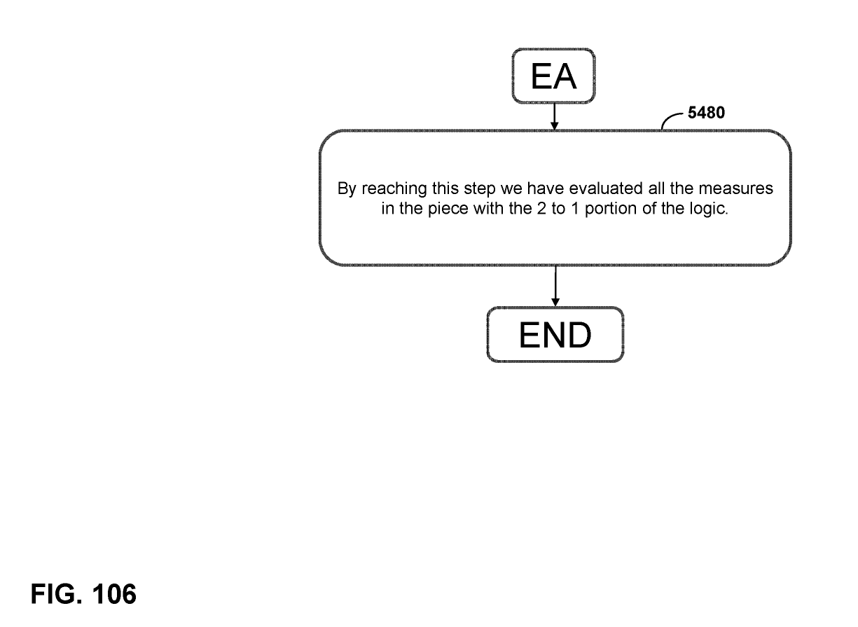

Depicted in FIGS. 103-105 is process for simplifying rhythms in ⅜, 6/8, 9/8 and 12/8 which represent common time signatures where dotted quarter notes represent the beat. This section also focuses on simplifying rhythms from proficiency 2 to proficiency 1 and limits some of the rhythmic patterns using ⅛^{th} notes even when less than three are presented consecutively (steps S260-5440). FIG. 106 (step S480) represents the end point to the logic if the user selects the 2 to 1 process.

### Exemplary System Configuration

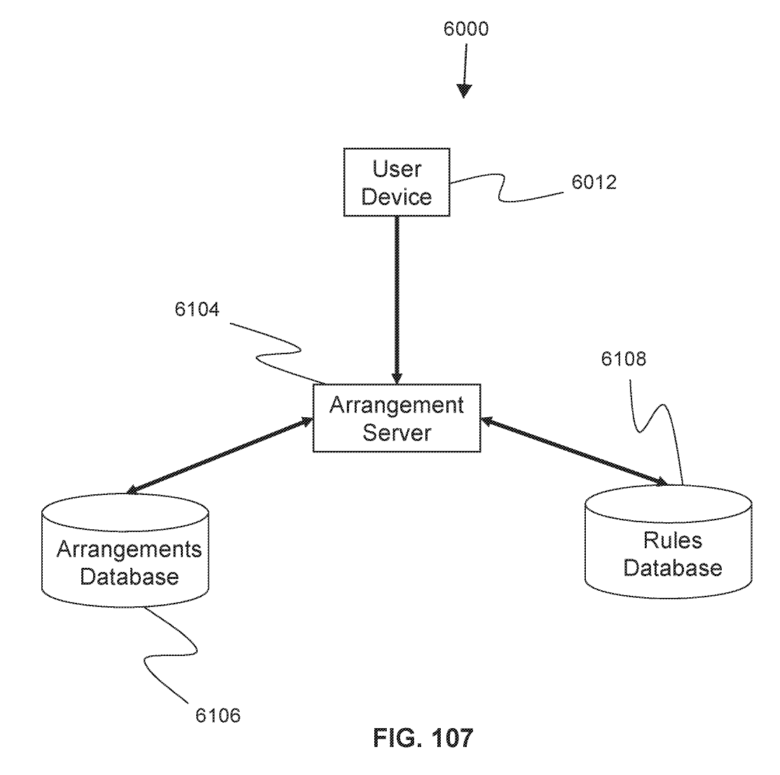

FIG. 107 illustrates one embodiment of a system 6000 for customized musical arrangements that incorporate this rhythmic simplification process, where a user utilizes a device 6102 to interface with an arrangement server 6104. A user interacts with the system through the user device 6102 to input the individual player or ensemble information at the user device 6102, select music and receive the resulting customized arrangements reflecting the rhythmic simplification process. The individual player or ensemble information and other information input by the user will then be transmitted to the arrangement server 6104. The user device 6102 may be any type of computing device, such as a desktop computer, laptop computer, tablet, smartphone or other electronic device. The user device 6102 may be running an application locally on the user device or providing an internet browser-based interface run by arrangement server 6104 and displayed at user device 6102 through an internet browser application. User device 6102 may also include a simple interface device, such as a touchscreen monitor, which is operatively coupled with arrangement server 6104 and displays a graphical user interface from the arrangement server 6104 for display on the interface device and for interaction with the user.

The arrangement server 6104 will be responsible for receiving the individual player or ensemble information input by the user at the user device 6102 and creating the appropriate arrangements. The arrangement server 6104 may include one or more computing devices, as described below, and will also be connected with one or more databases which store the arrangements, arrangement rules and received input information. In one embodiment, an arrangements database 6106 is connected with the arrangement server 6104 and stores information about all of the possible musical selections and arrangements for each musical selection. A rules database 6108 may store the rules described above for selecting a particular arrangement for a particular musical instrument, musical part in the arrangement, the rhythmic simplification logic and any other relevant criteria utilized for selecting the appropriate arrangement based on the input ensemble information. It is understood that the information stored in the arrangements database 6106 and the rules database may be stored in a single database and utilize multiple relational database tables. Additional databases and/or database tables may be utilized to store additional information understood by one of skill in the art, such as user account information, rights information, graphical user interface data, etc.

The arrangement server 6104 may then be configured to output the customized music arrangements to the user device 6102, where the user can view, print, download or otherwise receive the arrangements. In one embodiment, the arrangement server 6104 may be connected with a plurality of user devices such that each musician in the ensemble has a user device (such as a tablet or monitor) which will display their own customized arrangement. This embodiment can also apply to individual players not part of an ensemble. Thus, the arrangements could be created and displayed to the members of the ensemble or individual players not part of an ensemble on their user devices in real-time.

### Computer-Implemented Embodiment

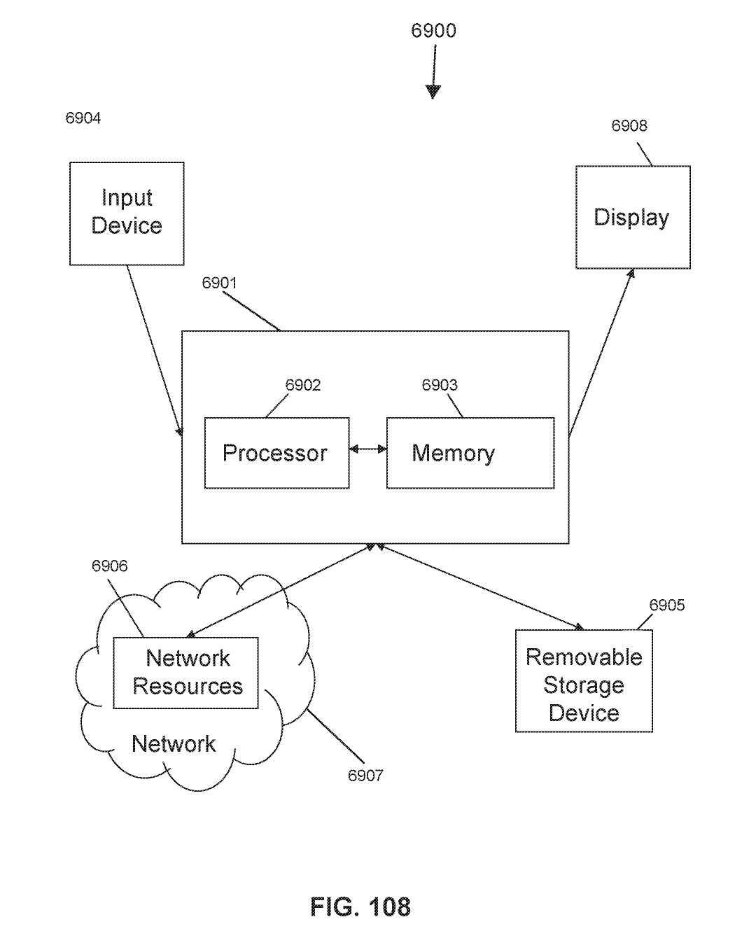

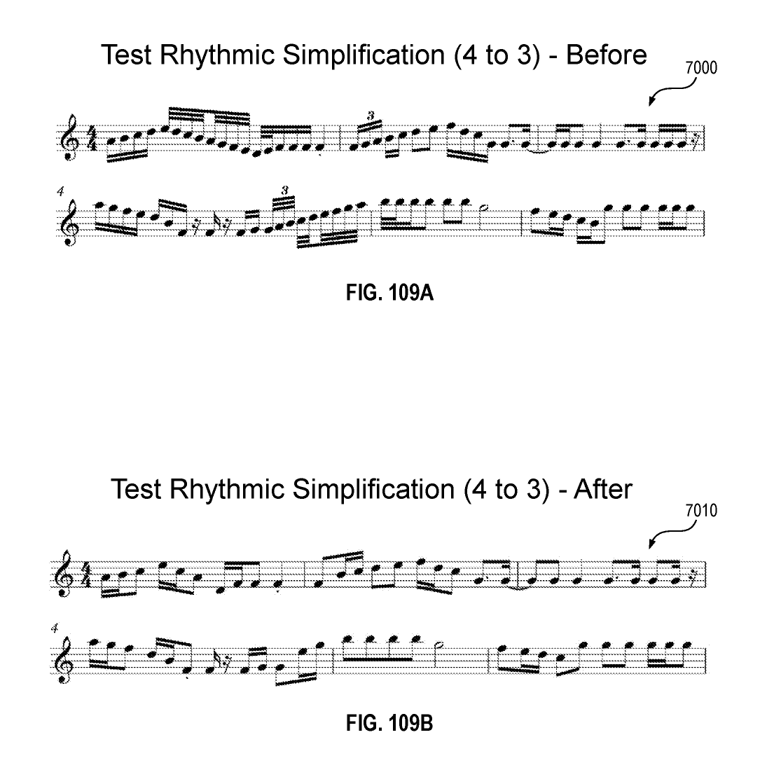

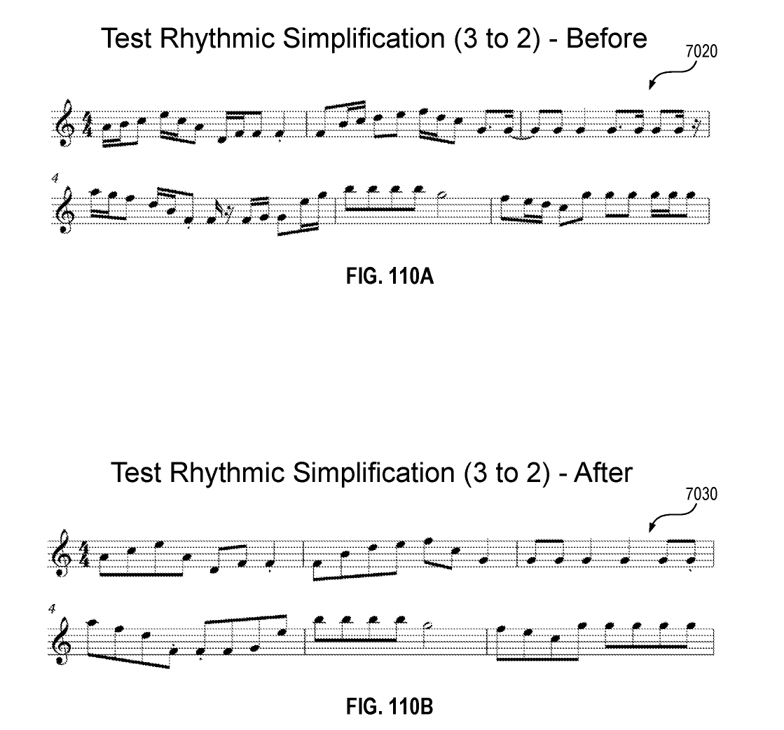

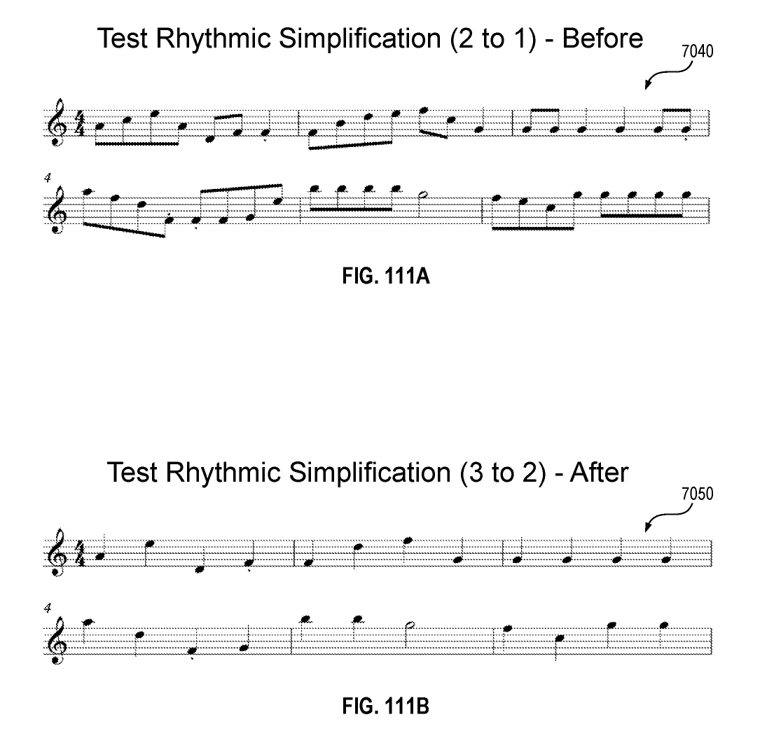

FIG. 108 is a block diagram that illustrates an embodiment of a computer/server system 6900 upon which an embodiment of the inventive methodology may be implemented. The system 6900 includes a computer/server platform 6901 including a processor 6902 and memory 6903 which operate to execute instructions, as known to one of skill in the art. The term “computer-readable storage medium” as used herein refers to any tangible medium, such as a disk or semiconductor memory, that participates in providing instructions to processor 6902 for execution. Additionally, the computer platform 6901 receives input from a plurality of input devices 6904, such as a keyboard, mouse, touch device or verbal command. The computer platform 6901 may additionally be connected to a removable storage device 6905, such as a portable hard drive, optical media (CD or DVD), disk media or any other tangible medium from which a computer can read executable code. The computer platform may further be connected to network resources 6906 which connect to the Internet or other components of a local public or private network. The network resources 6906 may provide instructions and data to the computer platform from a remote location on a network 6907. The connections to the network resources 3906 may be via wireless protocols, such as the WiFi 802.11 standards, Bluetooth® or cellular protocols, or via physical transmission media, such as cables or fiber optics. The network resources may include storage devices for storing data and executable instructions at a location separate from the computer platform 6901. The computer interacts with a display 3908 to output data and other information to a user, as well as to request additional instructions and input from the user. The display 6908 may therefore further act as an input device 6904 for interacting with a user.

While various embodiments have been described above, it should be understood that they have been presented by way of example only, and not of limitation. The breadth and scope should not be limited by any of the above-described exemplary embodiments. Where this document refers to technologies that would be apparent or known to one of ordinary skill in the art, such technologies encompass those apparent or known to the skilled artisan now or at any time in the future. In addition, the described embodiments are not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the described embodiments.

Furthermore, although items, elements or components may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-enabled method of simplifying music rhythms comprising the steps of:
receiving, from a database storing a plurality of digitally-encoded musical selections, a musical selection in accordance with a user choice;
receiving, from the user, a target proficiency to which the chosen musical selection is to be adjusted, the target proficiency characterized by at least one simplification rule selected from the group consisting of a minimum note duration, a combination rule, and a beat-shifting rule; and
adjusting notes and rests of the chosen musical selection having rhythmic values inconsistent with the target proficiency to rhythmic values consistent with the at least one simplification rule.

2. The method in accordance with claim 1, wherein the adjusting is performed on a measure by measure basis.

3. The method in accordance with claim 1; wherein an early beginner proficiency group is characterized by a minimum note rule having a minimum note or rest duration of a quarter note.

4. The method in accordance with claim 1, wherein a beginner proficiency group is characterized by a minimum note rule having a minimum note or rest duration of an eighth note.

5. The method in accordance with claim 1, wherein an intermediate proficiency group is characterized by a minimum note rule having a minimum note or rest duration of a sixteenth note.

6. The method in accordance with claim 1, wherein an advanced proficiency group is characterized by a minimum note rule having no minimum note or rest duration.

7. The method in accordance with claim 1, wherein the combination rule comprises combining two or more shorter duration notes or rests into one longer duration note or rest.

8. The method in accordance with claim 1, wherein the combination rule comprises combining three or more shorter duration notes or rests into two longer duration notes or rests.

9. The method in accordance with claim 1, wherein the combination rule comprises combining two notes or rests of any duration into two notes or rests whose sum equals the same total duration.

10. The method in accordance with claim 1, wherein the beat-shifting rule comprises:
identifying a note or rest which falls between the beat; and
moving the identified note or rest to fall on the beat.

11. The method in accordance with claim 1, wherein the beat-shifting rule comprises:
identifying a note or rest which falls between the eighth note subdivision of a beat; and
moving the identified note or rest to fall on the eighth note subdivision of a beat.

12. The method in accordance with claim 1, wherein the beat-shifting rule comprises:
identifying a note or rest which falls between the sixteenth note subdivision of a beat; and
moving the identified note or rest to fall on the sixteenth note subdivision of a beat.

13. A rhythm simplification system, comprising:
a database storing one or more digitally-encoded musical arrangements;
an input device;
a processor operatively coupled to the input device and the database; and
a memory storing a set of executable instructions, which; when executed by the processor, cause the processor to:
receive, from the input device, a selection of one of the one or more digitally-encoded musical arrangements;
retrieve the selected musical arrangement from the database;
receive, from the input device, a target proficiency to which the selected musical arrangement is to be adjusted, the target proficiency characterized by at least one simplification rule selected from the group consisting of a minimum note duration; a combination rule, and a beat-shifting rule; and
adjust the notes and rests of the selected musical arrangement having rhythmic values inconsistent with the target proficiency to rhythmic values consistent with the at least one simplification rule.

14. The system in accordance with claim 13, wherein the memory further includes instructions, which, when executed by the processor, cause the processor to adjust the notes and rests of the selected musical arrangement on a measure by measure basis.

15. The system in accordance with claim 13, wherein the memory further includes instructions, which, when executed by the processor, cause the processor to combine two or more shorter duration notes or rests into one longer duration note or rest.

16. The system in accordance with claim 13, wherein the memory further includes instructions, which, when executed by the processor, cause the processor to combine three or more shorter duration notes or rests into two longer duration notes or rests.

17. The system in accordance with claim 13, wherein the memory further includes instructions, which, when executed by the processor, cause the processor combine two notes or rests of any duration into two notes or rests whose sum equals the same total duration.

18. The system in accordance with claim 13, wherein the memory further includes instructions, which, when executed by the processor, cause the processor to identify a note or rest which falls between the beat and move the identified note or rest to fall on the beat.

19. The system in accordance with claim 13, wherein the memory further includes instructions, which, when executed by the processor, cause the processor to identify a note or rest which falls between the eighth note subdivision of a beat and move the identified note or rest to fall on the eighth note subdivision of a beat.

20. The system in accordance with claim 13, wherein the memory further includes instructions, which, when executed by the processor, cause the processor to identify a note or rest which falls between the sixteenth note subdivision of a beat and move the identified note or rest to fall on the sixteenth note subdivision of a beat.
